(19) United States
(12) Patent Application Publication
(10) Pub. No.: US 2019/0041637 A1
(43) Pub. Date: Feb. 7, 2019

(54) METHODS OF AUTOMATICALLY RECORDING PATCHING CHANGES AT PASSIVE PATCH PANELS AND NETWORK EQUIPMENT

(71) Applicant: CommScope Technologies LLC, Hickory, NC (US)

(72) Inventors: Michael Gregory German, Secaucus, NJ (US); Ryan E. Enge, Carrollton, TX (US); LeaAnn Harrison Carl, Plano, TX (US); Lary Van Scoy, Hichory, NC (US)

(73) Assignee: CommScope Technologies LLC, Hickory, NC (US)

(21) Appl. No.: 16/054,774

(22) Filed: Aug. 3, 2018

Related U.S. Application Data
(60) Provisional application No. 62/640,281, filed on Mar. 8, 2018.
(60) Provisional application No. 62/540,893, filed on Aug. 3, 2017.

(51) Int. Cl. G02B 27/01; G06T 19/00; G01S 19/01; H04W 4/33; G06K 19/06

(52) U.S. Cl. CPC G02B 27/0101; G06T 19/006; G02B 27/017; G01S 19/01; H04W 4/33; H04W 4/80; G06K 19/06037; G02B 2027/0141; G02B 2027/0138; G02B 2027/014; G02B 2027/0178; G06K 19/06028

(57) ABSTRACT

Some embodiments are directed to methods and systems for using augmented reality (AR) technology with a system for tracking connections at rack-mounted patching or other equipment, as well as non-rack-mounted equipment. Such AR technology can also be used to assist a user in locating non-visible equipment by displaying digital representations of such non-visible equipment.

### RELATED APPLICATIONS

This application claims the benefit of U.S. Provisional Patent Application Ser. No. 62/640,281, filed on Mar. 8, 2018, and U.S. Provisional Patent Application Ser. No. 62/540,893, filed on Aug. 3, 2017, all of which are hereby incorporated herein by reference in their entirety.

This application is related to the following applications:

U.S. patent application Ser. No. 15/093,771 filed on Apr. 08, 2016, which issued as U.S. Pat. No. 9,811,494, which is a continuation of U.S. patent application Ser. No. 14/811,946 filed on Jul. 29, 2015, which issued as U.S. Pat. No. 9,338,525, which is a continuation of U.S. patent application Ser. No. 14/138,463 filed on Dec. 23, 2013, which issued as U.S. Pat. No. 9,123,217, which is a continuation-in-part of U.S. patent application Ser. No. 12/826,118 filed Jun, 29, 2010, which issued as U.S. Pat. No. 8,643,476, which in turn claims priority from U.S. Provisional Patent Application No. 61/221,306, filed Jun. 29, 2009.

U.S. patent application Ser. No. 15/277,680 filed on Sep. 27, 2016, which published as U.S. Patent Application Publication No. 2017/0018274, which is a continuation of U.S. patent application Ser. No. 14/934,364 filed on Nov. 6, 2015, which claims priority from U.S. Provisional Patent Application No. 62,077,981, filed Nov. 11, 2014.

All of the preceding applications are hereby incorporated herein by reference in their entirety.

### FIELD OF THE INVENTION

The present invention relates generally to communications patching systems and, more particularly, to patch panels for communications patching systems.

### BACKGROUND

Many businesses have dedicated telecommunication systems that enable computers, telephones, facsimile machines and the like to communicate with each other, through a private network, and with remote locations via a telecommunications service provider. In most buildings, the dedicated telecommunications system is hard wired using telecommunication cables that contain conductive wire. In such hard wired systems, dedicated wires are coupled to individual service ports throughout the building. The wires from the dedicated service ports extend through the walls of the building to a telecommunications closet or closets. The telecommunications lines from the interface hub of a main frame computer and the telecommunication lines from external telecommunication service providers may also terminate within a telecommunications closet.

A patching system is typically used to interconnect the various telecommunication lines within a telecommunications closet. In a telecommunications patching system, all of the telecommunication lines are terminated within a telecommunications closet in an organized manner. The organized terminations of the various lines are provided via the structure of the telecommunications closet. A mounting frame having one or more racks is typically located in a telecommunications closet. The telecommunications lines terminate on the racks, as is explained below. It is noted that the patching systems described herein may be used in connection with data center environments, providing interconnection between servers, switches, storage devices, and other data center equipment, as well as office/LAN environments.

Referring to FIG. 1, a typical prior art rack 10 is shown. The rack 10 retains a plurality of patch panels 12 that are mounted to the rack 10. On each of the patch panels 12 are located port assemblies 14. The illustrated port assemblies 14 each contain a plurality of optical communication connector ports (e.g., SC, ST, LC ports, etc.) 16. Each of the different communication connector ports 16 is hard wired to one of the communication lines. Accordingly, each communication line is terminated on a patch panel 12 in an organized manner. In small patch systems, all communication lines may terminate on the patch panels of the same rack. In larger patch systems, multiple racks may be used, wherein different communication lines terminate on different racks.

In FIG. 1, interconnections between the various communication lines are made using patch cords 20. Both ends of each patch cord 20 are terminated with connectors 22. One end of a patch cord 20 is connected to a connector port 16 of a first communication line and the opposite end of the patch cord 20 is connected to a connector port 16 of a second communications line. By selectively connecting the various lines with patch cords 20, any combination of communication lines can be interconnected.

In office/LAN environments, as employees move, change positions, and/or add and subtract lines, the patch cords in a typical telecommunications closet may be rearranged quite often. In data center environments, patching information requires updates based on provisioning/addition/subtraction of servers, switches, storage devices, and other data center equipment. Therefore, it is important to maintain a log or tracing system which provides port identification information, patch cord connection information and/or patch cord identification information. This information may be recorded and updated on handwritten or preprinted labels adjacent to the connector ports. Handwritten or preprinted patch cord labels (i.e., labels affixed or clipped to patch cords) may also provide connectivity information by providing a unique identifier for each patch cord. The overall interconnections of the various patch cords in a telecommunications closet may be monitored by manually updating a paper or computer based log.

These solutions suffer from numerous drawbacks. Handwritten or preprinted labels offer limited space for documenting connectivity information and are subject to error if and when they are updated. Also, handwritten or preprinted labels may obscure each other, especially in high density installations, and may be difficult to read in dark environments, such as telecommunications closets. Furthermore, handwritten or preprinted labels do not provide an automated log or tracing system for the patch cords. Where a paper or computer based log is employed, technicians may neglect to update the log each and every time a change is made. These manually updated logs are also prone to erroneous entries.

Therefore, regardless of the procedure used, the log or tracing system inevitably becomes less than 100% accurate and a technician has no way of reading where each of the patch cords begins and ends. Accordingly, each time a technician needs to change a patch cord, the technician manually traces that patch cord between two connector ports. To perform a manual trace, the technician locates one end of a patch cord and then manually follows the patch cord until he/she finds the opposite end of that patch cord. Once the two ends of the patch cord are located, the patch cord can be positively identified.

It may take a significant amount of time for a technician to manually trace a particular patch cord, particularly within a collection of other patch cords. Furthermore, manual tracing may not be completely accurate and technicians may accidentally go from one patch cord to another during a manual trace. Such errors may result in misconnected telecommunication lines which must be later identified and corrected. Also, it may be difficult to identify the correct port to which a particular patch cord end should be connected or disconnected. Thus, ensuring that the proper connections are made can be very time-consuming, and the process is prone to errors in both the making of connections and in keeping records of the connections. Accordingly, a need exists for accurately and quickly tracing, detecting and identifying the ends of patch cords in a telecommunications closet. A need also exists for accurately and quickly knowing which ports are connected by patch cords.

### SUMMARY

Pursuant to embodiments of the present invention, methods of executing a patching connection change in a patching field are provided. Pursuant to these methods, an electronic work order is received at a display located at the patching field. This electronic work order may specify the patching connection change that is to be performed. A technician may read the electronic work order and execute the patching connection change. An electronic message may be sent from the patching field indicating that the patching change has been completed.

The patching connection change may involve adding, changing or deleting a patching connection at a passive patch panel. In some embodiments, the display may be a display that is retrofitted onto the passive patch panel. In other embodiments, the display may be a display that is associated with a rack controller. In order to send the electronic message from the patching field that indicates that the patching change has been completed, the technician may activate an input mechanism that is associated with the display. In response to the activation of this input mechanism, the electronic message may be sent to a system controller. The input mechanism may comprise, for example, a push button or a touch screen capability of the display.

In some embodiments, the performance of the patching connection may involve performing a first operation of the patching connection change, and then sending a first message indicating that the first operation has been completed; and then performing a second operation of the patching connection change, and then sending a second message indicating that the second operation has been completed. The patching connection change may be the addition of a patch cord to form a new patching connection. In such embodiments, the first operation may be plugging a first end of the patch cord into a first connector port and the second operation may be plugging a second end of the patch cord into a second connector port. Alternatively, the patching connection change may be changing an existing patching connection. In such embodiments, the first operation may be unplugging a first end of a patch cord from a first connector port and the second operation may be plugging the first end of the patch cord into a second connector port. A connectivity database may be updated to reflect that the patching connection change has been completed in response to the second message.

One embodiment is directed to a method of using an augmented reality (AR) device. The method comprises detecting and decoding an identifier associated with a standard rack in an image captured by the AR device and obtaining information about the standard rack and any equipment installed in the standard rack from a management system using the identifier. The method further comprises detecting perimeters of standard rack positions in the standard rack based on the information and generating an overlay for the AR device, the overlay comprising at least one emphasis feature generated based on at least one of the perimeters.

Another embodiment is directed to a system of tracking connections made using cables. The system comprises a standard rack, a management system, and an augmented reality (AR) device. The system is configured to detect and decode an identifier associated with the standard rack in an image captured by the AR device, obtain information about the standard rack and any equipment installed in the standard rack from the management system using the identifier, detect perimeters of standard rack positions in the standard rack based on the information, and generate an overlay for the AR device, the overlay comprising at least one emphasis feature generated based on at least one of the perimeters.

Another embodiment is directed to a method of using an augmented reality (AR) device. The method comprises identifying, using an indoor positioning system, a standard rack in an image captured by the AR device, obtaining information about the standard rack and any equipment installed in the standard rack from a management system based on the identity of the standard rack, detecting perimeters of standard rack positions in the standard rack based on the information, and generating an overlay for the AR device, the overlay comprising at least one emphasis feature generated based on at least one of the perimeters.

Another embodiment is directed to a system of tracking connections made using cables. The system comprises a standard rack, a management system, an augmented reality (AR) device; and an indoor positioning system. The system is configured to identify, using the indoor positioning system, the standard rack in an image captured by the AR device and obtain information about the standard rack and any equipment installed in the standard rack from a management system based on the identity of the standard rack. The system is further configured to detect perimeters of standard rack positions in the standard rack based on the information and generate an overlay for the AR device, the overlay comprising at least one emphasis feature generated based on at least one of the perimeters.

Another embodiment is directed to a method of using an augmented reality (AR) device to assist a user in locating non-visible equipment. The method comprises detecting and identifying a marker deployed near the non-visible equipment, obtaining information about the non-visible equipment from a management system based on the identified marker, and generating an overlay for the AR device, the overlay comprising at least one digital representation of the non-visible equipment.

Another embodiment is directed to a system for assisting a user in locating non-visible equipment. The system comprises a management system and an augmented reality (AR) device. The system is configured to detect and identify a marker deployed near the non-visible equipment, obtain information about the non-visible equipment from the management system based on the identified marker, and generate an overlay for the AR device, the overlay comprising at least one digital representation of the non-visible equipment.

It is noted that any one or more aspects or features described with respect to one embodiment may be incorporated in a different embodiment although not specifically described relative thereto. That is, all embodiments and/or features of an embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

### BRIEF DESCRIPTION OF THE DRAWINGS

FIG. 1 is a perspective view of a typical prior art communication rack assembly containing multiple patch panels with connector ports that are selectively interconnected by patch cords.

FIG. 2 is a block diagram of a patch panel and an optional external database, according to embodiments of the present invention.

FIG. 3 is a fragmented front view of a patch panel, according to embodiments of the present invention.

FIG. 4 is a fragmented front view of a patch panel, according to embodiments of the present invention.

FIG. 5 is a fragmented perspective view of a patch panel, according to embodiments of the present invention.

FIG. 6 is a perspective view of an electronic display for use with patch panels according to embodiments of the present invention.

FIGS. 7A-7C are block diagrams illustrating methods of displaying connection information for a connector port of a patch panel in a communications patching system.

FIG. 8A is a side view of a frame of a patch panel system, according to some embodiments of the present invention.

FIG. 8B is a front view of the frame of FIG. 8A.

FIG. 9 is a schematic block diagram of portions of a communications system that may implement methods according to embodiments of the present invention.

FIG. 10 is a schematic illustration of an electronic work order according to embodiments of the present invention.

FIG. 11 is a flow chart illustrating methods of executing patching connection changes according to embodiments of the present invention.

FIG. 12A is a schematic diagram illustrating a technician making a patching change in a patching filed using a mobile system controller according to embodiments of the present invention.

FIG. 12B is a perspective view of a mobile system controller according to embodiments of the present invention that is implemented in a pair of eyeglasses.

FIG. 12C is a schematic view of a display on the mobile system controller of FIG. 12B showing how a first step in a patching change may be displayed to a technician.

FIG. 12D is a schematic view of the display on the mobile system controller of FIG. 12B showing how the second step in the patching change may be displayed to the technician.

FIG. 12E is a schematic close-up view of one of the patch panels in FIG. 12A that illustrates a readable label that is provided on the patch panel to facilitate detecting patch cord insertions and removals from connector ports on the patch panel.

FIG. 13 is a high-level block diagram of one exemplary embodiment of a system that tracks connections made using patching equipment and other types of equipment and that makes use of an augmented reality (AR) device.

FIGS. 14A-14C illustrate one example of a software-generated overlay superimposed over a user's view of a rack in which patching equipment is installed.

FIG. 15 is a flow diagram showing one exemplary embodiment of a method of using an AR device in a system that tracks connections made using patching equipment and other equipment.

FIG. 16 is a high-level block diagram of another exemplary embodiment of a system that tracks connections made using patching equipment and other types of equipment and that makes use of an AR device.

FIG. 17 is a flow diagram showing another exemplary embodiment of a method of using an AR device in a system that tracks connections made using patching equipment and other equipment.

FIGS. 18A-18N illustrate the operation of one example of an application executing on a smartphone that makes use of software-generated overlays superimposed over user views of a rack in which patching equipment is installed.

FIG. 19 is a high-level block diagram of one exemplary embodiment of a system for using an AR device to assist with locating non-visible equipment.

FIG. 20 comprises a high-level flow chart illustrating one exemplary embodiment of a method of using an AR device to assist with locating non-visible equipment.

FIGS. 21A-21F illustrate one example using an AR device to assist with locating non-visible equipment by including digital representations of the non-visible equipment in overlay images that are generated and superimposed over the user's view of the real world displayed by the AR device.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated listed items.

In the drawings, the thickness of lines and elements may be exaggerated for clarity. It will be understood that when an element is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like are used herein for the purpose of explanation only.

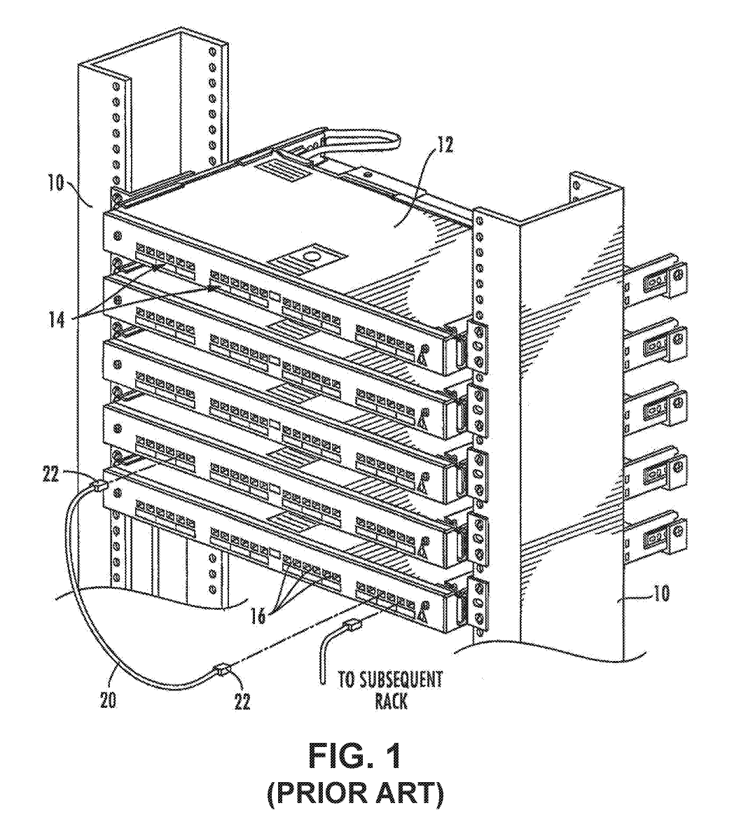

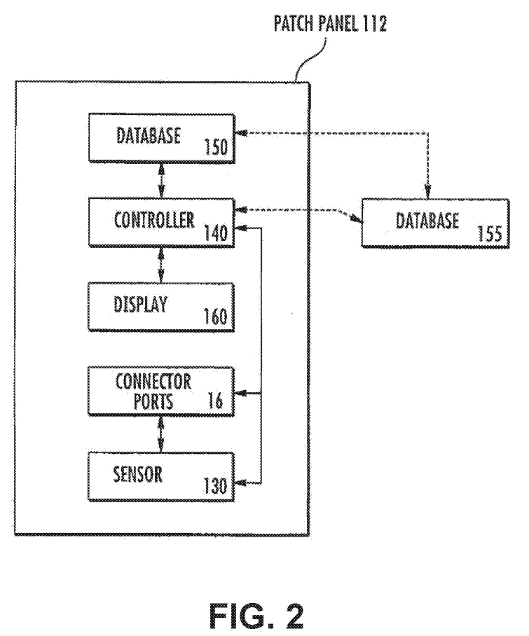

Referring now to FIG. 2, a patch panel 112, according to some embodiments of the present invention, is illustrated. The illustrated patch panel 112 includes a plurality of connector ports 16. A patch cord 20 (FIG. 1) has opposite ends with a connector 22 secured to each end. Each connector 22 is configured to be removably secured within a respective connector port 16.

Each connector port 16 is configured to detect when a patch cord connector 22 is inserted within, and removed from, the respective connector port 16. This detection is generally accomplished by any type of sensor 130, including, but not limited to, mechanical sensors (e.g., mechanical switches), passive optical based sensors, RFID sensors and electrical based sensors. The sensor 130 may be integrated with the connector port 16 or may be adjacent to the connector port 16.

Each connector 22 of a respective patch cord 20 has the same unique identifier (i.e., uniquely paired identifier) in order to accurately track connectivity. In some embodiments, the identifier is in the form of programmable memory. In some embodiments, the programmable memory is Electrically Erasable Programmable Read-Only Memory (EEPROM). In some particular embodiments, the identifier may be a 1-Wire® device manufactured by Maxim Integrated Products. The identifier and the sensor 130, described above, may share components.

A controller 140 is typically electrically coupled to the connector ports 16 and/or the sensors 130. Therefore, the controller 140 is capable of monitoring when a patch cord 20 is inserted into any connector port 16, or removed from any connector port 16. The controller 140 is also capable of automatically keeping an accurate log of all changes that have occurred to the patch cords 20. In some embodiments, the controller 140 is external to the patch panel 112. For example, the controller 140 may be a controller mounted on a rack 10 (FIG. 1). In some embodiments, the controller 140 is electro-magnetically coupled to the connector ports 16 and/or the sensors 130. For example, the controller 140 and the connector ports 16 and/or the sensors 130 could communicate via wireless signals rather than by direct electrical coupling.

The controller 140 may communicate with an internal or local database 150. The database 150 monitors and logs patch cord interconnections with the connector ports 16. Such information may be stored in memory, such as EEPROM, associated with the database 150.

In some embodiments, an external database 155 may be included. Either database 150, 155 may comprise a software database that is dedicated to monitor and log patch cord interconnections with the connector ports 16. Either database 150, 155 may comprise a web based or Microsoft Excel based program, and may provide user friendly connectivity information and connectivity logs, for example via a display associated with a personal computer, etc. In some embodiments, the external database 155 communicates with the controller 140. In some other embodiments, the external database 155 communicates with the internal database 150. The external database 155 and the controller 140 and/or the internal database 150 may communicate via wireless signals (e.g., by electro-magnetic coupling) or by direct electrical coupling.

The patch panel 112 includes or is in communication with a display 160. More particularly, the display 160 is in communication with the controller 140. The display 160 may communicate with the controller 140 via wireless signals (e.g., by electro-magnetic coupling) or by direct electrical coupling. For example, in some embodiments, the display 160 could be a display on a handheld computing device such as a smartphone or a tablet computer that communicates wirelessly with the controller 140 using, for example Bluetooth communications or Near Field Communication (NFC) technology. The display 160 displays port identification information and real-time patch cord connection information for each respective connector port 16, as described in more detail below. The displayed patch cord connection information for each connector port 16 is dynamically updated by the controller 140 as a patch cord 20 is inserted and removed from a respective connector port 16. As used herein, dynamically updating information (e.g., patch cord connection information) is defined as updating the information in real-time.

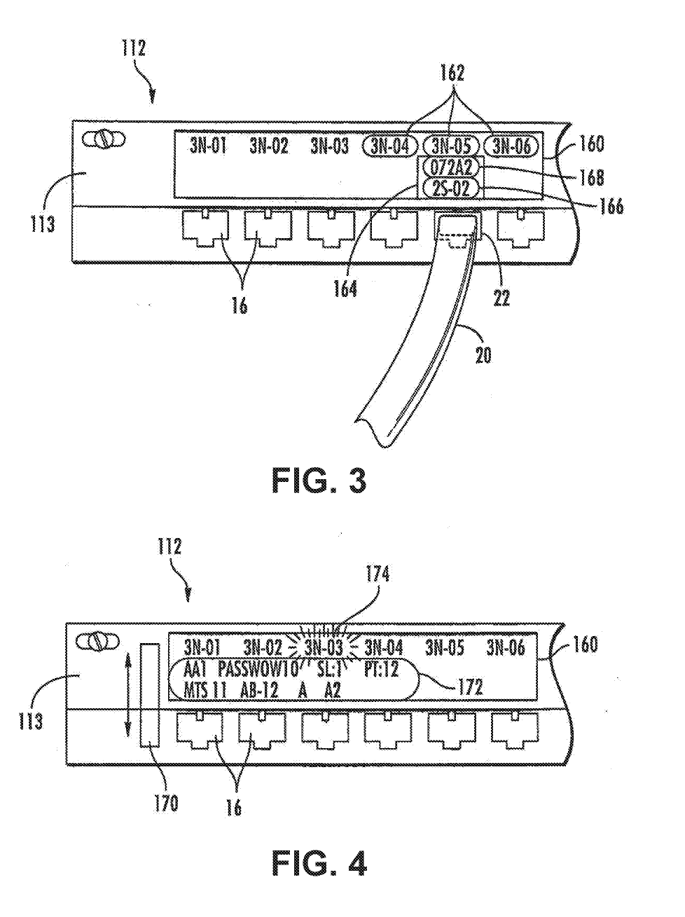

In some embodiments, the display 160 is positioned adjacent the connector ports 16. For example, the patch panel may include a front surface 113 (FIG. 3), and the display 160 may be integrated with the front surface 113 or may be visible through the front surface 113. The front surface 113 may be removable. In particular, the front surface 113 may be removed and/or replaced to repair or upgrade the patch panel 112. For example, the front surface 113 including the display 160 may be installed on a patch panel that previously included no labels or paper labels. Moreover, the front surface 113 including the display 160 may be installed when a previous display has malfunctioned or if the user wants to upgrade the display.

In some embodiments, a printed circuit board (PCB) is secured to the patch panel 112 and electrically coupled to the display 160. The PCB may be positioned adjacent to the display 160 and may provide power to the display 160. The PCB may provide interconnection with a controller and/or a controller circuit, such as the controller 140 and/or a circuit associated with the controller 140. In this regard, the PCB may serve to electrically couple the controller 140 and the display 160. As described below, in some embodiments, the display 160 comprises a plurality of adjacent, spaced-apart portions. The PCB or a plurality of PCBs may provide interconnection between the spaced-apart portions.

Turning to FIG. 3, and according to some embodiments of the present invention, the display 160 is positioned adjacent to the connector ports 16. The display 160 is configured to display port identification information 162. The port identification information 162 identifies each connector port 16 on the display 160 adjacent to the respective connector port 16. In the embodiment shown in FIG. 3, the port identification information 162 is displayed adjacent every connector port 16, regardless of whether a patch cord 20 is inserted therein. In other embodiments, the port identification information 162 may be displayed only adjacent to connector ports 16 that have patch cords 20 inserted therein.

Patch cord connection information 164 may further be displayed on the display 160 adjacent the connector ports 16. The patch cord connection information 164 may be displayed adjacent the connector ports 16 when a patch cord 20 is inserted therein. In this regard, the patch cord information 164 is dynamically updated by the controller 140 as a patch cord 20 is inserted and removed from a respective connector port 16.

In some embodiments, and as shown in FIG. 3, the patch cord connection information 164 may include end point connection information 166 to accurately locate the end point (i.e., a different connector port 16) of any patch cord 20. Furthermore, because the connectors 22 of a respective patch cord 20 have the same unique identifier, the patch cord connection information 164 may also include patch cord identification information 168 based on the unique identifier of the patch cord 20. As shown in FIG. 3, the patch cord connection information 164 may be displayed only adjacent to connector ports 16 that have patch cords 20 inserted therein.

In the embodiment exemplified in FIG. 3, the display 160 is positioned above the connector ports 16. In this regard, port identification information 162 and/or patch cord connection information 164 for each connector port 16 appear directly above the respective connector port 16. In some other embodiments, the display 160 may be positioned beneath the connector ports 16 such that port identification information 162 and/or patch cord connection information 164 for each connector port 16 appear directly below the respective connector port 16. The display 160 may be mounted on or integrated with the patch panel 112 adjacent the connector ports 16. Alternatively, the display 160 may be positioned such that the display 160 is visible through a surface of the patch panel 112 adjacent the connector ports 16. As described above, the patch panel 112 may include a front surface 113, and the display 160 may be integrated with the front surface 113 or may be visible through the front surface 113.

The display 160 may be capable of displaying more detailed connectivity information about each of the connector ports 16. Such information may include the end points of the communications link associated with a particular connector port 16 (e.g., switch and wall outlet points). The detailed connectivity information for each connector port 16 may take up multiple lines on the display 160. However, because of space and other limitations, it may not be possible for the display 160 to simultaneously display this detailed connectivity information for all the connector ports 16. This is especially the case if the display 160 is already displaying port identification information 162 and/or patch cord connection information 164 for each connector port 16.

According to some embodiments, manipulation of a user input device 170 (FIG. 4) allows a user to navigate between different layers of information on the display 160. The user input device 170 may comprise a rotatable scroll wheel. According to some embodiments, pressing the scroll wheel takes a user from a mode such as the one seen in FIG. 3, wherein port identification information 162 and/or patch cord connection information 164 is displayed, to a mode such as the one seen in FIG. 4, in which detailed connectivity information 172 associated with a particular connector port 16 is displayed. Such information may include the end points of the communications link associated with a particular connector port 16 (e.g., switch and wall outlet points). More particularly, the detailed connectivity information may represent a full communications link (i.e., inclusive of endpoints beyond the patch cord connection information 164). For example, as illustrated in FIG. 4, each block of information in the connectivity information 172 may represent an identifier for a building, floor, room, rack, patch panel, connector port or the like.

Still referring to FIG. 4, once the wheel is pressed, it may then be rotated to scroll through the connector ports 16. As a particular port 16 is selected, its port identification 174 is highlighted and the detailed connectivity information 172 for that port 16 is displayed.

Although the user input device 170 has been exemplified as a rotatable scroll wheel, it is understood that the user input device 170 may comprise any device known to those skilled in the art. It is further contemplated that the detailed connectivity information 172 may scroll across the display 160 automatically rather than in a user initiated fashion.

As illustrated in FIG. 4, the user input device 170 may be adjacent to the display 160. In some embodiments, the user input device 170 may be positioned away from the display 160 and may allow the user to remotely perform at least some of the functions described above. The user input device 170 may be logically correlated to the display 160 to facilitate remote operation.

The display 160 and the connectivity information provided thereon may comply with ANSI/TIA/EIA/606A standards, which provide guidelines for record keeping, label placement and link identification. The ANSI/TIA/EIA/606A standards are an evolving set of standards. For example, the ANSI/TIA/EIA/606A standards are a revised version of the ANSI/TIA/EIA/606 standards. It is understood that the display 160 and the connectivity information provided thereon may comply with the most recent revision of the ANSI/TIA/EIA/606A standards or the equivalent. The display 160 and the connectivity information provided thereon may further comply with other national and international standards.

The display 160 may be capable of toggling between a custom labeling scheme, such as the modes shown in FIGS. 3 and 4, and an ANSI/TIA/EIA/606A (or like national or international standard) compliant scheme. The custom labeling scheme may represent a company or organization specific standard and may be a default setting. In some embodiments, the user may toggle between a custom labeling scheme and an ANSI/TIA/EIA/606A (or like national or international standard) compliant scheme using the user input device 170. In some embodiments, wherein the user input device 170 comprises a scroll wheel, the user may press the scroll wheel to toggle between a custom labeling scheme, such as the modes shown in FIGS. 3 and 4, and an ANSI/TIA/EIA/606A (or like national or international standard) compliant scheme.

In the embodiments shown in FIGS. 3 and 4, the display 160 comprises a plurality of adjacent, spaced-apart portions such that each portion spans only some (e.g., six) of the plurality of connector ports 16 of the patch panel 112. In some embodiments, each portion of the display 160 may have a footprint about 100 millimeters by about 15 millimeters. In some embodiments, each portion of the display 160 may have a footprint no greater than 2000 square millimeters. Alternatively, in some embodiments, the display 160 may be continuous and may be adjacent to all the connector ports 16 of the patch panel 112. The size of the display 160 and/or each portion of the display 160 may be consistent with and/or dependent on the mounting pitch of the connector ports 16. In this regard, the size of the display 160 and/or each portion of the display 160 may be consistent with and/or dependent on the type of connector ports 16 (e.g., SC, LC, RJ45, MPO) associated with the patch panel 112.

The display 160 may be any type of display, including, but not limited to, a liquid crystal display (LCD), a light emitting diode (LED) display an organic light emitting diode (OLED) display, and a vacuum fluorescent display (VCD). In some embodiments, the display 160 may be backlit and/or make use of inverted colors to ensure viewability in dark spaces such as cabinets and telecommunication closets.

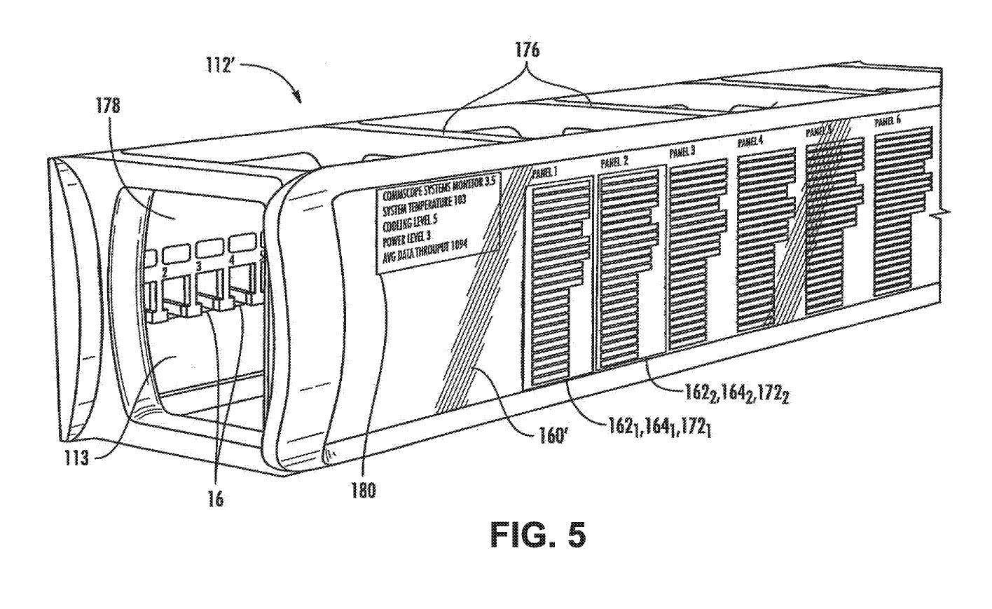

Turning now to FIG. 5, a patch panel 112′ is illustrated according to some embodiments of the present invention. The patch panel 112′ shares the same features as the patch panel 112 described above with the following differences. The patch panel 112′ includes a plurality of arms 176 extending outwardly away from the patch panel front surface 113. An electronic display 160′ is attached to the distal ends of the arms 176 and positioned in front of or substantially in front of the connector ports 16. As illustrated, the arms 176 may include openings 178 through which the connector ports 16 and/or cords connected therewith may be accessed.

Thus, the display 160′ may be spaced outwardly from the connector ports 16. This outward spacing allows for a relatively large display 160′, as compared to the display 160 that is integrated with or visible through a front surface 113 of the patch panel 112. The display 160′ may have a length that spans a substantial portion of a length of the patch panel 112′.

The relatively large size of the display 160′ may allow for more information to be displayed simultaneously. For example, the port identification information 1621 and/or patch cord connection information 1641 and/or detailed connectivity information 1721 for each connector port 16 of the patch panel 112′ may be displayed simultaneously. This information can include all of the data as described above in reference to the port identification information 162 and the patch cord connection information 164 and the detailed connectivity information 172.

The port identification information 1621 and/or patch cord connection information 1641 and/or detailed connectivity information 1721 associated with the connector ports 16 of the patch panel 112′ may take up substantially all the space on the display 160′. In some other embodiments, because of its relatively large size, the display 160′ can also display connectivity information associated with other patch panels (e.g., other patch panels on the same rack). For example, port identification information 1622 and/or patch cord connection information 1642 and/or detailed connectivity information 1722 for each connector port 16 of one or more different patch panels (e.g., a second patch panel on the same rack) may be displayed.

Thus, the display 160′ may display connectivity information for each of the ports 16 of the patch panel 112′ (i.e., each of the ports 16 of the patch panel 112′ that the display 160′ is adjacent to), or may display connectivity information for the patch panel 112′ and one or more other patch panels of a rack or a cabinet. In some embodiments, various information may scroll along the display 160′; such scrolling may be automatic or may be user initiated. In some other embodiments, the display 160′ may be a touch screen display. Such a touch screen may allow a user to scroll through information, or may allow a user to view information associated with different patch panels that are in communication with the display, for example.

In some embodiments, the display 160′ may be configured to display general information 180 in addition to the connectivity information. Thus, the relatively large display 160′ can conveniently display the general information 180, which is typically displayed remotely from a patch panel, along with labeling or connectivity information associated with the ports 16. The general information 180 can include, for example, environmental data such as the current system temperature. The general information 180 can also include such data as the current cooling level, the current power level, the current average data throughput, and the number or percent of connector ports available and/or in use.

In some embodiments, the display 160′ is optically semi-transparent or semi-translucent to allow a user to see through the display 160′ to the patch panel 112′, and particularly to the connector ports 16 and cables connected therewith.

In some embodiments, the arms 176 can include channels or grooves (not shown) for routing of cables.

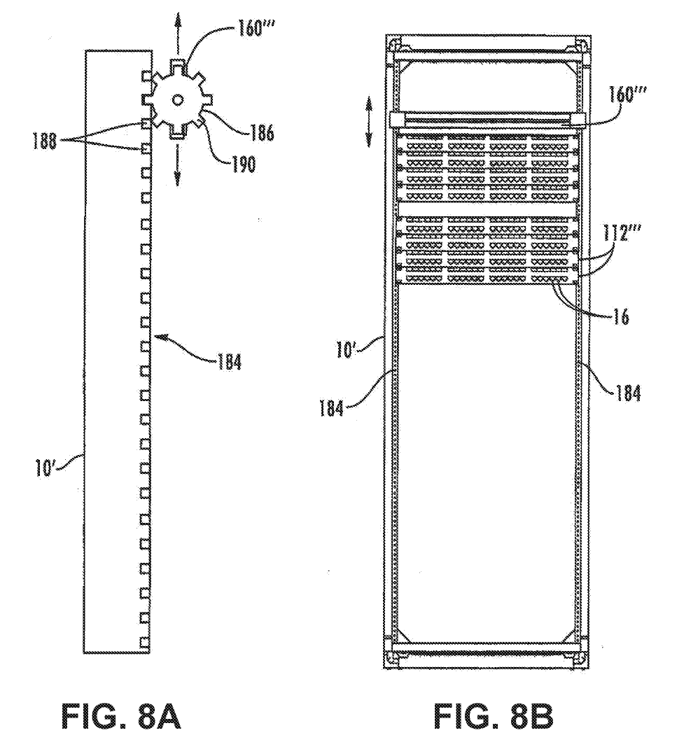

Turning now to FIGS. 8A and 8B, a patch panel system is illustrated. The system includes a frame 10′ configured to support equipment mounted thereto in a plurality of spaced-apart mounting locations. In some embodiments, the frame 10′ comprises a rack, such as the rack 10 illustrated in FIG. 1, for example. One or more patch panels 112′″ are mounted to the frame 10′ in spaced-apart locations. The system also includes at least one controller associated with the one or more patch panels 112′″. The at least one controller monitors and logs the patch cord connectivity for the one or more patch panels 112′″. In some embodiments, the controller is a rack controller. In some other embodiments, each patch panel 112′″ can include a dedicated controller, such as the controller 140 described in detail above.

The patch panel system also includes a display 160′″ movably secured to the frame 10′. The display 160′″ is configured to display patch cord connectivity information monitored by the at least one controller for the one or more patch panels 112′″. The display 160′″ is movable along the frame 10′ (as indicated by the arrows). The display 160′″ generally faces away from the patch panels 112′″.

In some embodiments, the frame 10′ includes first and second vertically oriented members 184 in an opposing spaced-apart relationship. The display 160′″ can be movably secured to at least one of the two vertically oriented members 184.

In the illustrated embodiment, the display 160′″ is attached to a wheel 186. The frame 10′ includes a plurality of apertures 188. For example, the apertures 188 may be positioned in one or both of the vertically oriented members 184 (the apertures 188 may be thought of as forming one or more “tracks”). The wheel 186 has a plurality of outwardly extending projections 190 sized and configured to fit within the apertures 188. The wheel 186 may be rotatable such that an adjacent projection 190 fits within an adjacent aperture 188 to allow translational movement of the display 160′″ (i.e., up and down movement as indicated by the arrows) while also providing electronic communication between the display 160′″ and the at least one controller.

The wheel 186 and/or the display 160′″ may include mechanisms to prevent the display 160′″ from rotating along with the wheel 186. For example, a gear may be connected to the wheel 186 and the display 160′″ may be connected to the same gear or an associated gear, with the gear(s) configured to offset any rotational movement of the wheel 186. Alternatively, the display 160′″ may be relatively loosely attached to a shaft associated with the wheel 186 such that, when the wheel 186 rotates, the shaft “slips” at its interface with the display 160′″. In this regard, the shaft urges the display 160′″ up or down as the wheel 186 rotates, but does not urge the display 160′″ to rotate with the wheel. Other mechanisms to prevent rotation of the display 160′″ are contemplated and are well known to those of skill in this art.

In some embodiments, each aperture 188 includes a contact therewithin. The contacts may provide power to the display 160′″ and/or may provide communication to the display 160′″. In particular, the contacts may serve as a communication link between the at least one controller and the display 160′″.

The apertures 188 may be positioned such that, when one of the projections 190 of the wheel 186 fits in one of the apertures 188, the display 160′″ may be positioned adjacent the connector ports 16 associated with a particular patch panel 112′″. In other words, each aperture may be associated with a particular patch panel 112′″.

In various embodiments, the apertures 188 associated with a particular patch panel 112′″ may be positioned such that the display 160′″ is above, below, or substantially in front of the patch panel 112′″ when a projection 190 of the wheel 186 is positioned in the aperture 188.

The connectivity information on the display may include information such as the port identification information 162 and/or patch cord connection information 164 and/or detailed connectivity information 172 described above in reference to FIGS. 3 and 4.

Furthermore, the display 160′″ may be relatively large because it does not need to be integrated with or visible through a front surface of a patch panel 112′″. Thus, the display 160′″ may be able to display information such as the port identification information 1621 and/or patch cord connection information 1641 and/or detailed connectivity information 1721 for each connector port 16 of the patch panel 112′ adjacent the display 160′″, and may also be able to display information such as the port identification information 1622 and/or patch cord connection information 1642 and/or detailed connectivity information 1722 for each connector port 16 of one or more different patch panels 112′″, as described above in reference the display 160′. Moreover, the display 160′″ may have a length that spans a substantial portion of a length of the patch panel 112′″.

It is understood that the display 160′″ may be movable along the frame 10′ in ways other than described above. For example, the display 160′″ may be connected to one or more carriers that are configured to move the display up and down the frame 10′. The carriers may be in tracks, such as continuous tracks, and may be controlled such that the carriers stop at certain vertical positions such that the display is positioned above, below, or substantially in front of a particular patch panel 112′″. The track can include a plurality of contacts, similar to the contacts described above with regard to the apertures 188, to provide power to the display 160′″ and/or to communicate information to the display 160′″. In some other embodiments, the display 160′″ may itself be movable and positionable along one or more tracks. For example, the display 160′″ may include arms (such as the arms 176 associated with the display 160′ in FIG. 5), and one or more of the arms could couple with one or more tracks.

There may be one track, or there may be more than one “track” in which a carrier or a wheel moves. For example, there may be two vertical continuous tracks or two vertically disposed plurality of apertures each forming a “track,” and these tracks may be located in or on the frame 10′ or may be in or on the vertically oriented members 184. Thus, a carrier or wheel may move along each of the tracks, and the display may be attached to both of the carriers or wheels.

The display 160′″ may be moved manually by an operator to a desired position. In this regard, the apertures 188 and/or the projections 190 can be configured to provide audible and/or tactile feedback to a user to help ensure the projection 190 is properly positioned in the aperture 188. In embodiments using a carrier other than the wheel 186, the track may include grooves positioned to provide the same type of feedback to a user.

Furthermore, the display 160′″ may be moved automatically in response to a command from a user. There may be a user interface device positioned on or adjacent the frame 10′, the display 160′″, or a user interface device may be positioned remotely away from the system. The display 160′″ may comprise a touch screen, similar to as described in reference to the display 160′ of FIG. 5, and the touch screen may allow a user to move and/or position the display 160′″ as desired.

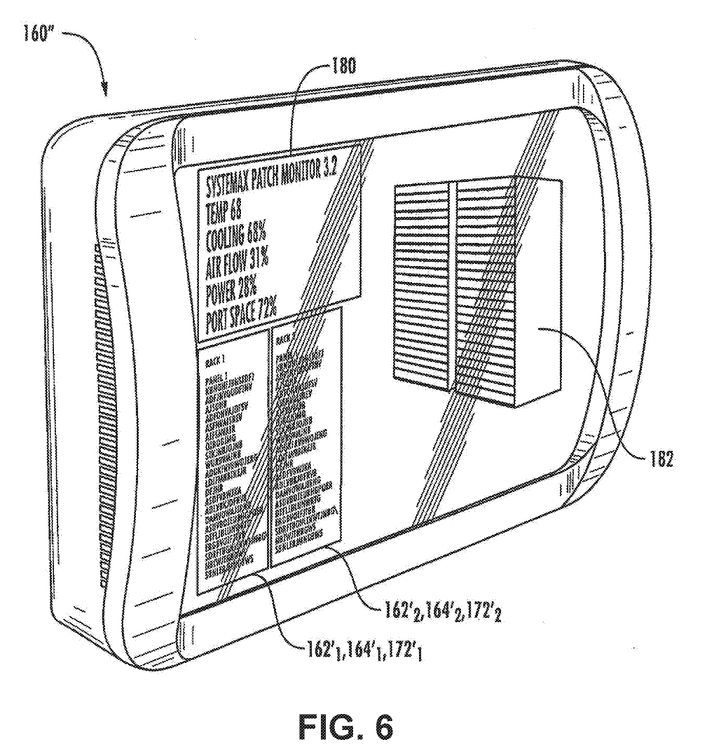

Turning now to FIG. 6, a display 160″ for use with patch panels or groups of patch panels, according to some embodiments of the present invention, is illustrated. The display 160″ may be mounted to a patch panel, to a rack, to a stand, to a wall, etc. For example, the display 160″ could be removably mounted to a frame, such as the rack 10 illustrated in FIG. 1. More particularly, the display 160″ could be removably mounted to a side of the rack. The display 160′″ may be removably mounted at about eye-level for ease of use. Alternatively, the display 160″ could be portable; for example, the display 160″ could be the display of a wireless terminal such as a PDA or smartphone. Like the previously described displays 160, 160′, and 160′″, the display 160″ communicates with one or more controllers associated with one or more patch panels.

The display 160″ may be particularly useful in environments where it is desirable to monitor a plurality of patch panels, such as in a telecom closet or a data center. The display 160″ may be configured to display connectivity information associated with patch panels of one or more racks and/or one or more cabinets, for example. In the illustrated embodiment, port identification information 162′₁ and/or patch cord connection information 162′₁ and/or detailed connectivity information 172′₂ of various patch panels of a first rack and port identification information 162′₂ and/or patch cord connection information 164′₂ and/or detailed connectivity information 172′₂ of various patch panels of a second rack can be displayed. This information can include all of the data as described above in reference to the port identification information 162 and the patch cord connection information 164 and the detailed connectivity information 172.

In some embodiments, the display 160″ comprises a touch screen configured to show a graphical representation of the racks or cabinets, such as the graphical representation 182 showing a pair of racks. Thus, a user may be able to touch a particular panel in the graphical representation 182, to display that panel's connectivity information, such as the connectivity information 162′₁ and 162′₁. In other embodiments, a separate user interface (not shown) may allow a user to select a particular patch panel. In still other embodiments, various information may scroll along the display 160″; such scrolling may be automatic or may be user initiated.

The display 160″ may simultaneously display general information 180, such as the information described above in reference to the display 160′ of FIG. 5.

It will be understood that various features of the displays 160, 160′, 160″ and 160′″ are interchangeable. It will further be understood that any of the displays are configured to display detailed connectivity information associated with a particular connector port. Such detailed connectivity information may include information about associated switches, servers, storage devices, and the like. It will also be understood that each of the displays 160, 160′, 160″ and 160′″ communicate with at least one controller, such as the controller 140 described above and illustrated in FIG. 2. This communication may be wireless or may be via direct electrical coupling.

As described in more detail above, the displays and/or their associated controllers may communicate with a database, such as an external database. The displays may be used with patch panels that do not include various sensing technology (e.g., no port sensing). These “passive panels” may be updated remotely (for example, using the database) such that any of the displays disclosed herein may still display comprehensive connectivity information. Manual updating may also be useful in other configurations, such as where the cords do not include identifiers.

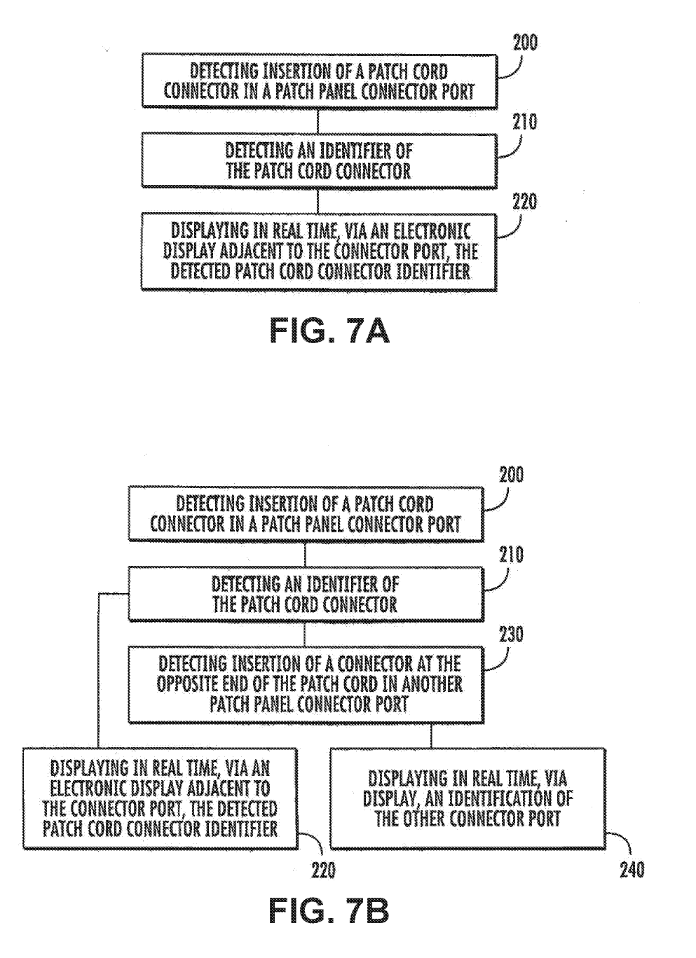

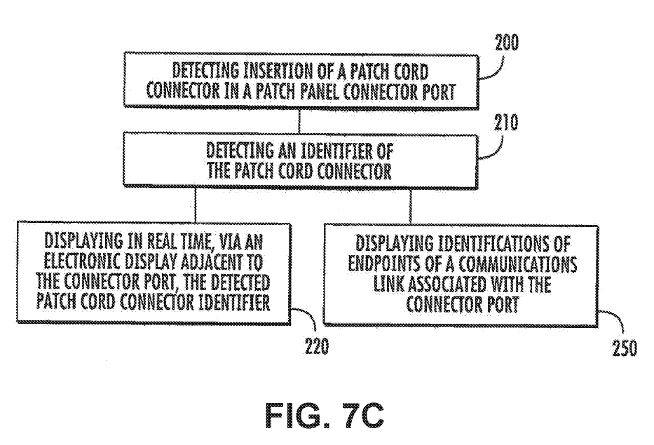

Methods of displaying patch cord connection information for a connector port of a patch panel, according to some embodiments of the present invention, are illustrated in FIGS. 7A-7C. One method (FIG. 7A) includes the steps of detecting insertion of a patch cord connector in a patch panel connector port (block 200), detecting an identifier of the patch cord connector (block 210) and displaying in real time the detected patch cord connector identifier via an electronic display adjacent to the connector port (block 220).

Another method (FIG. 7B) further includes detecting insertion of a connector at the opposite end of the patch cord in another patch panel connector port (block 230) and displaying an identification of the other connector port via the electronic display (block 240). Yet another method (FIG. 7C) further includes displaying identifications of end points of a communications link associated with the connector port (block 250).

Currently, there is a large installed base of passive (i.e., non-intelligent) patch panels and network equipment that do not include capabilities for automatically sensing patching changes and for then notifying a system controller to automatically update a connectivity database to reflect such patching changes. When technicians execute patching changes at these passive (non-intelligent) patch panels, they must update the connectivity database later, typically by entering the completed patching changes into the connectivity database using, for example, a computer. Unfortunately, when the computer that is used to update the connectivity database is not accessible at the patching field where the patching changes are made, then there necessarily is a delay between execution of the patching change and the updating of the connectivity database. In some instances, technicians may wait for hours or days before updating the connectivity database. If other technicians execute further patching changes or equipment changes before the connectivity database is updated, problems may ensue. Moreover, there is always a possibility that the technician forgets to input the changes at all, introducing errors into the connectivity database that will need to be tracked down and corrected later.

One method of avoiding such potential errors in the connectivity database is to replace the installed base of passive patch panels and network equipment with intelligent patch panels and network equipment that automatically track patching changes. However, such replacement may be very costly. Pursuant to further embodiments of the present invention, methods are provided which may partially or fully automate the process of recording patching changes that are made at passive patch panels and network equipment that may reduce the likelihood that errors arise in the connectivity database.

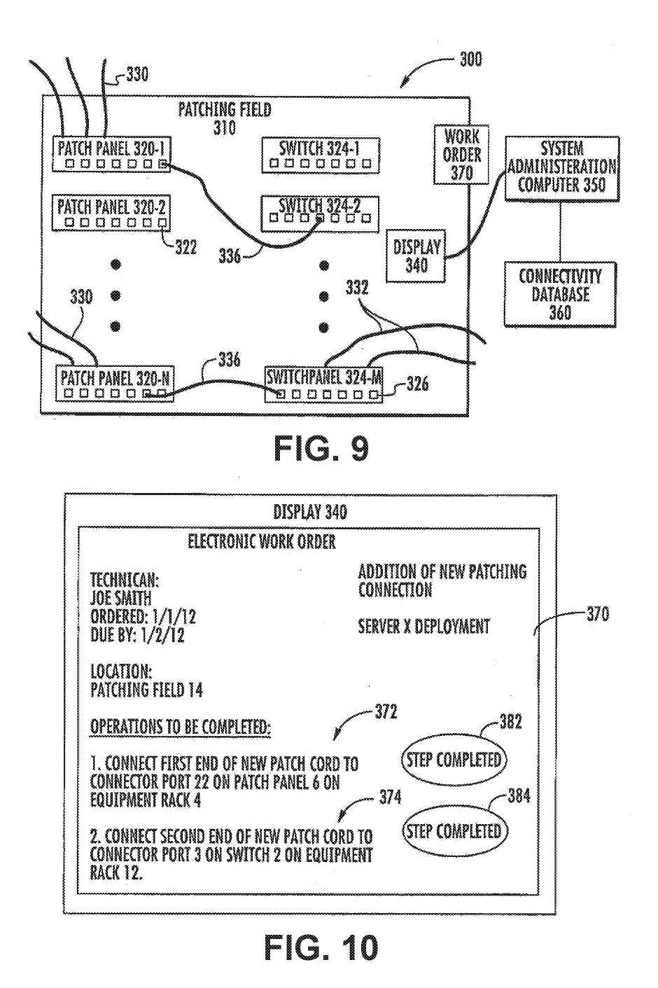

In particular, FIG. 9 is a schematic block diagram of portions of a communications system/network 300 according to further embodiments of the present invention. As shown in FIG. 9, the communications system 300 includes a patching field 310. The patching field 310 may include, for example, a plurality of rack mounted patch panels 320-1 through 320-N. Each patch panel 320 may include a plurality of connector ports 322. Horizontal cables 330 may extend from the back end of each patch panel connector port 322 (only a few representative horizontal cables 330 are depicted in FIG. 9). These horizontal cables 330 may connect (either directly or indirectly) to various other elements of the communications system 300 such as other patch panel or wall-mounted connector ports, network equipment or end user equipment. In the depicted embodiment, the patching field 310 further includes a plurality of rack-mounted network switches 324-1 through 324-M. Each network switch 324 may include a plurality of connector ports 326. Cables or patch cords 332 may connect each network switch 324 to other network equipment such as servers, routers, memory devices and the like. A plurality of patch cords 336 may be used to selectively interconnect the connector ports 322 on the patch panels 320 with the connector ports 326 on the network switches 324.

The communications system 300 further includes a system administration computer 350 and a connectivity database 360. The connectivity database 360 may include information on all of the patching connections within the communications system 300, specifically including identification as to all of the patch cord connections between patch panels (in cross-connect style patching fields) and as to all of the patch cord connections between patch panels and network equipment (in interconnect-style patching fields such as the example patching field 310 depicted in FIG. 9).

As is further shown in FIG. 9, at least one display device 340 is provided at the patching field 310. The display 340 may be connected by a wireless and/or wired connection to the system administration computer 350 and/or to the connectivity database 360. In some embodiments, the display 340 may be the display on a rack manager or controller that is included, for example, on a rack of patch panels, network switches, network equipment or the like. In other embodiments, the display 340 may be the display on a portable computing device such as, for example, a tablet computer or a smartphone that communicates with the system administration computer 350 and/or to the connectivity database 360 using, for example Bluetooth communications or Near Field Communication (NFC) technology to wirelessly communicate with a controller at the patching field that has a hardwired communication link to the system administration computer 350 and/or to the connectivity database 360. Pursuant to still further embodiments, the display 340 may be a display that is installed in a retrofit operation on or near a patch panel or network device that is subject to a patching connection change (e.g., installed on an equipment rack on which the patch panel or network switch is mounted).

When a patching change is required (i.e., when a patch cord 336 is to be added, removed or moved to connect different connector ports), a control device of the communications system 300 such as the system administration computer 350 may generate an electronic work order 370. The electronic work order 370 may be a work order that is suitable for display on an electronic display device such as the display 340. The electronic work order 370 may be transmitted from the system administrator computer 350 to the display 340 where it is displayed to a technician. The electronic work order 370 may identify the patching change that is required by, for example, identifying the type of patching change (e.g., adding a new patching connection, deleting an existing patching connection or changing an existing patching connection) and may identify the patch panel connector ports 322 and/or network equipment connector ports 326 that are impacted by the patching change. The use of electronic work orders for implementing patching changes is discussed, for example, in U.S. Pat. No. 6,522,737, the entire contents of which are incorporated herein by reference.

In some embodiments, the electronic work order 370 may comprise step-by-step instructions that specify each operation required to complete the patching change. These instructions may comprise written instructions, graphics and any other appropriate indicators that held guide the technician to perform the patching change. For example, connector ports on servers often are not labeled, and therefore the step-by-step instructions for a patching change involving a server connector port may include a picture or other graphic that includes an indicator identifying the connector port on the server that is involved in the patching change. FIG. 10 is a schematic illustration of such a step-by-step electronic work order 370 displayed on a touch-screen display 340. As shown in FIG. 10, the electronic work order 370, which in this case specifies the addition of a new patching connection, lists each step 372, 374 that is required to complete the patching change. Additionally, the electronic work order 370 includes “step completed” icons 382, 384 that are positioned adjacent the respective enumerated steps 372, 374.

The electronic work order 370 may be displayed to the technician via the display 340. In this manner, the technician is conveniently provided a paperless work order at the location of the equipment that is involved in the patching change. After reviewing the electronic work order 370, the technician may then implement the first step 372 of the patching change. For instance, in the example illustrated in FIG. 10 where the patching change is adding a new patching connection, the first step 372 of the patching change is installing the first end of the new patch cord into connector port 22 on patch panel 6 on equipment rack 4. Once the technician performs this first step 372, the technician may press the icon 382 on the touchscreen display 340. In response to this action by the technician (i.e., the activation of an input mechanism in the form of the technician pressing the icon 382), a message is sent to the system administration computer 350 that the first step 372 of the patching change identified in electronic work order 370 has been completed. The system administration computer 350 may then update the connectivity database 360 accordingly. In embodiments that do not include a touch screen display 340, the technician may use a different type of user input device that is associated with the display 340, such as a keyboard, pointer, etc., to cause a computing device that is associated with the display 340 to send the message to the system administration computer 350 and/or the connectivity database 360.

Next, the technician may perform the second step 374 of the patching change. Once the technician performs the second step 374, the technician may press the icon 384 on the display 340. In response to this action by the technician (i.e., the activation of an input mechanism in the form of the technician pressing the icon 384), a message is sent to the system administration computer 350 that the second step 374 of the patching change identified in electronic work order 370 has been completed. The system administration computer 350 may then update the connectivity database 360 to reflect the addition of the new patching connection. In this manner, the means for updating the connectivity database 360 may be largely automated (as the technician may only need to, for example, press a few buttons on the display 340), and the updates to the connectivity database 360 may be performed essentially in real time.

In some embodiments (such as the embodiment of FIG. 10 discussed above), the electronic work order 370 may be configured so that the technician is instructed to press a button or activate some other input mechanism after the completion of each step of a patching change operation. In other embodiments, the technician may complete the entire patching change operation and only then notify the connectivity database 360 that the patching change has been completed. This may allow the technician to update the connectivity database 360 by, for example, pushing a single button on a touch screen display that confirms that the patching operation has been completed. In some embodiments, the communications system 300 may be configured so that it will not deliver a subsequent electronic work order 370 to the technician until the technician confirms (via inputting information using the display 340) that the current electronic work order 370 has been completed or indicates that completion of the electronic work order 370 has been postponed or delayed. This feature may act as a safeguard that requires a technician to interact with the display 240 during (or immediately after) the execution of each electronic work order 370, which may increase the likelihood that the technician timely and accurately uses the display 340 to update the connectivity database 360 upon the completion of each electronic work order 370.

In some embodiments, the display 340 may only support patching activities for a single equipment rack, or may only display information relating to patching activities at one equipment rack at any given time. This may help reduce errors that may occur as technicians input information regarding patching changes when selecting equipment ports for patching or tracing. In other embodiments, however, patching activities regarding multiple equipment racks may be displayed on a single display 340.

As noted above, the display 340 that is provided at the patching field 310 may comprise, for example, (1) a display on a rack manager or controller, (2) a display that is retroactively installed on or adjacent to the patch panel or network switch or (3) a display on a portable computing device such as, for example, a tablet computer or a smartphone that communicates wirelessly with the system administration computer 350 and/or to the connectivity database 360 using, for example Bluetooth communications or NFC technology. In other embodiments, other emerging display technologies may be used. For example, Google Glass® is a new product that implements mobile computing technology into a pair of eyeglasses such as a pair of sunglasses to provide “intelligent” sunglasses. Information is displayed through at least one of the lenses of the pair of intelligent eyeglasses for viewing by an individual wearing the glasses (in some cases the lenses may be omitted). The individual wearing the pair of intelligent eyeglasses may input information via voice commands that are received through a microphone on the intelligent eyeglasses. Thus, in some embodiments, the steps of a patching change may be sequentially displayed to a technician on the display of the intelligent eyeglasses, and as each step is completed by the technician the technician can update the connectivity database by, for example, a voice command of “STEP COMPLETED” that is received via a microphone o the intelligent eyeglasses and used to update the connectivity database. The next step in the patching change may then be displayed on the display of the eyeglasses. Thus, it will be appreciated that in further embodiments a wearable display such as a display incorporated into a pair of intelligent eyeglasses may be used to implement the display 340.

As yet another example, wearable gesturable interfaces are being developed that include, for example, a “pocket” computing device, a pocket projector and a camera. An example of such a system is the SixthSense system, which is described at www.pranavmistry.com/projects/sixthsense. The projector may be used to project information onto any convenient surface, turning such surfaces into a display device. The camera may be used to track the movement of a user's fingers, and thus the “surface” display can be configured to act like the equivalent of a touchscreen display by tracking the user's finger movements on the display. Thus, as another example, a wearable gesturable interface may be used to implement the display 340 in other embodiments.

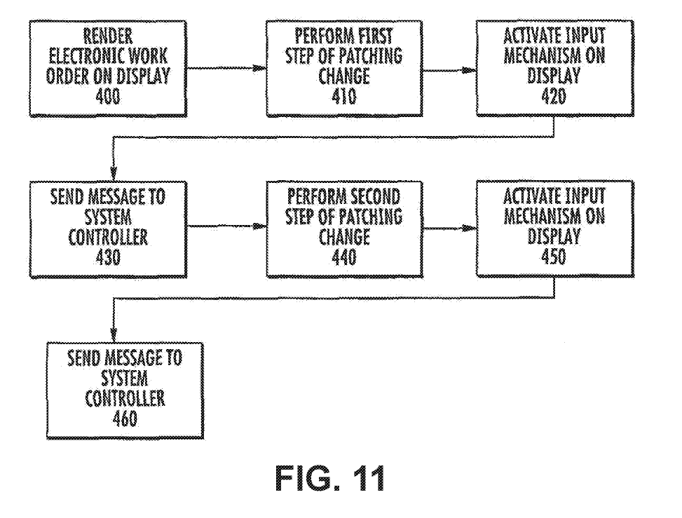

FIG. 11 is a flow chart illustrating methods of executing patching connection changes according to embodiments of the present invention. As shown in FIG. 11, operations may begin with an electronic work order being displayed to a technician on a display that is located in a patching field that includes the patching connection that is to be added, deleted or changed (block 400). The technician may then perform the first step of the patching change specified in the work order (block 410). Upon completion of this step, the technician activates an input mechanism on the display by for example, pressing an icon on a touch screen display, activating an icon on a non-touch screen display using a pointing device, etc. (block 420). Activation of this input mechanism causes a message to be sent (directly or indirectly) to a system controller (block 430). The technician may then perform the second step of the patching change specified in the work order (block 440). Upon completion of this second step, the technician again activates an input mechanism on the display (block 450). Activation of this input mechanism causes a message to be sent directly or indirectly to the system controller (block 460). The messages that are sent to the system controller may be messages indicating that the respective first and second steps have been completed. The system controller may update the connectivity database to reflect the completion of the patching change.

While the method of executing a patching connection change that is described above with respect to FIG. 11 sends messages to the system controller after the completion of each individual step of a patching change, it will be appreciated that in other embodiments the technician may only need activate the input mechanism once after the patching change is completed, at which time a single message is sent to the system controller. In still other embodiments, the electronic work order may include multiple patching changes, and the technician may only activate the input mechanism after all of the patching changes are completed, at which time a single message is sent to the system controller to notify the system controller that all of the patching changes listed in the work order were completed.

The above-described embodiments of the present invention that use a display and electronic work orders to update a connectivity database to reflect patching changes may provide a relatively inexpensive and convenient mechanism for mostly automating tracking of patching connection changes. While such a system may still be susceptible to technician errors (e.g., where a technician inserts a patch cord into, or removes a patch cord from, the incorrect connector port), it provides a simple and intuitive means for a technician to update the connectivity database, and may avoid typographical input errors that might otherwise occur (since the technician need only press a button upon completing a step or a patching change).

Embodiments of the present invention that have a technician send notification messages that update the connectivity database via a display that is located in a patching field may be particularly appropriate for use in interconnect-style patching fields where patch cords are used to directly connect connectors ports on the patch panels to corresponding connector ports on network devices such as network switches. Typically, it is more difficult or expensive to automatically track patching connection changes in interconnect-style patching systems, as network equipment is generally not available that has preinstalled capabilities for sensing patch cord plug insertions and removals and/or for determining patch cord connectivity information and transmitting that information to a connectivity database. By allowing a technician to simply and conveniently update the connectivity database by, for example, pressing a button on a touch screen display it is possible to avoid the additional expense and complexity of a fully automated patch cord connectivity tracking solution.

As noted above, in some embodiments of the present invention, the display 340 may be incorporated into or work in conjunction with a mobile system controller. The mobile system controller is a controller that may be carried or worn by a technician that displays information to a technician to assist in performing patching changes and/or which collects information that is used to automatically track patching connection changes. The use of mobile system controllers may provide a number of advantages such as, for example, the ability to use the controller with multiple equipment racks, the use of less rack space, simpler set-up of the patching system, etc. Moreover, the use of mobile system controllers may facilitate tracking patching connection changes to network switches, and other network devices without requiring any specialized tracking devices, equipment or patch cords. In some example embodiments, the mobile system controllers may be implemented, for example, on smartphones, tablet computers, intelligent eyeglasses such as Google Glass eyeglasses or on wearable gestural interfaces such as, for example, 3-dimensional sensor technology that is available from PrimeSense. In other embodiments, fixed system controllers may be used that are positioned at the patching field, but which are not necessarily mounted on or part of an equipment rack. For example, a computer and one or more cameras could be located above a patching field and positioned so that one of the cameras may view actions that are taking place at the equipment racks. The use of such mobile or fixed system controllers may allow further “intelligence” to be added to connector ports on “non-intelligent” devices such as conventional patch panels, network switches and the like.

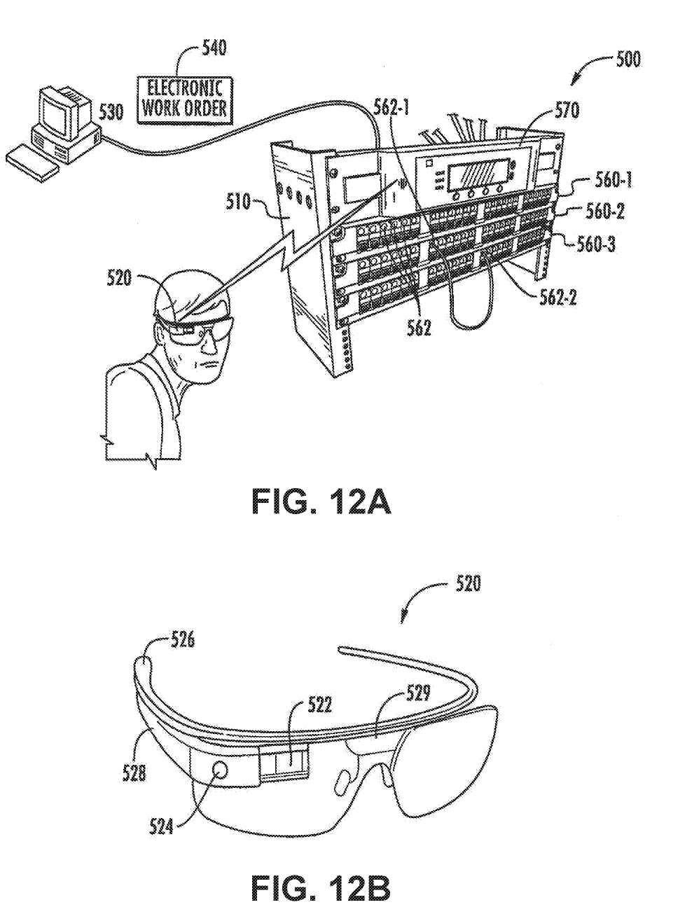

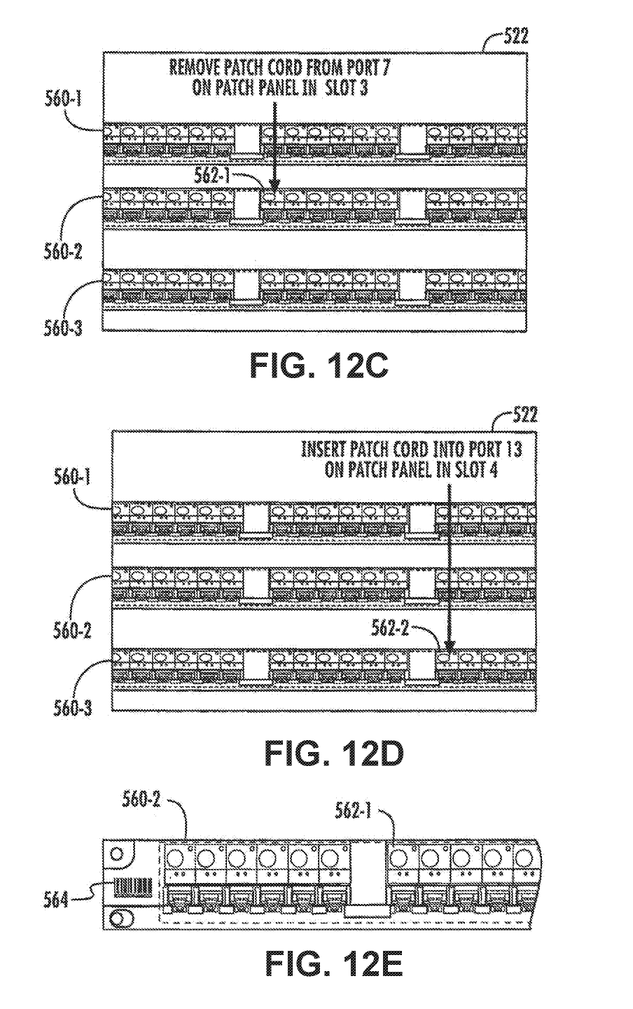

One example embodiment of a mobile system controller and the use thereof will now be described with reference to FIGS. 12A-12D. In this example embodiment, the mobile system controller is implemented using a pair of Google Glass® eyeglasses that may be worn by a technician. It will be appreciated that the Google Glass® eyeglasses are simply one example of a mobile system controller, and that other technologies may alternatively be used.

As shown in FIG. 12A, a patching change may be necessary in a patching field 500 that includes a plurality of equipment racks 510 (only one equipment rack 510 is illustrated in FIG. 12A in order to simplify the drawing) that contain patch panels, network switches and/or various other network equipment. In the depicted embodiment, three patch panels 560-1, 560-2, 560-3 are mounted on the equipment rack 510, as is a conventional rack controller 570. Each patch panel 560 includes a plurality of connector ports 562. The rack controller 570 may be in communication with a system administrator computer 530 that may be located elsewhere. The rack controller 570 may have wireless communications capabilities such as Bluetooth or NFC communications capabilities. A technician is in control of a mobile system controller 520 (i.e., the intelligent eyeglasses 520). The mobile system controller 520 may be in communications with the system administrator computer 530 via, for example, a Bluetooth communication link between the mobile system controller 520 and the rack controller 570 and a wired communications link between the rack controller 570 and the system administrator computer 530.

FIG. 12B is a perspective view of the intelligent eyeglasses 520 that comprise the mobile system controller. As shown in FIG. 12B, the intelligent eyeglasses 520 include a display 522 that the technician can view through one of the lenses of the intelligent eyeglasses 520. The eyeglasses 520 may also include a camera 524, a processor 526, a wireless communications module 528 and input/output devices 529 such as, for example, a microphone and a speaker.

Referring again to FIG. 12A, the system administrator computer 530 may initiate a patching change by transmitting an electronic work order 540 to the intelligent eyeglasses 520. In the depicted embodiment, the system administrator computer 530 transmits the electronic work order 540 to the rack controller 570 over a wired connection, and the rack controller 570 wirelessly transmits the electronic work order 540 to the intelligent eyeglasses 520 over, for example, a Bluetooth or NFC wireless connection. In other embodiments, the system administrator computer 530 may transmit the electronic work order 540 directly to the intelligent eyeglasses 520 over, for example, a wireless network (e.g., WiFi) or the cellular network. In this example, the electronic work order 540 instructs the technician to remove a first end of a patch cord 550 from a connector port 562-1 on the second patch panel 560-2 and to then plug the first end of patch cord 550 into a connector port 562-2 on a third patch panel 560-3.

As shown in FIG. 12C, the display 322 on the intelligent eyeglasses 520 may display a picture of the second patch panel 560-2, and may highlight the connector port 562-1 that the first end of patch cord 550 is to be removed from. As is also shown in FIG. 12C, the display 522 may also include explicit step-by-step instructions to the technician of the actions that will be necessary to implement the patching change specified in the electronic work order 540. As the display 522 provides a visual indicator to the technician of the connector port 562-1 that the patch cord 550 should be removed from, it may not be necessary to provide conventional visual indicators such as LEDs at each connector port on the second patch panel 560-2 that are conventionally used to guide technicians to the correct connector port.

Once the technician has removed the first end of patch cord 550 from connector port 562-2, the technician may, for example, use a voice command such as “STEP COMPLETED” to notify the intelligent eyeglasses 520 that the first end of patch cord 550 has been removed from connector port 562-1. As shown in FIG. 12D, the intelligent eyeglasses 520 may then update the display 522 to show the next step in the patching change, which in this case is plugging the first end of patch cord 550 into connector port 562-2 on patch panel 560-3. A picture or schematic image of patch panel 560-2 may be pictured on the display 522, and connector port 562-2 may be highlighted in some fashion. Once the technician has plugged the first end of patch cord 550 into the connector port 562-2, the technician may, for example, use a voice command such as “STEP COMPLETED” to notify the intelligent eyeglasses 520 that the first end of patch cord 550 has been plugged into connector port 562-2. The intelligent eyeglasses 520 may then transmit a message to the system administrator computer 530 that the first end of patch cord 550 has been inserted into connector port 562-2 on patch panel 560-2.

In still further embodiments, the mobile system controller 520 may fully automate tracking the connectivity changes associated with each patching change. For example, in further embodiments, the intelligent eyeglasses 520 in the example above may be configured to “sense” the insertion and removal of patch cords from the patch panels 560 and other network equipment that is mounted on the equipment racks 510, and to then transmit information regarding the detected patch cord insertion or removal to another controller such as the system administrator computer 530 that runs the network management software

For example, as shown in FIG. 12E, which is a schematic close-up view of the patch panel 560-2, a readable label such as a bar code 564 may be provided on each patch panel and other items of equipment mounted on the equipment racks 510. The intelligent eyeglasses 520 may include barcode scanning software. The intelligent eyeglasses 520 may be programmed to use the camera 524 to automatically identify and read the barcodes (such as barcode 564) on the patch panels and other equipment. The barcode 564 may have data embedded therein such as equipment identification information (e.g., a patch panel identification number) and information on the type of equipment (e.g., a Systimax GS6 version 3.1 24-port patch panel). Once the intelligent eyeglasses 520 locate the patch panel 560-2, they may query a database to determine the location of connector port 562 on patch panel 560-2. Images taken using the camera 524 may then be compared, for example, to stored images to determine whether the first end 552 of patch cord 550 has been removed from connector port 562-1. Once the intelligent eyeglasses 520 sense that the patch cord 550 has been removed from connector port 562-1 (by, for example, obtaining an image on camera 524 of connector port 562-1 that matches a stored image of connector port 562-1 with no patch cord inserted therein), then the intelligent eyeglasses 520 may transmit an instruction to a central controller such as the system administrator computer 530 indicating that the first end 552 of patch cord 550 has been removed from connector port 562-1.

In still other embodiments, bar codes or other optical identifiers may be provided on each patch cord (e.g., on the strain relief boot of each plug) and each connector port. In such embodiments, the system may simply scan a piece of equipment (e.g., a patch panel or a network switch) or an entire equipment rack and automatically determine which patch cords are connected where. So long as the patch cords are arranged so that the scanner is able to scan each identifier, these embodiments may provide a very simple way to track all of the patching cord connections in a patching field.

In some embodiments, the camera 524 and barcode scanning software on the intelligent eyeglasses 520 may also be used to identify any errors that the technician may make in implementing a patching change. In particular, when a technician is inserting or removing a patch cord from a connector port, they will typically look directly at the connector port that is involved in the patching change. The camera 524 may have a relatively wide field of view, as this may facilitate capturing images of barcodes 564 that may be mounted on a piece of equipment (e.g., a patch panel or a network switch) at some distance from at least some of the connector ports on the piece of the equipment. However, the central portion of each image captured by the camera 524 will typically focus on the connector port that is involved in the patching change (and perhaps a small number of other connector ports). The intelligent eyeglasses 520 may be programmed to process the central portions of the images captured by the camera 524 to determine the identity of the connector ports in the central portion of the field of view and the status of those connector ports (e.g., they do or do not have a patch cord inserted therein). This information may be forwarded to the system administration computer 530 and compared to stored information regarding which of these connector ports should have patch cords therein. If a determination is made that a patch cord has been plugged into a connector port that is not supposed to have a patch cord therein (or that a patch cord has been removed from a connector port that should still have a patch cord plugged into it), an error message may be generated and transmitted to the technician, where it may be provided to the technician via an output device such as a speaker on the intelligent eyeglasses 520 or as an error message on the display 522. In this fashion, not only can the intelligent eyeglasses 520 be used to (1) lead the technician through the steps of the patching change and (2) automatically update the connectivity database in real time as the steps of the patching change are carried out, but they may also be used to (3) identify any errors made by the technician, such as removing the wrong patch cord from the wrong connector port or plugging a patch cord into the wrong connector port, and to then identify these errors to the technician in real time in the patching field 500. This may result in significant time savings since technicians may immediately correct their mistakes as opposed to having to retrace their steps later to do so.

Thus, in the example above, once the technician has removed the first end 552 of patch cord 550 from connector port 562-1, the intelligent eyeglasses 520 may sense that the patch cord 550 has been removed by comparing an image of connector port 562-1 that is captured by the camera 524 to a stored image (or other information) that is sufficient for the processor 526 in the intelligent eyeglasses 520 to determine that the image indicates that the connector port 562-1 no longer has a patch cord inserted therein. The intelligent eyeglasses 520 may then transmit a message to the system administrator computer 530 that the first end 552 of patch cord 550 has been removed from connector port 562.

It will be readily apparent from the above examples that the mobile system controllers according to embodiments of the present invention may be used to automatically track patching connections to not only patch panels, but also to any other type of equipment that receives patch cords including network switches, servers, routers, SANS, etc. Typically, these other types of equipment cannot be purchased with intelligent patching capabilities, and thus embodiments of the present invention may make it much easier to automatically track patching connections to these other types of equipment.

In the embodiments described above with respect to FIGS. 12A-12E, the mobile system controller 520 in the form of a pair of intelligent eyeglasses automatically pairs with the rack controller 570 on each equipment rack when the technician stands in front of the equipment rack via, for example, a wireless communications link. Each rack controller 570 is in wired communication with a system administration computer 530 that runs the network management software and updates the connectivity database. It will be appreciated, however, that numerous modifications may be made to this arrangement pursuant to the teachings of the present invention.

For example, in further embodiments, different communications means may be used, such as wireless communications between each rack controller 570 and the system administrator computer 530 (e.g., over a WiFi network) or wired communications between the mobile system controller 520 and the rack controller 570 (e.g., by connecting a tablet computer based mobile system controller 520 to the rack controller 570 via a wired connection). As another example, in still other embodiments each row or aisle of equipment racks (e.g., in a data center) may have a single “row controller” that provides intelligent patching functionality for the entire row or aisle of equipment racks. The mobile system controller 520 (e.g., the above-described intelligent eyeglasses 520) automatically pairs with the row controller when the technician stands in front of the row (or in the aisle in the case of an “aisle controller”) via, for example, a wireless communications link. Each row/aisle controller is in wired communication with the system administration computer 530 that runs the network management software and updates the connectivity database. Each equipment rack may have a bar code or some other identification that may be processed optically or electrically by the intelligent eyeglasses 520 so that the intelligent eyeglasses 520 will be able to distinguish between different equipment racks and associate the equipment racks with information stored in a database regarding the equipment that is mounted on the rack. In these embodiments, as with the embodiments described above where the intelligent eyeglasses 520 communicate with a rack controller 570, the intelligent eyeglasses 520 may be used as both a display that guides the technician through patching connection changes and as an input device that collects and tracks information regarding patching connection changes and forwards this information to the system administrator computer 530 for use in updating the connectivity database.

In still further embodiments, the rack/row/aisle controllers may be omitted, and the intelligent eyeglasses 520 may communicate wirelessly with the system administrator computer 530 via, for example, a WiFi or broadband wireless network. In these embodiments, each equipment rack may again include a bar code or other identifier that may be processed optically or electrically by the intelligent eyeglasses 520 so that the intelligent eyeglasses 520 will be able to distinguish between different equipment racks and associate the equipment racks with information stored in a database regarding the equipment that is mounted on each rack.

It will likewise be appreciated that the intelligent patching control functions may be carried out in any appropriate location, and may all be carried out in a single location or the functions may be distributed and carried out at multiple locations. For example, in some of the above-described embodiments, processing capabilities are provided at the mobile system controller 520 (e.g., the intelligent eyeglasses 520), at the rack/row/aisle controllers 570, and at the system administrator computer 530. Any of these “controllers” may, for example, run the system management software, update the connectivity database, store information regarding the equipment mounted on the equipment racks, generate the electronic work orders or perform any other operations used to assist technicians in making patching connection changes or in automatically tracking such patching changes. Thus, while the descriptions above provide examples as to how various functions may be distributed across these controllers, it will be appreciated that numerous other distributions are possible, and that more or fewer controllers may be provided.

While the eyeglasses 520 represent one type of system controller, it will be appreciated that other types of system controllers may be used, including fixed system controllers. For example, cameras may be mounted on equipment racks, in overhead locations, etc. that are used in place of the camera 524 on the intelligent eyeglasses 520. These cameras may have associated processors that perform the image processing that is described above that is used to detect patch cord insertions and removals and that is used to identify the connector ports where these patch cord insertions and removals occurred. Thus, it will be appreciated that any appropriate system controller may be used. The concept is that the intelligence is moved from the patch panels to one or more other mobile or fixed devices (i.e., the mobile or fixed system controllers described above) that are used to detect patch cord insertions and removals and to update the connectivity database using this information. Additionally, by using an electronic work order system in conjunction with the mobile or fixed system controllers that are present in the patching fields, the system may detect errors made by technicians during patching changes and notify the technicians of these errors almost immediately.

In still further embodiments, the mobile system controller may be implemented to include both a display and 3-dimensional scanning technology such as, for example, the 3-dimensional scanning technology available from PrimeSense, which may be implemented, for example, in a single device such as a pair of intelligent eyeglasses. In example embodiments, identifiers such as bar codes may be provided on the patch cords and pieces of equipment. The 3-dimensional scanning technology may be used to scan the equipment on each equipment rack and to recognize which patch cords (which can be identified by their bar codes) are plugged into which connector ports (which can be identified by the bar codes on each piece of equipment and stored information regarding the connector port layout on each piece of equipment, or barcodes at each connector port). Thus, in these embodiments, the mobile system controller may be used to automatically scan the equipment racks and populate the connectivity database. When patching connection changes are made, the mobile system controller can identify such changes from the 3-dimensional scans and update the connectivity database to reflect the patching connection changes. Thus, in some embodiments, highly automated intelligent patch cord tracking may be provided without the need for special patch panels, network switches, patch cords or the like.

Pursuant to still further embodiments of the present invention, the display that is provided in the patching field (e.g., display 340 of FIGS. 9-10 or display 522 of FIGS. 12A-D) may be used to provide a technician information which may be used to diagnose identified problems or error situations. For example, in some embodiments, a technician may send a request to, for example, the system administrator computer that an “audit trail” be displayed on the display 340/522 for a particular connector port. This audit trail may show, for example, a history of the connections to the connector port including for example, identification of the end devices and intermediate points of those connections. This connection history information may be helpful to the technician in identifying the cause of an unanticipated problem in the network.

The intelligent eyeglasses (or other wearable computing device) can also use augmented reality (AR) technology to present information to the user. For example, a software-generated overlay image can be generated and superimposed over the user's view of the real world. This software-generated overlay image (also referred to here as an “overlay”) can include various features, such as features that identify or provide information about a rack, equipment in a rack (or a part of such equipment such as a port) or that identify or provide information about a work order (or a step thereof) and features by which a user can select or provide an input related to the rack, equipment (or part thereof), or a work order (or a step thereof). AR technology can be used with any type of AR device including, without limitation, wearable devices (such as devices using three-dimensional (3D) holographic-lenses) and non-wearable devices (such as smartphones, tablets, handheld computers, etc., with a camera).

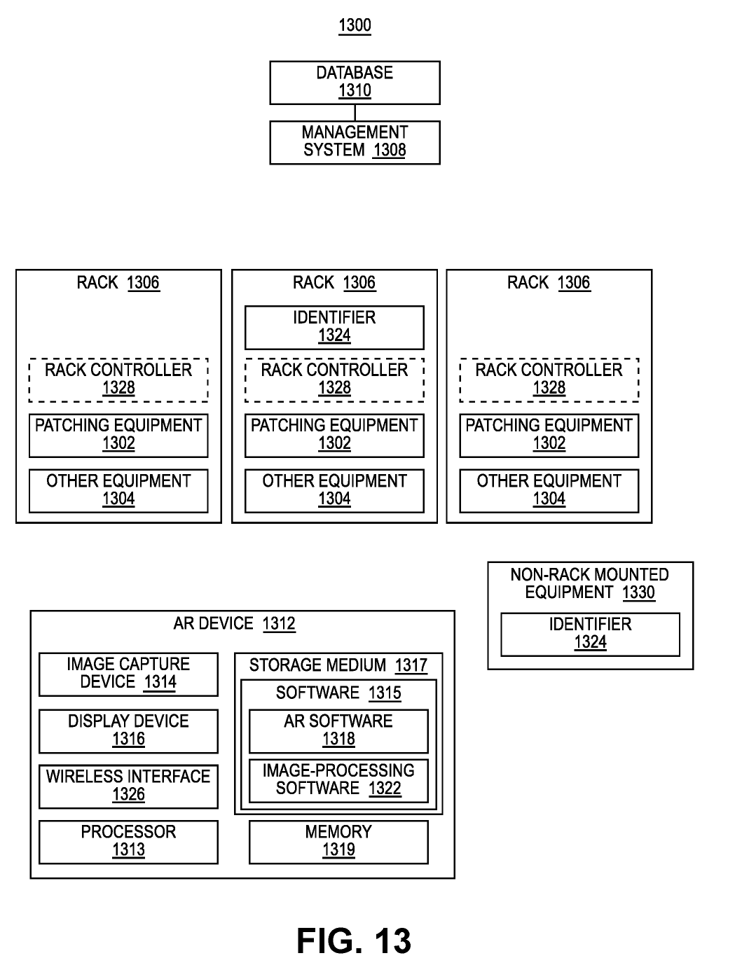

FIG. 13 is a high-level block diagram of one exemplary embodiment of a system 1300 that tracks connections made using patching equipment 1302 (such as patch panels) and other types of equipment 1304 (also referred to here as “other equipment” 1304) (such as servers, switches, and routers). In this example, the patching equipment 1302 and the other equipment 1304 is installed in racks 1306. The racks 1306 can be deployed in a data center, enterprise facility, a central office or other facility of a telecommunication service provider and/or in another part of the telecommunication service provider's network (such as the outside plant).

One advantage of using the AR technology described here is that they do not require the patching and other equipment to be “intelligent” (that is, to have special functionality that can be used to automatically track cable connections at the ports of such equipment). That is, such AR technology can be used to track connections made at “standard” (non-intelligent) patching equipment 1302 and other equipment 1304. However, it is to be understood that the AR technology described here can be used with intelligent patching and other equipment and/or combinations of intelligent and non-intelligent patching and other equipment (such as media converters, multiplexers, mainframes, power strips, etc.).

The system 1300 comprises a management system 1308 (like the system controller described above) that is configured to track the connections made at the equipment installed in the racks 1306. The system 1300 further comprises a database 1310 in which information about the connections, racks, and equipment is stored. The management system 1308, for example, can be deployed on a server computer. The management system 1308 can be co-located with the racks 1306 or can be located remotely (for example, deployed in a different facility).

In general, the management system 1308 operates as described above in connection with the prior embodiments.

In this exemplary embodiment, the racks 1306 comprise racks having a standard width (also referred to here as “standard racks”). For example, in enterprise applications, standard racks 1306 having a standard width of 19 inches are commonly used, and standard racks 1306 having a standard width of 23 inches are also commonly used in telecommunication service provider applications. Standard racks 1306 having different standard widths can also be used. Each standard rack 1306 is divided into a predetermined number of regions (or fractions thereof), each region having a standard height. In the example described here, the standard height is also referred to as a “rack unit” or “U,” which is standardized at 1.752 inches (or 44.50 millimeters). As used herein, each such 1U-region is also referred to here as a “rack position.” It is to be understood that the predetermined regions can be defined in other ways (for example, using regions having different standard heights). Also, although in the examples described here, the standard width for each standard rack 1306 is the same and the standard height for each region (rack position) is the same, in other embodiments, the standard width of the standard racks 1306 can vary from rack to rack and/or the standard height can vary from region to region.

In this example, the height of the equipment installed in the racks 1306 is a multiple of a rack unit or a fraction of a rack unit. For example, a server can have a height of 3 rack units or 3U, in which case that server would take up three rack positions when installed in the rack 1306. In other examples, the servers have other heights (for example, patching or other equipment can have a height that is a fraction of a rack unit). In this example, the width of the equipment is also standardized (at 19 inches in this example).

The management system 1308 is configured to store in the database 1310 dimensional information about each standard rack 1306 (for example, the height, width, relative location of the first, second, etc., number or fraction of rack positions in the rack 1306, location of the rack 1306, relation of the rack 1306 to other racks 1306, etc.).

The management system 1308 is also configured to store (at least) the height for each item of equipment installed in a rack 1306. The height can be stored in the database 1310 as a number or fraction of rack units (or alternatively, the height can be stored in the database 1310 as inches or other standard unit of measurement and the number or fraction of rack units can be determined therefrom as needed). The management system 1308 is also configured to store in the database 1310, for each item of equipment installed in the rack 1306, the position in the rack 1306 where that item of equipment is installed.

The system 1300 further comprises an AR device 1312. In this example, the AR device 1312 is implemented using intelligent eyeglasses of the type described above. In other examples, the AR device 1312 is implemented in other ways (for example, using other wearable AR devices or using a tablet or smartphone). It is to be understood that any type of AR device can be used, including, without limitation, wearable devices (such as devices using 3D holographic-lenses) and non-wearable devices (such as smartphones, tablets, handheld computers, etc., with a camera).

The AR device 1312 comprises an image-capture device 1314 and a display device 1316. The AR device 1312 is configured to display (using the display device 1316) a software-generated overlay image superimposed over the user's view of the real word.

The image-capture device 1314 is used to capture an image of what the user is current looking at using the AR device 1312. In this example, the AR device 1312 is configured to zoom in or out (either optically or digitally) when capturing images using the image-capture device 1314.

The AR device 1312 comprises at least one programmable processor 1313 on which software or firmware 1315 executes. The software 1315 comprises program instructions that are stored (or otherwise embodied) on an appropriate non-transitory storage medium or media 1317 from which at least a portion of the program instructions are read by the programmable processor 1313 for execution thereby. The software 1315 is configured to cause the processor 1313 to carry out at least some of the operations described here as being performed by that AR device 1312. Although the storage medium 1317 is shown in FIG. 13 as being included in the AR device 1312, it is to be understood that remote storage media (for example, storage media that is accessible over a network) and/or removable media can also be used. In one aspect illustrated in FIG. 13, each AR device 1312 also comprises memory 1319 for storing the program instructions and any related data during execution of the software 1315.

The system 1300 further comprises AR software 1318 that is configured to generate the software-generated overlay image that is superimposed over the user's view of the real word. In this example, at least a part of the AR software 1318 executes on the processor 1313 included in the AR device 1312. However, it is to be understood that at least a part of the AR software 1318 can be implemented on a device other than the AR device 1312 (for example, on the device that is used to implement the management system 1308 or a rack controller 1328 (described below)).

The system 1300 further comprises image-processing software 1322. In this example, at least a part of the image-processing software 1322 executes on the processor 1313 included in the AR device 1312. However, it is to be understood that at least a part of the image-processing software 1322 can be implemented on a device other than the AR device 1312 (for example, on the device that is used to implement the management system 1308 or a rack controller 1328 (described below)).

In this example, the image-processing software 1322 is configured to identify and decode an identifier 1324 that is associated with one or more of the rack 1306 and/or the equipment installed in the rack 1306. In one example, each identifier 1324 comprises a bar code, QR code, text label. Each identifier 1324 can be implemented, for example, using a printed adhesive label, or an electronic display device (for example, a liquid crystal or E-ink display), or using one or more light emitting diodes (LEDs) that are strobed to encode an identifier (for example, using Morse code or other scheme). The identifiers 1324 can be attached or integrated into the rack 1306 or equipment installed into the racks 1306. The identifiers 1324 can be associated with the cables connected to the ports of the equipment installed in the racks 1306.

The identifier 1324 associated with a rack 1306 and/or equipment installed therein can also be attached to a structure near the rack 1306 (for example, a wall, pole, floor, ceiling, door, etc.).

The image-processing software 1322 can also be configured to capture the location within the associated image where the identifier 1324 was detected.

In one implementation, the AR device 1312 is configured so that the detecting and decoding of any identifiers 1324 in images captured by the AR device 1312 is performed in response to an input from the user (for example, in response to the user selecting a button displayed as a part of the user interface for the AR device 1312). In other implementations, the image-processing software 1322 is configured to continuously scan for identifiers 1324, digitally zooming in on the captured images as necessary. This can be done so that the user does not need to explicitly select a button to initiate the detecting and decoding of identifiers 1324 in the captured images.

The management system 1308 stores the identifier 1324 (and optionally the relative location of the identifier 1324) that is associated with each rack 1324 or other item of equipment. As a result, each identifier 1324 that is decoded by the image-processing software 1322 can then be used to identify which particular rack 1306 or item of equipment is shown in the user's view and obtain information about that particular rack 1306 or item of equipment from the management system 1308.

Also, the management system 1308 tracks which equipment is installed in each rack 1306. Therefore, the identifier 1324 associated with each rack 1306 can also be used to identify which equipment is installed in that rack 1306 (if, for example, one or more items of such equipment do not have separate identifiers 1324 attached to them).

In one usage example, a single identifier 1324 is attached to one rack 1306 in each row of racks 1306. The user can then use the AR device 1312 to detect and decode that identifier 1324. Then, that identifier 1324 can be used to identify all of the racks 1306 in that row and the equipment installed in those racks 1306. In other usage examples, identifiers 1324 are attached to more or different racks 1036 or equipment.

As noted above, the management system 1308 stores dimensional information for the racks 1306 and equipment installed in the racks 1306. The dimensional information for the racks 1306 can be used by the image-processing software 1322 to detect the rack 1306 in the captured images and the equipment installed in the racks 1306.

In this example, as noted above, the racks 1306 comprise standard 19-inch wide racks that are divided into a predetermined number of rack positions having a standard height, and the height of the equipment installed in the racks 1306 is a multiple of a rack unit. The database 1310 stores dimensional information about each standard rack 1306 (for example, the height, width, relative location of the first, second, etc. rack positions in the rack 1306, etc.), which equipment is installed each rack 1306, the position in the rack 1306 where each item of equipment is installed, and the height of each item of equipment installed in a rack 1306.

The dimensional information can be used by the image-processing software 1322 to detect (using, for example, conventional feature extraction techniques) each rack 1306 within the captured images and to determine the perimeter of each rack position within each rack 1306, which in turn can be used to identify the equipment installed in the rack 1306.

For example, if an item of equipment installed in a rack 1306 is 3U high and is installed in the first, second, and third rack positions, then the image-processing software 1322 knows that the item of equipment is installed in the first, second, and third rack positions that it detects in the captured images.

Conventional objection-detection processing that could be used to detect the racks 1306 and the equipment installed in the racks 1306 (and ports or other parts thereof and cables and connectors used therewith) from the images captured by the AR device 1312 typically requires detailed three-dimensional (3D) models of the objects that are to be identified and detected. However, the vendor selling the system 1300 may not be able to obtain such three-dimensional models for the racks 1306 and the equipment installed in the racks 1306 (and ports or other parts thereof and cables and connectors used therewith). For example, equipment may be sold by a different vendor that is not willing or able to provide 3D models for such equipment to the vendor selling the system 1300. Also, cables connected to equipment installed in a rack may significantly obstruct the view of the equipment (and ports or other parts thereof and cables and connectors used therewith).

By using the identifier 1324 to identify the racks 1306 and the equipment installed in the racks 1306 (and ports or other parts thereof and cables and connectors used therewith), such 3D-model-based image-processing need not be the only technique used to identify the equipment installed in the racks 1306. The image-processing necessary to identify, detect, and decode the identifier 1324 from the images captured by the AR device 1312 is relatively accurate and resource efficient, relative to the conventional image-processing used to identify and detect the racks 1306 and equipment installed the racks 1306 (and ports or other parts thereof and cables and connectors used therewith) from the images captured by the AR device 1312. It is to be understood that that 3D-model-based image-processing can also be used in combination with the identifier-based techniques described here.

The image-processing software 1322 is also configured so that, once an object is detected in the captured images, the software 1322 tracks changes in the location of the detected object in the captured images. Such tracking can take into account any zooming in or out of the images initiated by the user (for example, where the user first zooms in the captured images to detect and decode an identifier 1324 and, thereafter, zooms out the captured images to see the larger field of view and the row of racks 1306 and equipment installed therein).

The image-processing software 1322 is also configured to identify gestures that are performed by the user of the AR device 1312 (such as “touching” particular virtual objects displayed in the user's field of view as described in more detailed below, dragging such virtual objects, etc.).

Moreover, in this embodiment, the management system 1308 tracks and stores information about various ports or other parts of (at least some) of the equipment installed in the racks 1306. Examples of ports include, without limitation, communication ports and power ports. Examples of such other parts of the equipment installed in the racks 1306 include, without limitation, cards, Gigabit Interface Converter (GBIC) slots, add-on modules, etc. More specifically, this information includes the number of ports and a region associated with each port. As used herein, a “region” for a port or other part of such equipment refers to region that includes only that port or part and no other. This region can have a shape that comprises the precise perimeter of that port or other part or have a simplified shape (for example, a rectangle, circle, or other polygon). The information about the various ports or other parts of equipment also includes information about the location of the region relative to the perimeter of that item of equipment.

The AR device 1312 further comprises a wireless interface 1326 for wirelessly communicating with the management system 1308. The wireless interface 1326 can use any suitable wireless protocol to communicate with the management system 1308 (for example, one or more of the BLUETOOTH family of standards, one or more of the IEEE 802.11 family of standards, near-field communication (NFC), cellular, etc.). The AR device 1312 can be directly connected to the management system 1308 (for example, where the management system 1308 is co-located with the racks 1306 so that the AR device 1312 can establish a direct wireless connection with the management system 1308) or an indirect connection with the management system 1308 (for example, via a local area network and/or a wide area network, and/or the Internet). Another way that the AR device 1312 can be indirectly connected to the management system 1308 is via a rack controller 1328. In such an example, the AR device 1312 uses a direction wireless connection to the rack controller 1328 in order to access the management system 1308 and database 1310. Also, the AR device 1312 can be configured to operate off-line (for example, in the event that it is not possible to establish a wireless or wired connection with the management system 1308 and database 1310 in some way). This can be done by first storing any captured information locally within the AR device 1312 (for example, in the storage medium 1317 or memory 1319) and then, at a later point in time, downloading the information to the management system 1308 and database 1310 (for example, at a later point in time when the AR device 1312 can establish a wireless or wired connection to the management system 1308 and database 1310).

Also, the system 1300 can optionally include one or more rack controllers 1328. If rack controllers 1328 are used, each rack controller 1328 is communicatively coupled to the management system 1308. In one implementation where multiple rack controllers 1328 are used, the rack controllers 1328 can be daisy chained together with the head of the daisy chain connected to a local area network (or other external network connection) in order to couple each rack controller 1328 to the management system 1308.

In general, the rack controllers 1328 operate as described above in connection with previous embodiments.

If a rack controller 1328 is used, the AR device 1312 can connect to the management system 1308 via a rack controller 1328 and the connection it has to the management system 1308. That is, the AR device 1312 can establish a direct wireless connection with a rack controller 1328, where such wireless connection is used to communicate with the management system 1308 via the rack controller's connection to the management system 1308.

The techniques described here can also be used with non-rack-mounted equipment 1330 such as IP telephones, wall outlets, wireless access points, cameras, printers, light fixtures, heating/ventilation/air conditioning (HVAC) controllers, access controllers, badge readers, etc. For example, an identifier 1324 of the type described above can be attached to such non-rack-mounted equipment 1330. The AR device 1312 can be used to read the identifier 1324 and identify that item of equipment 1330 as described above and, in response, the outer perimeter of that equipment 1330 can be detected (for example, using conventional edge-detection image processing that does not involve the use of 3D-model-based image-processing) for use in defining emphasis features and interactive regions as described detail below. Other embodiments can be implemented in other ways.

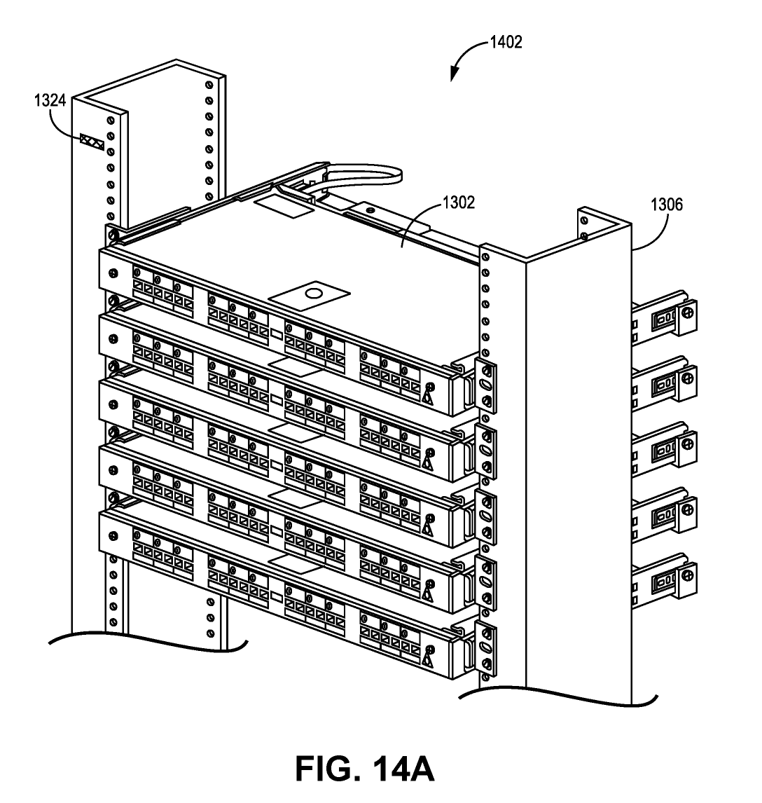

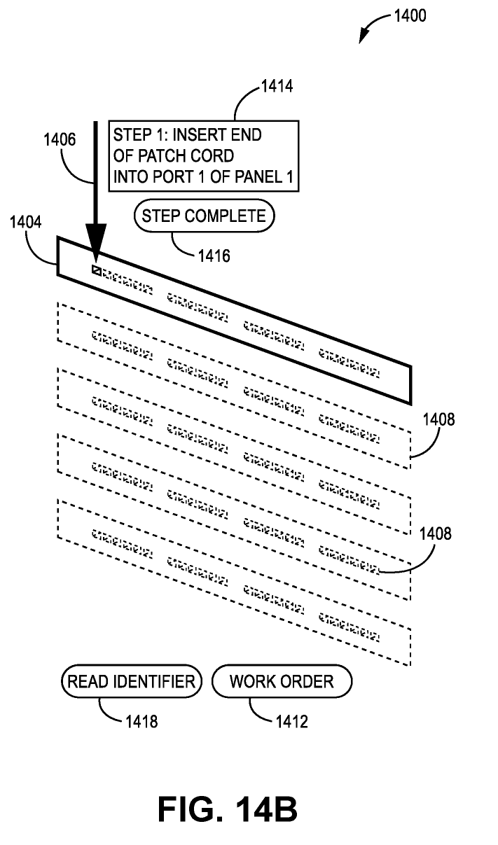

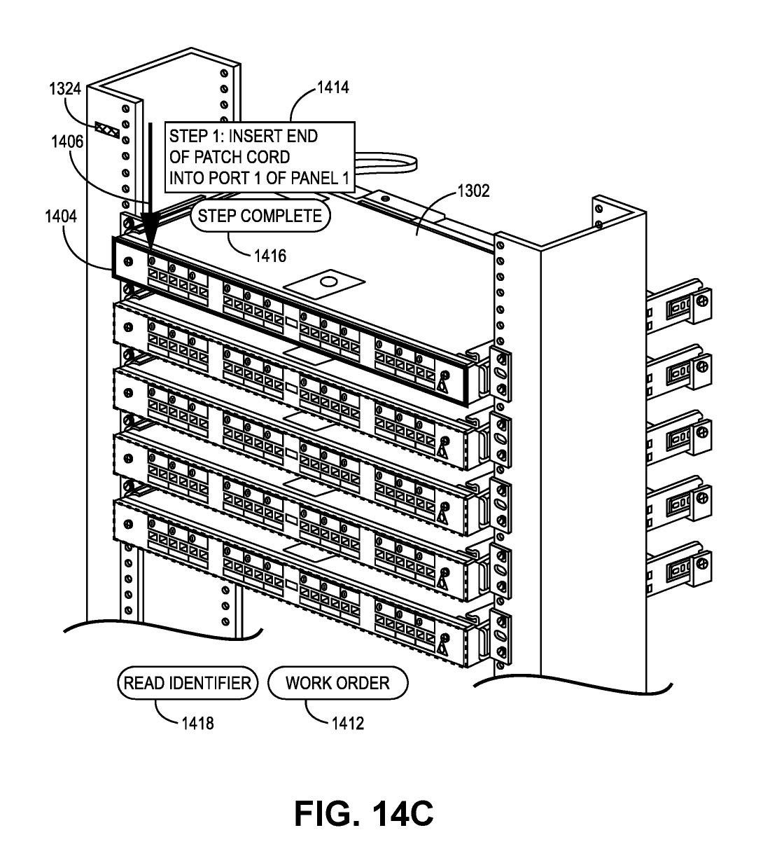

FIGS. 14A-14C illustrate one example of a software-generated overlay 1400 superimposed over a user's view 1402 of a rack 1306 in which patching equipment 1302 is installed.

In the example shown in FIGS. 14A-14C, the user is looking at the rack 1306. FIG. 14A shows the user's view 1402 of the rack 1306 without the overlay 1400 superimposed over it. FIG. 14B shows the software-generated overlay 1400 in isolation. FIG. 14C shows the overlay 1400 superimposed over the user's view 1402 of the rack 1306, where the resulting combination is what the user sees when looking at the rack 1306 using the AR device 1312.

In this example, the overlay 1400 includes an emphasis feature 1404 (also referred to here as the “first emphasis feature” 1404) that highlights or otherwise emphasizes one or more rack positions in the rack 1306 in order to visually identify for the user one or more items of equipment installed in one or more rack positions of the rack 1306 that is being viewed. In this way, a particular item of equipment installed in a rack 1306 can be highlighted for the user. This can be done, for example, to identify an item of equipment that is the subject of a step of a work order.

The emphasis feature 1404 can take a wide variety of forms including, an outline of the corresponding real-world object, a transparent or non-transparent virtual object that has the same general shape as the corresponding real-world object that is positioned over the real-world object, a pointer or arrow object that points to the corresponding real-world object, etc. Also, the emphasis feature can be stationary or animated. Also, not all of the emphasis features need be the same; that is, different emphasis features can be used for different purposes.

In the example shown in FIGS. 14A-14C, the first emphasis feature 1404 comprises an outline that surrounds the rack position in which an item of patching equipment 1304 is installed.

Also, in this example, the overlay 1400 includes another emphasis feature 1406 (also referred to here as the “second emphasis feature” 1406) that highlights or otherwise emphasizes a port of the patching equipment 1302 that is highlighted by the first emphasis feature 1404. In the example shown in FIGS. 14A-14C, the second emphasis feature 1406 comprises an arrow that points to a port of the emphasized patching equipment 1302. Again, this can be done, for example, to identify a port that is the subject of a step work of work order.

The emphasis features 1404 and 1406 shown in FIGS. 14A-14C are merely examples and it is to be understood that such features can be implemented or used in other ways.

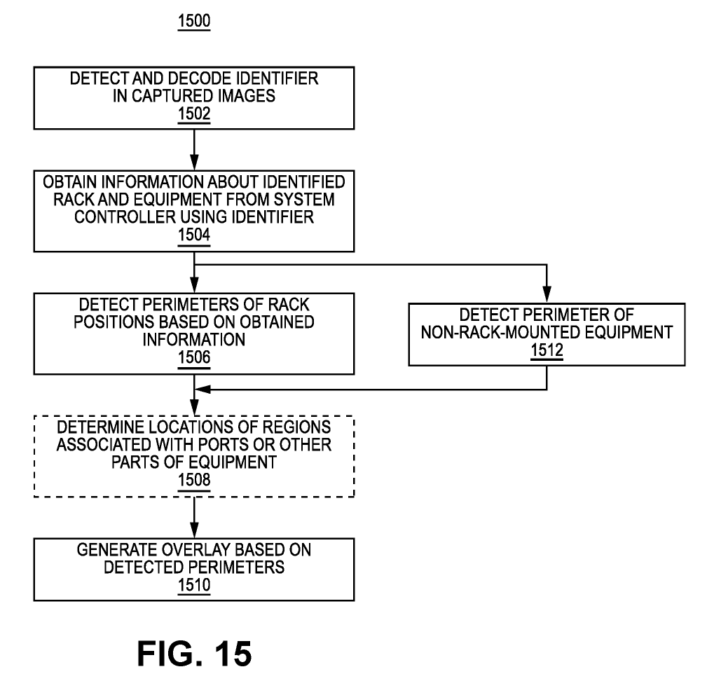

The emphasis features 1404 and 1406 included in the overlay 1400 can be generated using one or more identifiers 1324 attached to the rack 1306 or equipment. This can be done by the image-processing software 1322 as described below in connection with FIG. 15.

In this exemplary embodiment, the overlay 1400 includes one or more interactive regions 1408 that are associated with the rack 1306, the equipment installed in the rack 1306 (and ports or other parts thereof and cables used therewith).

Interactive regions 1408 are portions of the overlay 1400 that a user can interact with using any known method of user interaction including, without limitation, a gesture (for example, by “touching” the region 1408), voice command, eye tracking, screen press, etc. For example, a user can interact with an interactive region 1408 in order to select the associated real-world item and provide an appropriate selection input to the AR device 1312 (and the software 1315 executing thereon).

An interactive region 1408 does not necessarily need to visible within the overlay 1400; instead, the associated real-world object, which is visible in the user's view 1402, can be the visible target for the user touching (or otherwise interacting with) the interactive region 1408. Alternatively, the overlay 1400 can include some type of visible representation of an interactive region 1408 apart from the associated real-world object (for example, by shading or lightening the interactive region 1408 or outlining the interactive region 1408). Also, such visible representation of the interactive region 1408 can be selectively shown, for example, when a predetermined gesture is performed (such as the user's finger hovering near the interactive region 1408).

In general, the interactive regions 1408 themselves are not visible in the overlay 1400 but instead define where the associated real-world object is located within the user's view 1402. Then, when the user selects that real-world object within the user's view 1402 (for example, by touching that real-world object), the user will be selecting the associated interactive region 1408.

In one implementation, the interactive regions 1408 can be determined in the same way that the shape and location of the emphasis features 1404 and 1406 for the associated real-world object are determined (that is, using one or more identifiers 1324 associated with the rack 1306 or equipment).

In other implementations, the emphasis features 1404 and 1406 and the interactive regions 1408 can have different shapes and/or locations (for example, the interactive regions 1408 can have a shape that is more precisely matched to the shape of the corresponding real-world object in order to avoid confusion when a user tries to select that real-world object by touching it).

In this exemplary embodiment, the overlay 1400 includes one or more virtual user-interface objects. The user-interface objects are used to implement the user interface for the AR device 1312. The user-interface objects can be configured so that a user can select or otherwise interact with the virtual object in order to provide an input to the AR device 1312 and/or so that text, images, or other information can be displayed for the user. The user-interface objects and the AR device 1312, more generally, can be used with any function supported by the overall system (including functions typically performed by connection tracking systems such as a “trace” function for tracing connections, a “work order” function for performing work orders, a “find” function for searching for information stored in the system, a “show data” function for displaying information stored in the system, an “audit” function for auditing information stored in the system, an “add asset” function for adding new equipment or other assets, an “add connection” function for adding connections, a “remove connection” function for removing connections, a “define connection” function for defining connections, a “note” function for entering notes, a “take photo” function for capturing and storing photographs, etc.).

For example, as shown in FIGS. 14A-14C, the user-interface objects include a “WORK ORDER” button 1412 that a user can select or otherwise interact with using an appropriate gesture (for example, by touching it) in order to obtain information about any pending working orders associated with the equipment that is highlighted by the first emphasis feature 1404 or the port highlighted by the second emphasis feature 1406. In this example, the user has recently touched the WORK ORDER button 1412 and, in response, a “WORK ORDER” text box 1414 is displayed for the user that includes text information describing a pending work-order step involving the patching equipment 1302 highlighted by the first emphasis feature 1404 and the port highlighted by the second emphasis feature 1406. In this example, the work-order step that is being shown specifies that a user should connect one end of a patch cord to the port highlighted by the second emphasis feature 1406.

In this example, the user-interface objects also include a “STEP COMPLETE” button 1416 that a user can select or otherwise interact with using an appropriate gesture (for example, by touching it) in order to indicate that the work-order step specified in the WORK ORDER text box 1414 has been completed. Once the user selects the STEP COMPLETE button 1416, the AR device 1312 sends a message to the management system 1308 indicating that the displayed work-order step has been completed, and the management system 1308 updates its database 1310 to indicate that the displayed work-order step has been completed.

It should be understood that the AR device 1312 can be configured to receive a confirmation that work-order step has been completed by the user in other ways (for example, by having the user speak the phrase “STEP COMPLETED”, which would be recognized by speech recognition software included in the software 1315 as described above in prior embodiments).

In this example, the user-interface objects also include a “READ IDENTIFIER” button 1418 that a user can select or otherwise interact with using an appropriate gesture (for example, by touching it) in order to cause the image-processing software 1322 to detect and decode any identifiers 1324 in the images captured by the AR device 1312.

It is to be understood that only one example is shown in FIGS. 14A-14C and that the overlay 1400 (and emphasis features 1404 and 1406, interactive regions 1408, and user-interface objects) can be implemented or used in other ways.

Moreover, emphasis features and interactive regions for non-rack-mounted equipment 1330 (such as IP telephones, wall outlets, and wireless access points) can also be generated and included in the overlay.

FIG. 15 is a flow diagram showing one exemplary embodiment of a method 1500 of using an AR device in a system that tracks connections made using patching equipment and other equipment. The exemplary embodiment of method 1500 shown in FIG. 15 is described here as being implemented using the system 1300 and the AR device 1312 shown in FIG. 13 (though other embodiments can be implemented in other ways).

The blocks of the flow diagram shown in FIG. 15 have been arranged in a generally sequential manner for ease of explanation; however, it is to be understood that this arrangement is merely exemplary, and it should be recognized that the processing associated with method 1500 (and the blocks shown in FIG. 15) can occur in a different order (for example, where at least some of the processing associated with the blocks is performed in parallel and/or in an event-driven manner).

Method 1500 comprises identifying and decoding at least one identifier 1324 in an image captured by the AR device 1312 (block 1502).

In this example, the AR device 1312 is configured so that the detecting and decoding of any identifiers 1324 in the images captured by the AR device 1312 is performed in response to an input from the user (for example, the user selecting the READ IDENTIFIER button 1418).

The user can position the identifier 1324 in the field of view of the image-capture device 1314, zoom in so that the details of the identifier 1324 are visible with sufficient resolution, and then select the READ IDENTIFIER button in order to cause the image-processing software 1322 to detect and decode the identifier 1324. In other examples, the image-processing software 1322 is configured to continuously scan for identifiers 1324, digitally zooming in on the captured images as necessary.

In this example, as noted above, the image-processing software 1322 is configured to identify and decode any identifiers 1324 that are associated with the racks 1306 and/or the equipment installed in the racks 1306. For example, where each identifier 1324 comprises a bar code, the image-processing software 1322 is configured with bar-code scanning functionality suitable for identifying and scanning any bar codes that are within the captured images. The image-processing software 1322 can also be configured to capture the location within the associated image where the identifier 1324 was detected.

As noted above, the management system 1308 tracks the identifier 1324 that is associated with each rack 1324 or other item of equipment. As a result, the identifiers 1324 that are detected and decoded by the image-processing software 1322 in the captured images can be used to identify the particular racks 1306 and items of equipment installed in the racks 1306 associated with the identifiers 1324.

In one usage example, a single identifier 1324 is attached to one rack 1306 in each row of racks 1306. The user can then use the AR device 1312 to detect and decode that identifier 1324. Then, that identifier 1324 can be used to identify all of the racks 1306 in that row and the equipment installed in those racks 1306. In other usage examples, identifiers 1324 are attached to more or different racks 1036 or equipment.

Method 1500 further comprises obtaining information from the management system 1308 about any racks 1306 and equipment installed therein that is associated with the detected identifier 1324 (block 1504). As noted above, the management system 1308 stores dimensional information for the racks 1306 and equipment installed in the racks 1306. In this example, the racks 1306 comprise standard 19-inch wide racks that are divided into a predetermined number of rack positions having a standard height, and the height of the equipment installed in the racks 1306 is a multiple of a rack unit. The database 1310 stores dimensional information about each standard rack 1306 (for example, the height, width, relative location of the first, second, etc. rack positions in the rack 1306, etc.), which equipment is installed each rack 1306, the position in the rack 1306 where each item of equipment is installed, and the height of each item of equipment installed in a rack 1306.

Method 1500 further comprises detecting perimeters of rack positions in each rack 1306 based on the obtained information (block 1506). The obtained information can be used by the image-processing software 1322 to detect each rack 1306 within the captured images and the perimeter of each rack position within each rack 1306, which in turn can be used to identify the equipment installed in the rack 1306. For example, if an item of equipment installed in a rack 1306 is 3U high and is installed in the first, second, and third rack positions, then the image-processing software 1322 knows that the item of equipment is installed in the first, second, and third rack positions of the rack 1306 that it detects in the captured images.

Method 1500 optionally further comprises determining the location of regions in the captured image associated with ports or other parts of the equipment installed in each rack 1306 (block 1508). The information obtained from the management system 1308 is used to do this. As noted above, in this embodiment, the management system 1308 tracks and stores information about various ports or other parts of (at least some) of the equipment installed in the racks 1306. As noted above, this information includes the number of ports or other parts of such equipment, a region associated with each port or other part of such equipment, and information about the location of each region relative to the perimeter of that item of equipment.

Method 1500 further comprises generating an overlay based on the detected perimeters of the standard rack positions of each rack 1306 (and, optionally, the determined location of the regions for the ports or other parts of equipment installed in the racks 1306) (block 1510). These features can include emphasis features or interactive regions of or for a rack 1306, equipment installed in a rack 1306, and/or a region associated with a port or other part of equipment installed in a rack 1306. The resulting overlay can then be superimposed over the user's view of the racks 1306 as described above.

The processing associated with method 1500 can also be used with non-rack-mounted equipment 1330. For example, an identifier 1324 associated with non-rack-mounted equipment 1330 in an image captured by the AR device 1312 can be detected and decoded and information about the non-rack-mounted equipment 1330 can be obtained from the management system 1308 using the identifier 1324 as described above in connection blocks 1502 and 1504. Also, a perimeter of the non-rack-mounted equipment 1330 can be detected (for example, using conventional edge-detection image processing that does not involve the use of 3D-model-based image-processing) (block 1512). Then, the overlay can be generated based on the detected perimeter in connection with block 1510 (for example, by including at least one emphasis feature or interactive region for the non-rack-mounted equipment 1330 in the overlay that is generated based on the detected perimeter of the non-rack-mounted equipment 1330). The resulting overlay can then be superimposed over the user's view of the racks 1306 as described above.

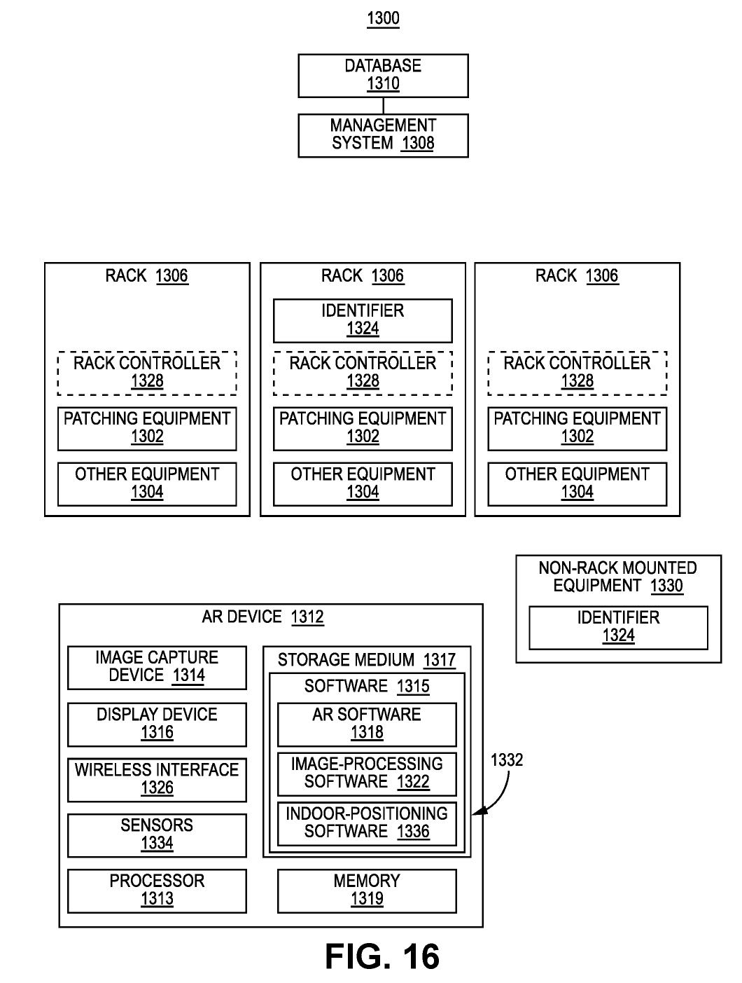

In the examples described above in connection with FIGS. 13, 14A-14C, and 15, the identity of the standard rack 1306 is determined by detecting and decoding an identifier 1324 associated with the standard rack 1304 in an image captured by the AR device 1312. However, the identity of the standard rack 1306 can be determined in different ways. For example, as shown in FIG. 16, the system 1300 can include an indoor positioning system 1332. In the particular embodiment shown in FIG. 16, the indoor positioning system 1332 is implemented using one or more sensors 1334 included in the AR device 1312 (for example, one or more radio frequency sensors or transceivers (such as a global position system (GPS) receiver or software or receivers for using or implementing cellular or wireless local area network location services) or inertial sensors) and software 1336 executing on the AR device 1312. Although the indoor positioning system 1332 is described here as being an “indoor” it is to be understood that it can be configured to determining locations outdoors.

In this example, at least a part of the indoor-positioning software 1336 executes on the processor 1313 included in the AR device 1312. However, it is to be understood that at least a part of the indoor-positioning software 1336 can be implemented on a device other than the AR device 1312 (for example, on the device that is used to implement the management system 1308 or a rack controller 1328).

The indoor-positioning software 1336 is configured to determine the location of the AR device 1312 within a map of the relevant site and the orientation of the AR device 1312 (more specifically, the orientation of the image-capture device 1314) and, based on the determined location and orientation, determine what standard racks 1306 are expected to be within the field of view of the image-capture device 1314, their positioning within the field of view, and associated identifiers for the expected racks 1304. The indoor-positioning software 1336 can then be used to identify the standard racks 1304 in an image captured by the AR device 1312.

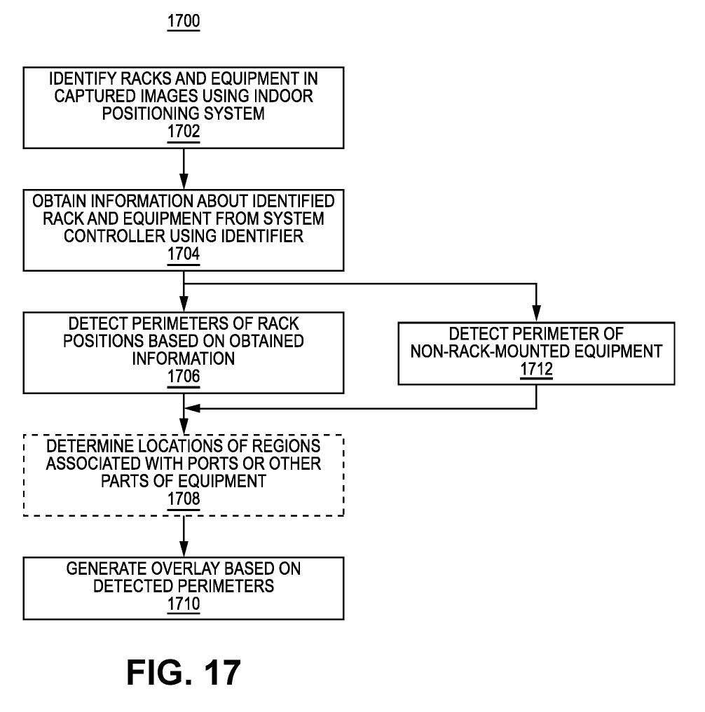

FIG. 17 is a flow diagram showing one exemplary embodiment of a method 1700 of using an AR device in a system that tracks connections made using patching equipment and other equipment. The exemplary embodiment of method 1700 shown in FIG. 17 is described here as being implemented using the system 1300 and the AR device 1312 shown in FIG. 16 (though other embodiments can be implemented in other ways).

The blocks of the flow diagram shown in FIG. 17 have been arranged in a generally sequential manner for ease of explanation; however, it is to be understood that this arrangement is merely exemplary, and it should be recognized that the processing associated with method 1700 (and the blocks shown in FIG. 17) can occur in a different order (for example, where at least some of the processing associated with the blocks is performed in parallel and/or in an event-driven manner).

Method 1700 comprises identifying a standard rack 1306 in an image captured by the AR device 1312 using the indoor positioning system 1332 (block 1702). In this example, the image-processing software 1322 detects any standard racks 1306 within an image captured by the AR device 1312 and their positioning within the captured image. Then, the indoor positioning system 1332 is used to determine the location of the AR device 1312 within the map of the relevant site and the orientation of the AR device 1312 and, based on the determined location and orientation, determine what standard racks 1306 are expected to be within the field of view of the image-capture device 1314, their positioning within the field of view, and associated identifiers for the expected racks 1306. In this way, the racks 1306 detected in the captured image can be matched with the standard racks 1306 expected to be within the field of view of the image-capture device 1314 in order to determine an identifier for the detected racks 1306.

Then, information from the management system 1308 about any racks 1306 and equipment installed therein that is associated with the determined identifier can be obtained (block 1704), perimeters of rack positions in each rack 1306 can be determined based on the obtained information (block 1706), (optionally) the location of regions in the captured image associated with ports or other parts of the equipment installed in each rack 1306 can be determined (block 1708), and an overlay is generated based on the detected perimeters of the standard rack positions of each rack 1306 (and, optionally, the determined locations of the regions for the ports or other parts of equipment installed in the racks 1306) (block 1710) as described above in connection with blocks 1504, 1506, 1508, and 1510, respectively, of FIG. 15.

The location of the AR device 1312 can also be provided to the management system 1308 (along with the determined identifier) for use in obtaining information from the management system 1308 about any racks 1306 and equipment installed therein.

The processing associated with method 1700 can also be used with non-rack-mounted equipment 1330. For example, non-rack-mounted equipment 1330 in an image captured by the AR device 1312 can be identified using the indoor positioning system 1332 and information about the non-rack-mounted equipment 1330 can be obtained from the management system 1308 using a determined identifier as described above in connection blocks 1702 and 1704. Also, a perimeter of the non-rack-mounted equipment 1330 can be detected (for example, using conventional edge-detection image processing that does not involve the use of 3D-model-based image-processing) (block 1712). Then, the overlay can be generated based on the detected perimeter in connection with block 1710 (for example, by including at least one emphasis feature or interactive region for the non-rack-mounted equipment 1330 in the overlay that is generated based on the detected perimeter of the non-rack-mounted equipment 1330). The resulting overlay can then be superimposed over the user's view of the racks 1306 as described above.

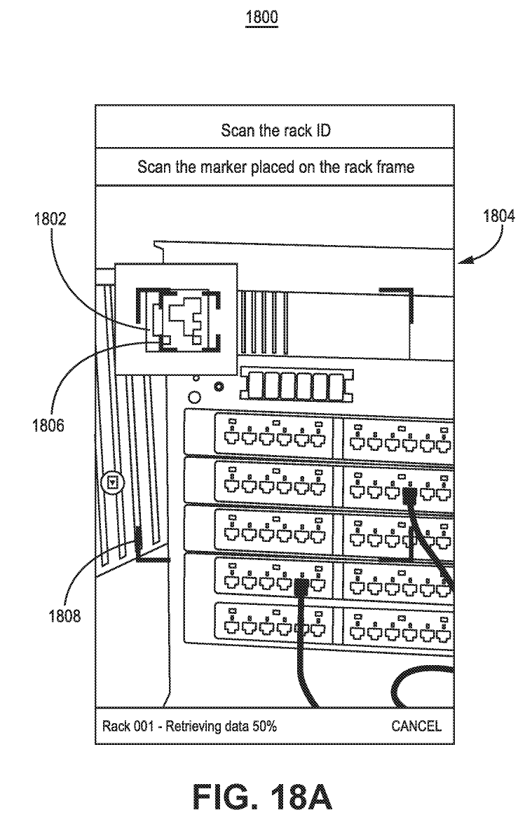

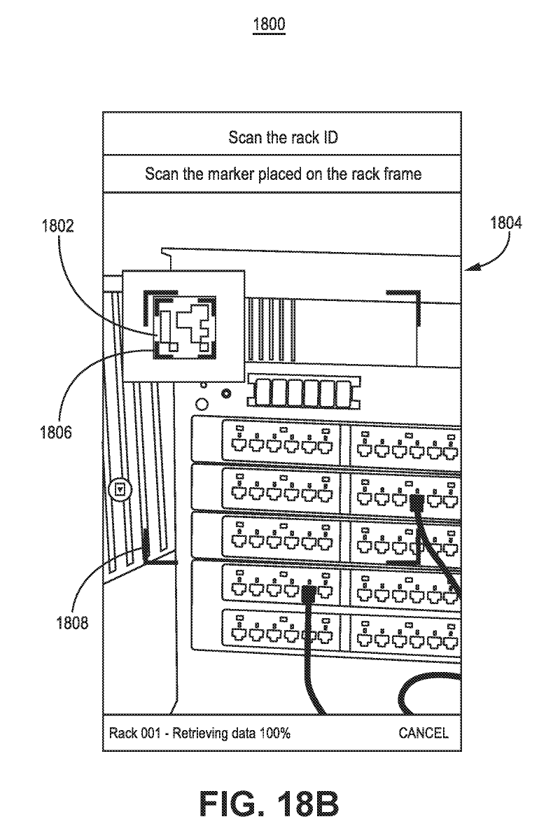

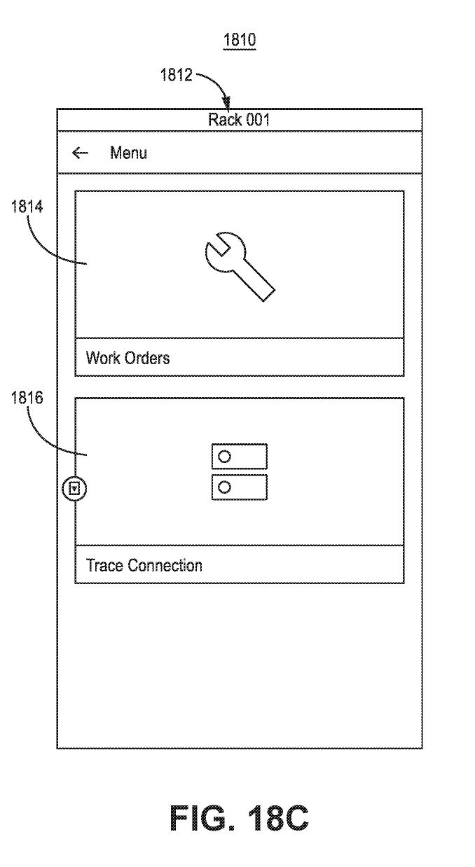

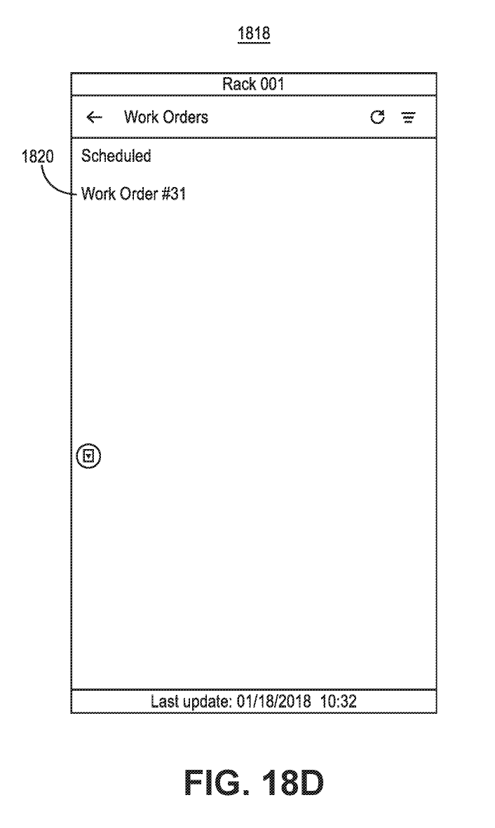

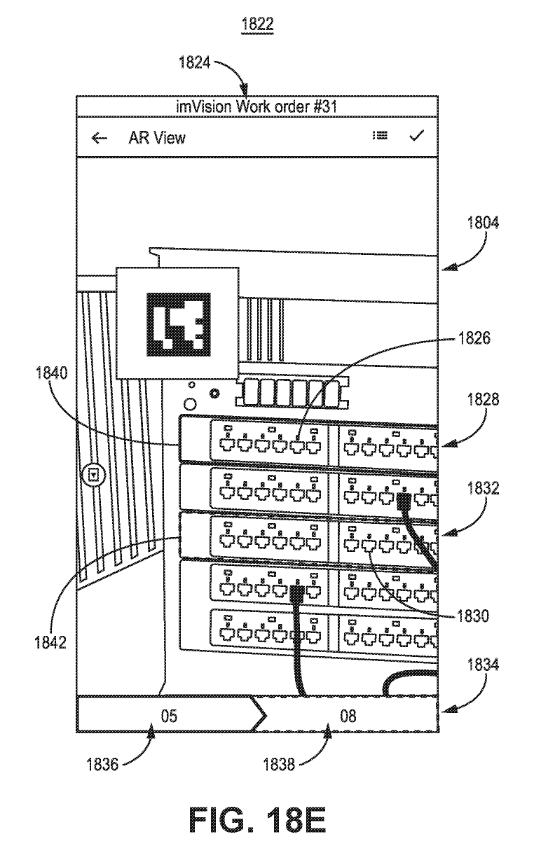

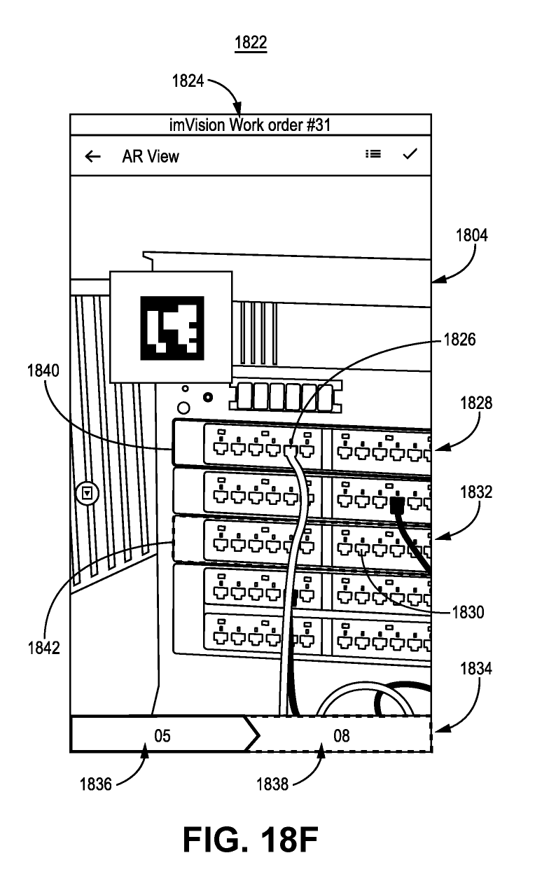

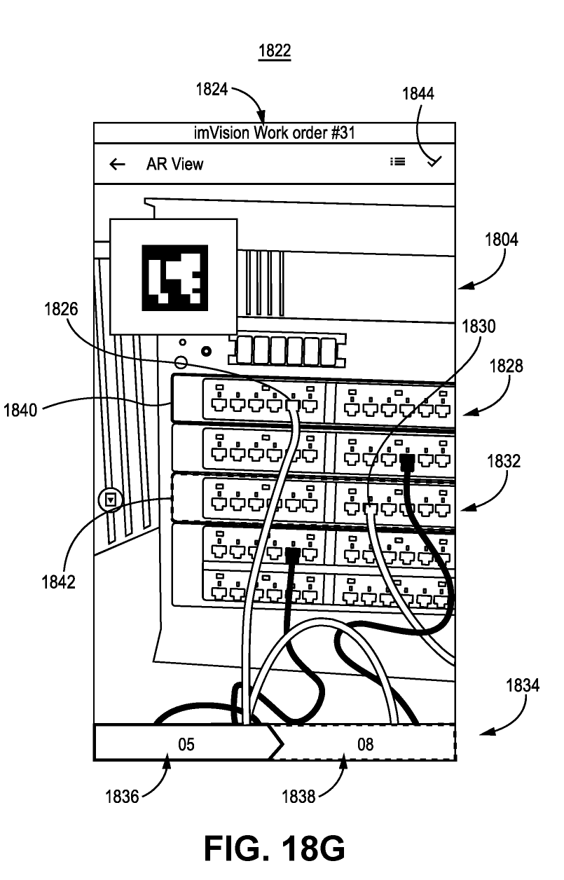

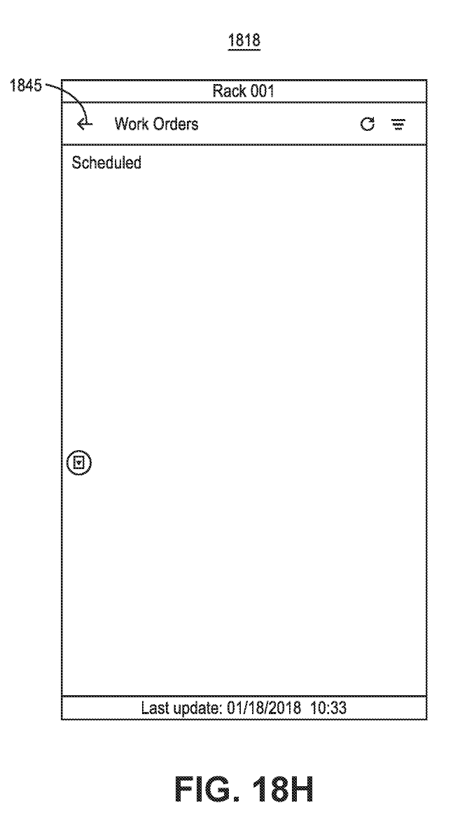

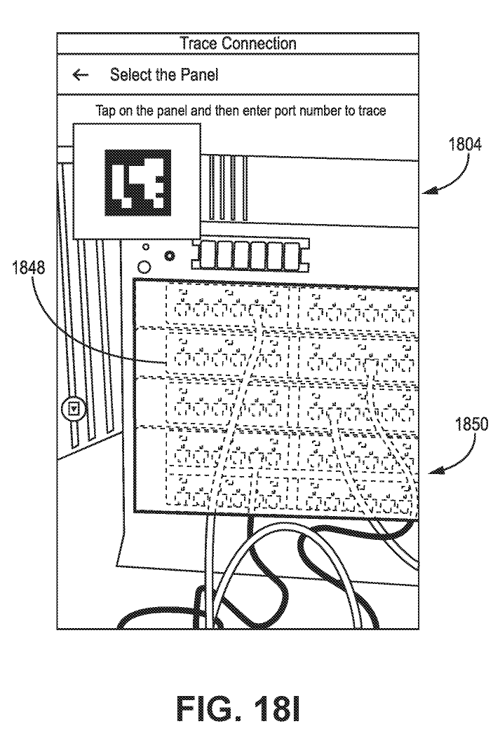

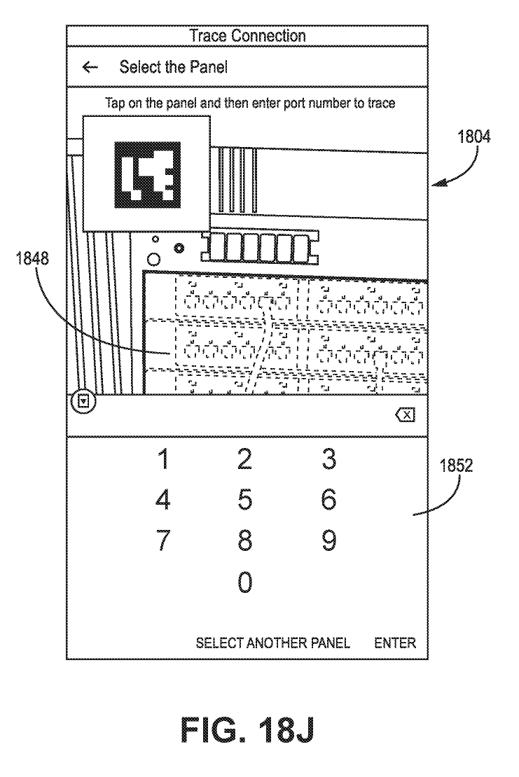

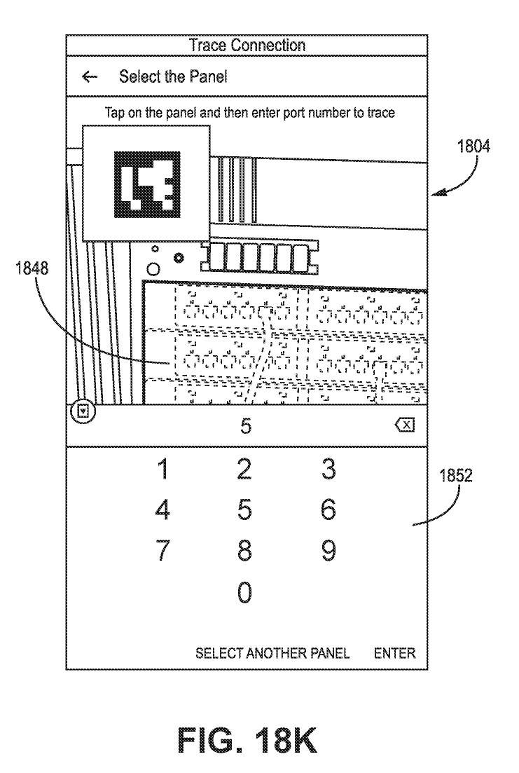

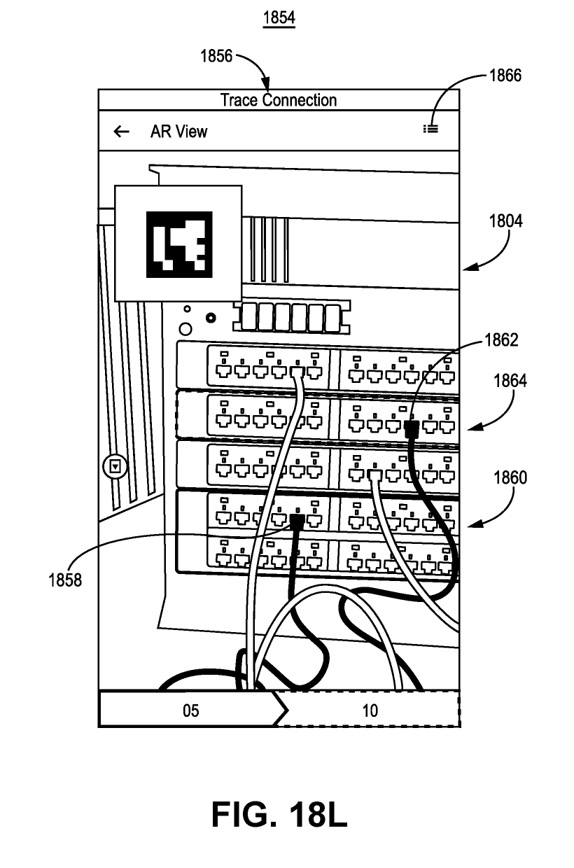

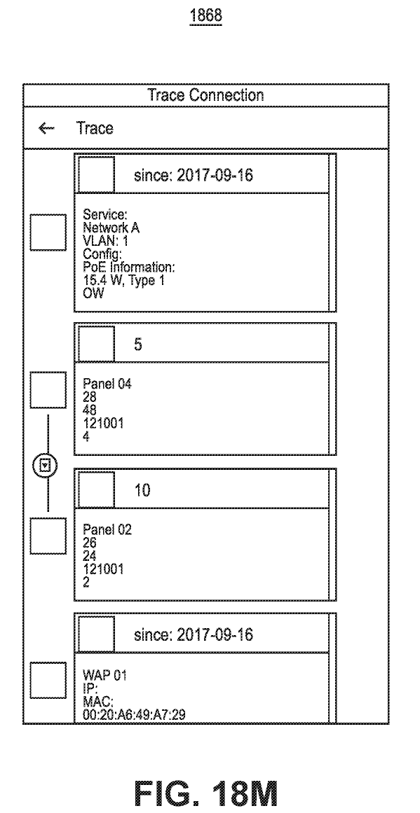

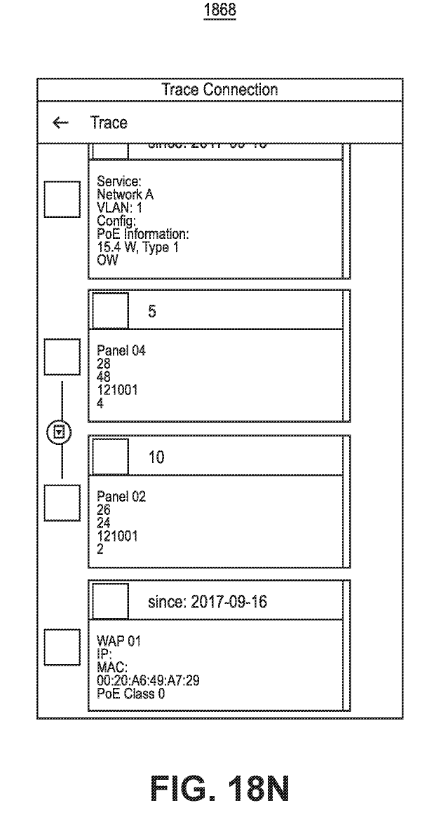

FIGS. 18A-18N illustrate the operation of one example of an application executing on a smartphone that makes use of, in various ways, software-generated overlays superimposed over user views of a rack in which patching equipment is installed. In this example, the AR device is the smartphone.

In this example, as shown in FIGS. 18A-18B, the application is configured to display a scan rack ID screen 1800 by which a user is able to use the smartphone to scan a maker 1802 that is associated with the rack 1804. As shown in FIGS. 18A-18B, a real-time image captured by the camera included in the smartphone is displayed by the smartphone.

User-interface elements are displayed to assist the user in positioning the marker 1802 within the field of view of the camera by manipulating the smartphone so that the application can successfully recognize and scan the marker 1802. In this example, the marker 1802 is located on the upper left corner of the rack 1804 (when looking at the front of the rack 1804). The user-interface elements in this example include two sets of corners 1806 and 1808. A first, inner set of corners 1806 define a square area that is located within the upper-left corner of a larger square area that is defined by a second, outer set of corners 1808. The user manipulates the smartphone in order to position the marker 1802 within the inner set of corners 1806 in the real-time image captured by the camera and displayed by the smartphone. The user manipulates the smartphone so that the marker 1802 is generally aligned within the inner set of corners 1806 and fills substantially all of the area defined by the inner set of corners 1806 (as shown in FIG. 18B). Then, the application detects and scans the marker 1802 and retrieves information about the rack 1804 that is stored in by the management system and the associated database (not shown in FIGS. 18A-18N).

As shown in FIG. 18C, the application is configured to then display a menu screen 1810 that displays an identifier 1812 associated with the rack 1804. This identifier is also referred to here as the “rack ID” 1812. In this example, the menu screen 1810 also includes two menu items—a work orders menu item 1814 and a trace connection menu item 1816.

If the user taps on the work orders menu item 1814, the application retrieves any outstanding work orders associated with the rack 1804 and displays a work orders screen 1818 in which the scheduled outstanding work orders associated with that rack 1804 are displayed (as shown in FIG. 18D).

As shown in FIG. 18D, in this example, there is one outstanding work order associated with that rack 1804. A label 1820 is displayed for that work order (“Work Order #31”). If the user taps on the label 1820, the application is configured to display an AR view screen 1822 (shown in FIG. 18E).

As shown in FIG. 18E, the application generates an overlay and superimposes it over the real-time view of the rack 1804 that is being captured by the camera (assuming the user is still pointing the camera towards the rack 1804 so that the rack 1804 remains within the field of view of the camera). The overlay includes emphasis features that emphasize one or more end points (ports and the panels or other equipment that include the ports) of a connection that is to be made (in the case where the user tapped on the work orders menu item 1814) or an existing connection (in the case where the user tapped on the trace connection menu item 1816). The connection that is identified in the AR view screen 1822 is referred to here as the “current” connection.

In this example, the current connection is the connection that is to be made by performing Word Order #31. This fact is identified in a label 1824 that is displayed at the top of the AR view screen 1822. In this example, the label 1824 contains the text “imVision Work Order #31”. Work Order #31 specifies that a first port 1826 of a first panel 1828 in the rack 1804 is to be connected to a second port 1830 of a second panel 1832 in the rack 1804. The first port 1826 is the port labeled with the port number “5” that is included in the uppermost panel in the rack 1804. The second port 1830 is the port labeled with the port number “8” that is included in the third panel in the rack 1804 (counting from the uppermost panel 1828).

In this example, the overlay for the AR view screen 1822 comprises a row 1834 that is displayed at the bottom of the screen 1822. The row 1834 is divided into two regions 1836 and 1838, one for each of the ports 1826 and 1828 of the current connection. The port number for the associated port is displayed in that region 1836 and 1838. In this example, as shown in FIG. 18E, the first port 1826 is associated with the first region 1836, and, as a result, the port number “05” (which is the port number for the first port 1826) is displayed in the first region 1836. The second port 1830 is associated with the second region 1838, and the port number “08” (which is the port number for the second port 1830) is displayed in the second region 1838.

In this example, the overlay for the AR view screen 1822 also includes two rectangular outlines 1840 and 1842, one for each panel 1828 and 1832 involved in the current connection. Each rectangular outline 1840 and 1842 outlines and emphasizes the associated panel 1828 or 1832 involved in the current connection.

In this example, as shown in FIG. 18E, a first rectangular outline 1840 outlines the first panel 1828 involved in the current connection, and a second rectangular outline 1842 outlines the second panel 1832 involved in the current connection.

Also, in this example, the background color of each region 1836 and 1838 matches the line color that is used for the corresponding rectangular outline 1840 and 1842, respectively. In this example, as shown in FIG. 18E, the region 1836 and rectangular outline 1840 that are associated with the first port 1826 and the first panel 1828 are shown using the color green, while the region 1838 and rectangular outline 1842 that are associated with the second port 1830 and the second panel 1832 are shown using the color purple.

This scheme assists the user in locating the panels and ports involved with the current connection. In this example, as noted above, the current connection is connection that is to be made by performing Work Order #31. The user can locate the first port 1826 involved with the current connection by looking at the left region 1836 of the bottom row 1834 in order to identify the relevant port number (“05” in this example) and the color of the appropriate rectangular outline 1840 to look for (green in this example). Then, the user is able to identify the panel 1828 that contains that port 1826 by looking for the rectangular outline 1840 that has a line color (green) that matches the background of the left region 1836. The user can identify the appropriate port 1826 using the port number printed on the face of the panel 1828 near the port 1826 and can connect one end of a cable to that port 1826 (as shown in FIG. 18F).

Then, the user can locate the second port 1830 involved with the current connection by looking at the right region 1838 of the bottom row 1834 in order to identify the relevant port number (“08” in this example) and the color of the appropriate rectangular outline 1842 to look for (purple in this example). The user is able to identify the panel 1832 that contains that port 1830 by looking for the rectangular outline 1842 that has a line color (purple) that matches the background of the right region 1838. Then, the user can identify the appropriate port 1830 using the port number printed on the face of the panel 1832 near the port 1830 and can connect one end of a cable into that port 1830 (as shown in FIG. 18G).

When the user has finished making the connection specified by a work order, the user can tap on a check mark 1844 displayed as a part of the AR view screen 1822 to indicate to the application that the user has finished performing the work order. Then, the port sensors included in or otherwise associated with the two ports 1826 and 1830 involved in the work order confirm that the cable has been connected to the correct ports 1826 and 1830. In this example, that is the case. If that were not the case, the management system could send a message to the application indicating that the work order was not properly executed and provide visual indicators indicating where the mistake occurred.

In the event that one of the ports of the current connection is not currently displayed on the smartphone, an arrow can be displayed by the smartphone to direct the user toward that port. The arrow can be oriented on the smartphone display so that it points in the direction toward where the port is located within the real world. For example, the arrow would point toward to the left if the port is located somewhere to the left of the current field of view displayed on the smartphone, would point to the right if the port is located somewhere to the right of the current field of view displayed on the smartphone, would point up if the port is located somewhere above the current field of view displayed on the smartphone, or would point down if the port is located somewhere below the current field of view displayed on the smartphone. The arrow can be oriented in two dimensions or three dimensions. The arrow can be located near an edge of the smartphone display that corresponds to the direction the arrow points (for example, near the left edge of the display if the arrow points to the left). The port number for the associated port can be displayed in or near the arrow to identify the associated port. Also, the background color of the arrow can be the same as the color used for the corresponding region 1836 or 1838 of the row 1834 and the rectangular outline 1840 or 1842. In the event that both of the ports of the current connection are not currently displayed on the smartphone, two arrows can be displayed on the smartphone display to direct the user towards each of the ports.

In this example, after the work order has been completed and confirmed by the system manager and the user causes the application to return to the work order screen 1818, no outstanding work orders will be displayed for the rack 1804 (as shown in FIG. 18H). This provides confirmation to the user that no further work orders are outstanding for that rack 1804.

The user can return to the menu screen 1810 by tapping the back arrow 1845 (shown in FIG. 18H).

If the user taps on the trace connection menu item 1816 shown on the menu screen 1810 (shown in FIG. 18C), the application is configured to display a trace connection screen 1846 (shown in FIG. 18I). As shown in FIG. 18I, the application generates an overlay and superimposes it over the real-time view of the rack 1804 that is being captured by the camera (assuming the user is still pointing the camera towards the rack 1804 so that the rack 1804 remains within the field of view of the camera).

In this example, the overlay comprises a rectangular box 1848 for each panel installed in the rack 1804. The rectangular box 1848 is positioned over the associated panel, and the interior of each box 1848 has a translucent coloring to further visually emphasize the panel and to indicate to the user that the user can tap on any part of the box 1848 in order to select the associated panel. Because the coloring is translucent, the user will still be able to see the underlying panel.

In this example, the user has selected the lower most panel 1850. Then, as shown in FIG. 18J, the application is configured to display a keypad 1852. The user can use the keypad 1852 to enter a port number for the connection that the user wishes to trace. In this example, as shown in FIG. 18K, the user enters the port number “5” using the keypad 1852.

Then, the application retrieves information about the connection associated with the identified port and displays an AR view screen 1854 to emphasize that connection (as shown in FIG. 18L). The AR view screen 1854 shown in FIG. 18L is substantially the same as the AR view screen 1822 that is displayed for work orders and that is described above.

In this case, the current connection being emphasized in the AR view 1854 is the traced connection. This fact is identified in a label 1856 that is displayed at the top of the AR view screen 1854. In this example, as shown in FIG. 18L, the label 1856 contains the text “Trace Connection”.

As shown in FIG. 18L, the application generates an overlay and superimposes it over the real-time view of the rack 1804 that is being captured by the camera (assuming the user is still pointing the camera towards the rack 1804 so that the rack 1804 remains within the field of view of the camera). The overlay includes emphasis features that emphasize one or more elements (ports and the panels or other equipment that include the ports) of the traced connection.

The traced connection, in this example, is a connection that connects a first port 1858 of a first panel 1860 in the rack 1804 to a second port 1862 of a second panel 1864 in the rack 1804. The first port 1858 is the port labeled with the port number “5” that is included in the lower-most panel in the rack 1804. The second port 1862 is the port labeled with the port number “10” that is included in the second panel in the rack 1804 (counting from the uppermost panel). The first and second ports 1858 and 1862 and the first and second panels 1860 and 1864 are emphasized in the same manner as described above in connection with FIGS. 18E-18G.

In the event that one or both of the ports of the current connection is not currently displayed on the smartphone, one or more arrow can be displayed by the smartphone to direct the user toward the one or more of the ports, as described above.

The application is also configured to display a details icon 1866 as part of the AR view screen 1854 displayed for a traced connection. The application is configured so that if a user taps on the details icon 1866, it displays a trace screen 1868 that includes details about the traced connection (as shown in FIGS. 18M-18N). FIG. 18M shows the upper portion of the trace screen 1868. FIG. 18N shows the bottom portion of the trace screen 1868.

Although the example shown in FIGS. 18A-18N has been described as being implemented using a smartphone as the AR device, it is to be understood that the techniques described above in connection with FIGS. 18A-18N can be implemented using other types of AR devices.

As noted above, the AR device and associated techniques described here can also be used with non-rack-mounted equipment. In particular, the AR device and associated techniques described here can be used to assist a user in locating equipment that is installed where it is not easily visible to the user. Digital representations of this equipment can be included in the overlay images that are generated and superimposed over the user's view of the real world displayed by the AR device.

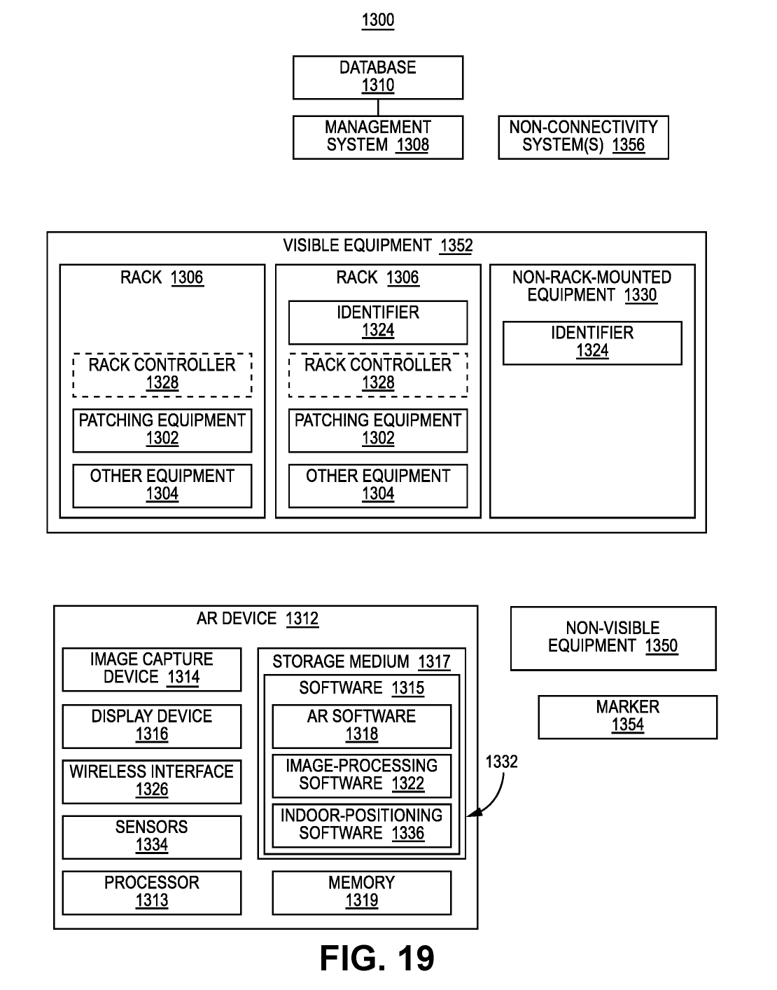

For example, as shown in FIG. 19, the system 1300 described above can be modified to track, and assist a user in locating, equipment 1350 that is installed where it is not easily visible to the user. Examples of such equipment 1350 include connectivity equipment (such as consolidation points, cables, cable bundles, conduits, and raceways), networking equipment (such as wireless local area network access points), power equipment (such as power cables, conduits, and fuses), security equipment (such as Internet Protocol (IP) security cameras), and heating, ventilation, and air conditioning (HVAC) equipment (such as conduits, cables, and sensors) lighting equipment (such as lighting fixtures and cables), elevator equipment, building-related equipment and structures, and information technology (IT) equipment. Such equipment can include other types of equipment. This equipment 1350 is also referred to here as “non-visible equipment” (though it is to be understood that some such equipment may be partially visible or visible with some effort).

The non-visible equipment 1350 can include non-visible equipment that is installed within an office environment (for example, in a dropped ceiling, raised floor, or wall) or within the outside plant (for example, underground or in a locked vault or other enclosure).

The system 1300 can also be configured to track, and assist a user in locating, visible equipment 1352. Such visible equipment 1352 is equipment that is easily visible to a user. In this example, such visible equipment 1352 includes, for example, the racks 1306, rack-mounted equipment (such as patching equipment 1302, other equipment 1304, and rack controllers 1328) and non-rack mounted equipment 1330. For visible equipment 1352, which is already visible to the user, emphasis features of the type described above can be included in the overlay images that are generated and superimposed over the user's view of the real world displayed by the AR device. Also, digital representations of the visible equipment 1352 can be included in the overlay image. For example, the digital representation can be located in the overlay image so that it is displayed near (but not covering) the real-world equipment 1352 when superimposed over the user's view of the real world displayed by the AR device 1312.

In this embodiment, at least one marker 1354 is located near where the non-visible equipment 1350 and visible equipment 1352 are installed. The marker 1354 is located so that it is visible to a user. The absolute, geographical location of each marker 1354 is tracked by the management system 1308 and stored in the database 1310 and is associated with any tracked equipment that is installed near the marker 1340 (including both visible equipment 1352 and non-visible equipment 1350). A marker 1354 can comprise an object or equipment that is installed in a fixed location near the relevant equipment 1350 and 1352. A marker 1354 can also comprises a label, code, or tag (such as bar code, QR code, or RFID tag) that is attached or fixed to an object or equipment that is installed in a fixed location near the relevant equipment 1350 and 1352 or that is attached or fixed to a structure that is part of the general environment such as wall, door, ceiling, floor, etc.

In the example shown in FIG. 19, the management system 1308 is also configured to store information about (at least some of) the non-visible equipment 1350 installed near the marker 1354. In this example, the management system 1308 is configured to at least store information about non-visible connectivity equipment (such as consolidation points, cables, cable bundles, conduits, and raceways) and non-visible networking equipment (such as wireless local area network access points). This information includes identifier information that can be used to identify the equipment (for example, including identifiers assigned to the equipment), location information (for example, where the equipment is located relative to the marker 1354 and where the equipment is located in an absolute coordinate system), and model information (for example, information about how a digital representation of such equipment should be generated and displayed, where the digital representation and/or model can be two-dimensional or three-dimensional). Also, in this example, the information about the non-visible connectivity and networking equipment stored by the management system 1308 also includes information about any connections made using such equipment (also referred to here as “connection information”).

Also, in the example shown in FIG. 19, information about other types of non-visible equipment 1350 is tracked by non-connectivity systems 1356. For example, information about non-visible lighting equipment is tracked by a lighting control system, and information about non-visible security equipment is tracked by a security system. Also, information about non-visible building-related equipment and structures is tracked by a building information modelling (BIM) system, and information about non-visible IT equipment is tracked by an IT system. This information can include identifier information, location information, and model information for such equipment. In this example, the software 1315 executing on the AR device 1312 is configured to access information tracked by the non-connectivity systems 1356 about such non-connectivity non-visible equipment 1350.

The associations between the marker 1354 and the equipment 1350 and 1352 can be determined during a learning or walk through process in which a user walks or other moves through the relevant work space wearing or using an AR device 1312. The AR device 1312 captures/collects spatial information about boundaries (walls, floors, ceiling), floor/under-floor mounted equipment (racks, cabinets, mainframes, power distribution units, etc.), wall-mounted equipment (faceplates, access points, security cameras, badge readers), ceiling/above-ceiling mounted equipment (light fixtures, consolidation points, HVAC controllers, etc.), and the like. The AR device 1312 associates location information with the captured information and images. The captured information and images and associated location information can then be used to associate non-visible and visible equipment near the marker 1350 using conventional AR techniques (for example, using image-recognition and/or using the known locations of the non-visible equipment).

The management system 1308 can be configured to directly associate the marker 1354 with equipment 1350 and 1352 installed nearby. For example, the management system 1308 can be configured to maintain one or more fields or objects in the database 1310 for storing identifiers for equipment 1350 and 1352 installed nearby and to use these fields or objects to determine equipment 1350 or 1352 installed near a marker 1354. The management system 1308 can be configured to indirectly associate the marker 1354 with equipment 1350 and 1352 installed nearby. For example, the management system 1308 can be configured to maintain one or more fields or objects in the database 1310 for storing the locations of the markers 1354 and equipment 1350 and 1352 and to use these locations to determine equipment 1350 or 1352 installed near each marker 1354. Each location can be, for example, an absolute geographic location, a location relative to a particular landmark or object (such as a door, elevator, etc.), or a building, floor, room, or other region of the relevant environment in which the item is located.

In this example, the software 1315 executing on the AR device 1312 is configured to access the information that is tracked by the management system 1308 and the non-connectivity systems 1356 and use that information in generating an overlay for display using the AR device 1312.

This integration of information about connectivity equipment and non-connectivity equipment can involve the integration of information about non-connectivity equipment into applications and/or features that are of a primarily connectivity-related nature. Alternatively, this integration can involve the integration of information about connectivity equipment into applications and/or features that are of a primarily non-connectivity-related nature.

The embodiment shown in FIG. 19 is described here using marker-based AR techniques. That is, in this embodiment, the marker 1350 is used not only to identify equipment installed near the AR device 1312 but also to establish and maintain the spatial orientation of the AR device 1312 relative to the real-world environment captured by the image-capture device 1314. However, it is to be understood that marker-less AR techniques can be used to establish and maintain the spatial orientation of the AR device 1312. In such a marker-less embodiment, an identifier deployed within the relevant environment can still be used to identify equipment installed near the AR device 1312. For example, this is done in the marker-less embodiments described above in connection with FIGS. 13-17, where identifiers 1324 are used to identify equipment installed near the AR device 1312 but rack perimeter information is used to establish and maintain the spatial orientation of the AR device 1312 while simplifying and improving the accuracy of the objection-detection processing used in connection with such marker-less AR techniques. In another marker-less embodiment, marker-less AR techniques are used to establish and maintain the location of the AR device 1312 and to establish and maintain the spatial orientation of the AR device 1312 relative to the real-world environment captured by the image-capture device 1314. In such an embodiment, the location of the AR device 1312 can be used to identify equipment installed nearby (instead of using an identifier deployed within the relevant environment). That is, the location of the AR device 1312 can be determined and then provided to the management system 1308 in order to determine what equipment is installed near the AR device 1312.

As noted above, the AR device 1312 can communicate with the management system 1308 (and associated database 1310) via the wireless interface 1326 using any suitable wireless protocol (for example, one or more of the BLUETOOTH family of standards, one or more of the IEEE 802.11 family of standards, NFC, cellular, etc.). As noted above, the AR device 1312 can be directly connected to the management system 1308 (for example, where the management system 1308 is co-located with the equipment 1350 and 1352 so that the AR device 1312 can establish a direct wireless connection with the management system 1308) or indirectly connected to the management system 1308 (for example, via a local area network and/or a wide area network, and/or the Internet). As noted above, another way the AR device 1312 can be indirectly connected to the management system 1308 is via the rack controller 1328. In such an example, the AR device 1312 uses a direct wireless connection to the rack controller 1328 in order to access the management system 1308 and database 1310 via the network connectivity provided to the rack controller 1328. Also, as noted above, the AR device 1312 can be configured to operate off-line (for example, in the event that it is not possible to establish a wireless or wired connection with the management system 1308 and database 1310). This can be done by first storing any captured information locally within the AR device 1312 (for example, in the storage medium 1317 or memory 1319) and then, at a later point in time, downloading the information to the management system 1308 and database 1310 (for example, at a later point in time when the AR device 1312 can be connected to the management system 1308 and database 1310).

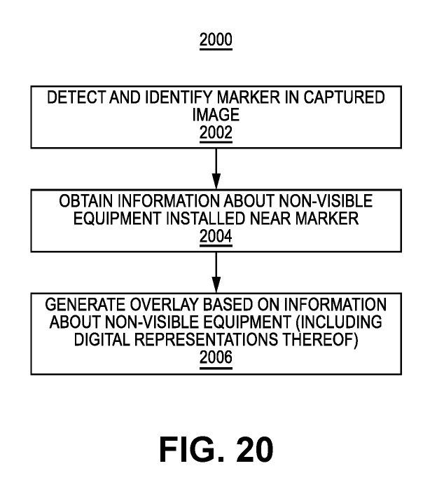

FIG. 20 comprises a high-level flow chart illustrating one exemplary embodiment of a method 2000 of using an AR device to assist with locating non-visible equipment. The exemplary embodiment of method 2000 shown in FIG. 20 is described here as being implemented using the AR device 1312 and associated system 1300 shown in FIG. 19 (though other embodiments can be implemented in other ways).

The blocks of the flow diagram shown in FIG. 20 have been arranged in a generally sequential manner for ease of explanation; however, it is to be understood that this arrangement is merely exemplary, and it should be recognized that the processing associated with method 2000 (and the blocks shown in FIG. 20) can occur in a different order (for example, where at least some of the processing associated with the blocks is performed in parallel and/or in an event-driven manner). Also, most standard exception handling is not described for ease of explanation; however, it is to be understood that method 2000 can and typically would include such exception handling.

Method 2000 comprises detecting and identifying at least one marker 1354 in an image captured by the AR device 1312 (block 2002).

In this example, the AR device 1312 is configured so that the detecting and identifying of any markers 1354 in the images captured by the AR device 1312 is performed in response to an input from the user (for example, the user selecting a button or other user interface element).

The user can manipulate the AR device 1312 so as to position a marker 1354 in the field of view of the image-capture device 1314, zoom in so that the details of the marker 1354 are visible with sufficient resolution, and then select the button in order to cause the image-processing software 1322 to detect and decode the marker 1354. In other examples, the image-processing software 1322 is configured to continuously scan for markers 1354, digitally zooming in on the captured images as necessary.

Where each marker 1354 comprises a barcode or QR code, the image-processing software 1322 is configured with barcode or QR-code scanning functionality suitable for detecting, identifying, and decoding bar or QR codes that are within the captured images. The image-processing software 1322 can also be configured to capture the location within the associated image where the marker 1354 was detected.

As noted above, the management system 1308 associates the equipment 1350 and 1352 that is installed near each marker 1354. As a result, when a particular marker 1354 is detected, and identified by the AR device 1312, it is possible to determine which equipment 1350 and 1352 is near the marker 1354 and the user of the AR device 1312.

Method 2000 further comprises obtaining information about non-visible equipment 1350 (and visible equipment 1352) installed near the detected marker 1354 (block 2004).

The software 1315 executing on the AR device 1312, after detecting and identifying a marker 1354, sends a request to the management system 1308 for information about any equipment 1350 and 1352 that is installed near the detected marker 1354. In this example, the software 1315 executing on the AR device 1312 also sends a request to one or more of the non-connectivity systems 1356 for information about any equipment 1350 and 1352 that is installed near the marker 1354. The request can also include a location of the AR device 1312.

Method 2000 further comprises generating an overlay based on the information about the non-visible equipment 1350 (and visible equipment 1352) installed near the detected marker 1354 (block 2006). More specifically, in this embodiment, digital representations of the non-visible equipment 1350 that would be within the field of view of the AR device 1312 if the equipment 1350 were visible (that is, if the user's view of the equipment 1350 was not obscured by structures such as walls, ceilings, floors, ground, enclosures, etc.). The overlay can also include emphasis features (and other visual elements) related to visible equipment 1352.

In this example, the software 1315 executing on the AR device 1312 uses the provided information about the equipment 1350 and 1352 installed near the detected marker 1354 to generate the digital representations of the non-visible equipment 1350 and the overlay image.

The generated overlays are then superimposed over the user's view of the real world displayed by the AR device 1312. By including digital representations of the non-visible equipment 1350 and including them into the overlay images, a user is able to see where non-visible equipment 1350 is located even though it is not visible. The user can also compare the location of the non-visible equipment 1350 with other features within the real-world environment. For example, where the non-visible equipment 1350 is installed in a dropped ceiling, the user can determine which ceiling tiles the non-visible equipment 1350 is installed near and then access the equipment 1350 by removing one or more of those ceiling tiles.

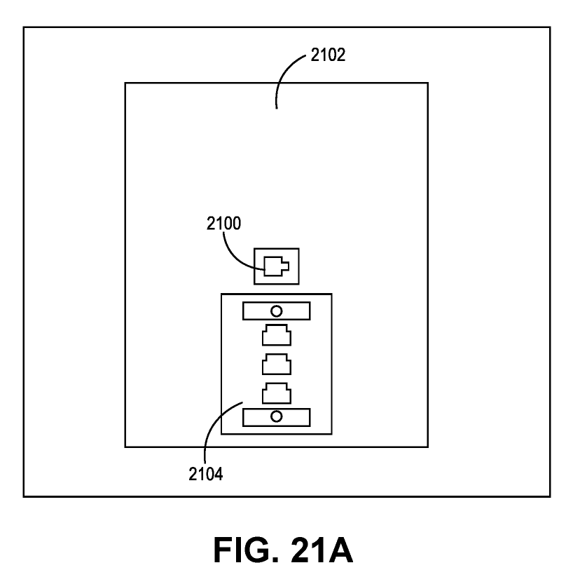

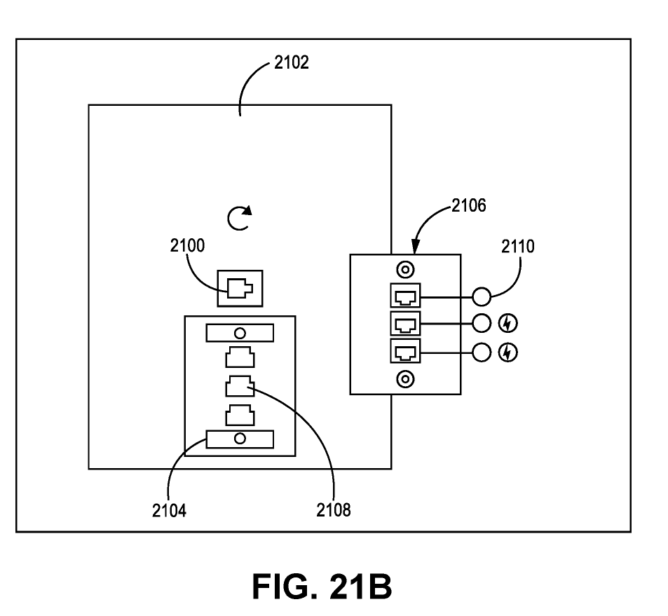

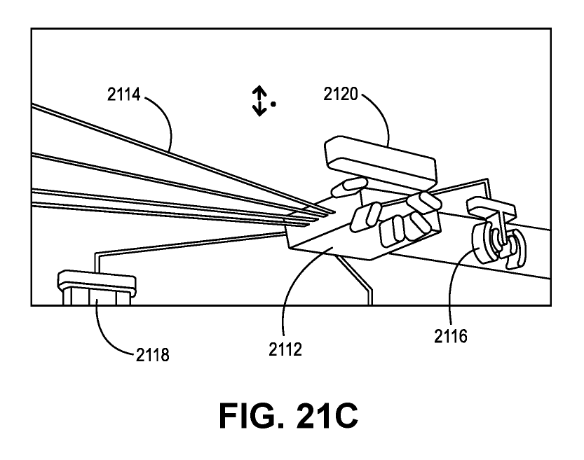

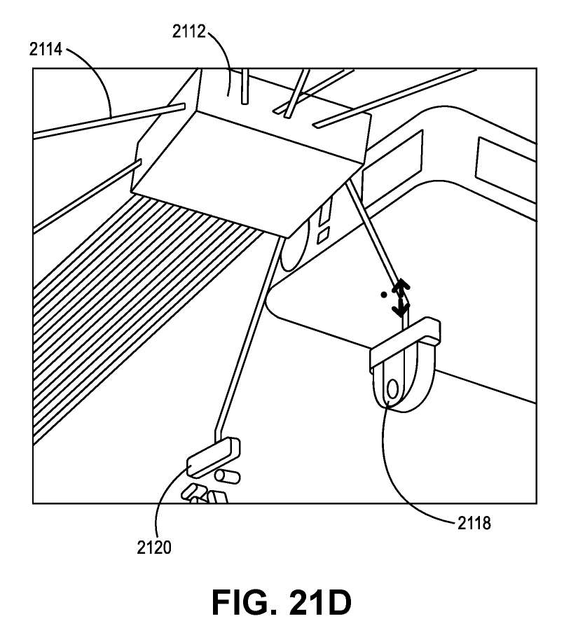

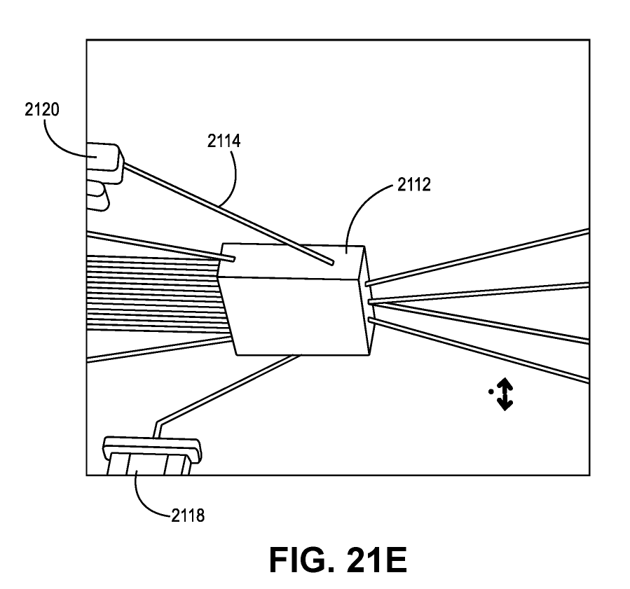

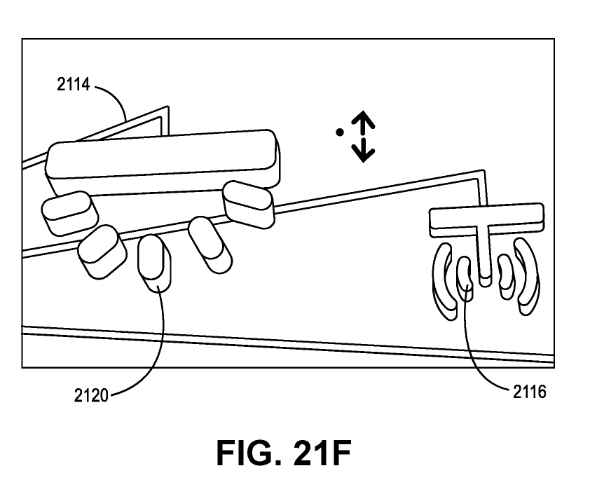

FIGS. 21A-21F illustrate one example using an AR device to assist with locating non-visible equipment by including digital representations of the non-visible equipment in overlay images that are generated and superimposed over the user's view of the real world displayed by the AR device.

In this example, as shown in FIG. 21A, the user orients the AR device 1312 so that a marker is within the field of view of the AR device 1312. In this example, the marker 2100 is located on a wall 2102 above a wall outlet 2104.

Then, the software 1315 executing on the AR device 1312 detects and identifies the marker 2100. The software 1315 then requests information about any equipment (including both visible equipment and non-visible equipment) installed near the marker 2100.

In this example, the visible equipment includes the wall outlet 2104. As shown in FIG. 21B, an overlay can be generated that displays a digital representation 2106 of the wall outlet 2104 that is displayed next to the wall outlet 2104. In this example, the wall outlet 2104 includes three ports 2108. The digital representation 2106 of the wall outlet 2104 includes a representation of each port 2108, and an annotation 2110 for each of the ports 2108 that displays status information for the associated port 2108. The overlay can also include annotations related to a work order that involves a port 2108 or other information (such as cable or connector type associated with that port 2108, performance results for the port 2108, for the wall outlet 2104, or a communication link that is terminated at that port 2108, an installation date for the wall outlet 2104 and/or a communication link that is terminated at that port 2108, etc.). The overlay can include interactive elements that a user can interact with (for example, by selecting) to enable the user to selectively display information associated with a port 2108. For example, the user can select the representation of a port 2108 in order to trace any connection made at that port 2108 (which can involve displaying information about the various cables, components, and devices that are connected to that port 2108). The system can also be configured to, in response to the user selecting (or making some other gesture for) a port 2108, display information about outstanding work orders associated with the port 2108 or help the user in identifying and locating cables, components, or devices that are connected to that port 2108. This port-related information can be provided for ports of any other equipment (not just wall outlets 2104), including for example, ports of a consolidation point, splice tray positions, panel ports in an outdoor cabinet, ports of HVAC or lighting systems controllers, ports of security cameras, wireless local area network access points, building access control (security) systems, etc.

In this example, the non-visible equipment includes connectivity equipment such as a consolidation point and cables and networking equipment such as wireless local area network access points. Also, in this example, the non-visible equipment includes security equipment such as an IP camera and lighting equipment such as lights.

The overlay that is generated includes digital representations of this non-visible equipment. The digital representations are positioned within the overlay so that the digital representations appear to be located where the corresponding real-world equipment is located and would be seen by the user if they were not obscured by the ceiling.

For example, the overlay includes digital representations 2112 of consolidation point (shown in FIGS. 21C-21E), digital representations 2114 of cables (shown in FIGS. 21C-21F), digital representations 2116 of wireless local area network access points (shown in FIGS. 21C and 21F), digital representations 2118 of IP cameras (shown in FIGS. 21C-21E), and digital representations 2120 of lights (shown in FIGS. 21C-21F).

By including digital representations of non-visible equipment in the overlays superimposed over the user's view of the real world displayed by the AR device 1312, the user is able to “see” where the non-visible equipment is located. This can assist the user in locating the non-visible equipment. After locating the non-visible equipment, the user can then take steps to access the non-visible equipment. For example, in this example, ceiling tiles can be removed in order to gain access to the non-visible equipment after locating the equipment using the digital representations included in the overlays superimposed over the user's view of the real world displayed by the AR device 1312.

Although the example shown in FIGS. 21A-21F has been described as being implemented using smart glasses as the AR device, it is to be understood that the techniques described above in connection with FIGS. 21A-21F can be implemented using other types of AR devices.

The techniques described above connection with FIGS. 13, 14A-14C, 15-17, 18A-N, 19, 20, and 21A-21F can be used in various ways. For example, these techniques can be used with the methods of executing patching connection changes described above in connection with FIG. 11. Information about a step of an electronic work order can be displayed for the user using the AR device 1312 (for example, using a WORK ORDER text box 1414 as described above). After the technician performs the step, the AR device 1312 can be used by the technician to confirm to the management system 1308 that the step has been completed (for example, by having the technician touch the STEP COMPLETE button 1416, in response to which an appropriate message is sent to the management system 1308 or by having the technician speak “STEP COMPLETED”, which is detected by the AR device 1312 and in response to which an appropriate message is sent to the management system 1308).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

### EXAMPLE EMBODIMENTS

Example 1 includes a method of using an augmented reality (AR) device, the method comprising: detecting and decoding an identifier associated with a standard rack in an image captured by the AR device; obtaining information about the standard rack and any equipment installed in the standard rack from a management system using the identifier; detecting perimeters of standard rack positions in the standard rack based on the information; and generating an overlay for the AR device, the overlay comprising at least one emphasis feature generated based on at least one of the perimeters.

Example 2 includes the method of Example 1, wherein the identifier is attached to at least one of the standard rack, equipment installed in the standard rack, and a structure near the standard rack.

Example 3 includes the method of any of the Examples 1-2, wherein the information about any equipment installed in the standard rack comprises information indicative of a height of each item of equipment installed in the standard rack.

Example 4 includes the method of Example 3, wherein the height of each item of equipment installed in the standard rack is expressed in a number of standard rack units or a fraction thereof.

Example 5 includes the method of any of the Examples 1-4, wherein the overlay comprises at least one interactive region based on at least one of the perimeters.

Example 6 includes the method of any of the Examples 1-5, wherein the information about the standard rack and any equipment installed in the standard rack comprises dimensional data for the standard rack and any equipment installed in the standard rack.

Example 7 includes the method of any of the Examples 1-6, wherein the information about the standard rack and any equipment installed in the standard rack comprises information about ports or other parts of any equipment installed in the standard rack.

Example 8 includes the method of Example 7, wherein the information about the ports or other parts of any equipment installed in the standard rack comprises information about at least one of: communication ports, power ports, cards, Gigabit Interface Converter (GBIC) slots, or add-on modules.

Example 9 includes the method of any of the Examples 7-8, wherein the information about the ports or other parts of any equipment installed in the standard rack comprises information about a respective region associated with each of the ports or other parts of any equipment installed in the standard rack; and wherein the method further comprises determining, based on the obtained information, a respective location of each respective region associated with each of the ports or other parts of any equipment installed in the standard rack.

Example 10 includes the method of any of the Examples 1-9, wherein the equipment installed in the standard rack comprises at least one of patching equipment or other equipment.

Example 11 includes the method of Example 10, wherein the other equipment comprises at least one of a switch, a router, a server, media converter, multiplexer, mainframe, or power strip.

Example 12 includes the method of any of the Examples 1-11, further comprising: detecting and decoding an identifier associated with non-rack-mounted equipment in an image captured by the AR device; obtaining information about the non-rack-mounted equipment from the management system using the identifier; and detecting a perimeter of the non-rack-mounted equipment; and wherein the overlay comprises at least one emphasis feature associated with the non-rack-mounted equipment generated based on the perimeter of the non-rack-mounted equipment.

Example 13 includes the method of Example 12, wherein the overlay further comprises at least one interactive region associated with the non-rack-mounted equipment based on the perimeter of the non-rack-mounted equipment.

Example 14 includes the method of any of the Examples 1-13, wherein the AR device is configured to communicate with the management system using at least one of a BLUETOOTH wireless connection, a near-field communication wireless connection, a wireless local area network (WLAN) wireless connection, a cellular wireless connection, and a wired connection.

Example 15 includes the method of any of the Examples 1-14, wherein the AR device is configured to communicate with the management system using at least one of a direct connection with the management system, an indirect connection via at least one of a wireless local area network, a cellular network, or a connection with a local controller.

Example 16 includes the method of any of the Examples 1-15, wherein the AR device is configured to communicate with the management system by first storing captured data locally within the AR device and then downloading the stored data to the management system.

Example 17 includes the method of any of the Examples 1-16, wherein the AR device further comprises a global position system (GPS) receiver, wherein the AR device is configured to use the GPS receiver to determine a location of the AR device and is configured to provide location information to the management system.

Example 18 includes the method of any of the Examples 1-17, wherein the AR device further comprises a global position system (GPS) receiver, wherein the AR device is configured to use the GPS receiver to determine a location of the AR device and is configured to provide location information to the management system.

Example 19 includes a system of tracking connections made using cables, the system comprises: a standard rack; a management system; and an augmented reality (AR) device; wherein the system is configured to: detect and decode an identifier associated with the standard rack in an image captured by the AR device; obtain information about the standard rack and any equipment installed in the standard rack from the management system using the identifier; detect perimeters of standard rack positions in the standard rack based on the information; and generate an overlay for the AR device, the overlay comprising at least one emphasis feature generated based on at least one of the perimeters.

Example 20 includes the system of Example 19, wherein the identifier is attached to at least one of the standard rack, equipment installed in the standard rack, and a structure near the standard rack.

Example 21 includes the system of any of the Examples 19-20, wherein the information about any equipment installed in the standard rack comprises information indicative of a height of each item of equipment installed in the standard rack.

Example 22 includes the system of Example 21, wherein the height of each item of equipment installed in the standard rack is expressed in a number of standard rack units or a fraction thereof.

Example 23 includes the system of any of the Examples 19-22, wherein the overlay comprises at least one interactive region based on at least one of the perimeters.

Example 24 includes the system of any of the Examples 19-23, wherein the information about the standard rack and any equipment installed in the standard rack comprises dimensional data for the standard rack and any equipment installed in the standard rack.

Example 25 includes the system of any of the Examples 19-24, wherein the information about the standard rack and any equipment installed in the standard rack comprises information about ports or other parts of any equipment installed in the standard rack.

Example 26 includes the system of Example 25, wherein the information about the ports or other parts of any equipment installed in the standard rack comprises information about at least one of: communication ports, power ports, cards, Gigabit Interface Converter (GBIC) slots, or add-on modules.

Example 27 includes the system of any of the Examples 25-26, wherein the information about the ports or other parts of any equipment installed in the standard rack comprises information about a respective region associated with each of the ports or other parts of any equipment installed in the standard rack; and wherein the system is further configured to determine, based on the obtained information, a respective location of each respective region associated with each of the ports or other parts of any equipment installed in the standard rack.

Example 28 includes the system of any of the Examples 19-27, wherein the equipment installed in the standard rack comprises at least one of patching equipment or other equipment.

Example 29 includes the system of Example 28, wherein the other equipment comprises at least one of a switch, a router, a server, media converter, multiplexer, mainframe, or power strip.

Example 30 includes the system of any of the Examples 19-29, wherein the system is further configured to: detect and decode an identifier associated with non-rack-mounted equipment in an image captured by the AR device; obtain information about the non-rack-mounted equipment from the management system using the identifier; and detect a perimeter of the non-rack-mounted equipment; and wherein the overlay comprises at least one emphasis feature associated with the non-rack-mounted equipment generated based on the perimeter of the non-rack-mounted equipment.

Example 31 includes the system of Example 30, wherein the overlay further comprises at least one interactive region associated with the non-rack-mounted equipment based on the perimeter of the non-rack-mounted equipment.

Example 32 includes the system of any of the Examples 19-31, wherein the AR device is configured to communicate with the management system using at least one of a BLUETOOTH wireless connection, a near-field communication wireless connection, a wireless local area network (WLAN) wireless connection, a cellular wireless connection, and a wired connection.

Example 33 includes the system of any of the Examples 19-32, wherein the AR device is configured to communicate with the management system using at least one of a direct connection with the management system, an indirect connection via at least one of a wireless local area network, a cellular network, or a connection with a local controller.

Example 34 includes the system of any of the Examples 19-33, wherein the AR device is configured to communicate with the management system by first storing captured data locally within the AR device and then downloading the stored data to the management system.

Example 35 includes the system of any of the Examples 19-34, wherein the AR device further comprises a global position system (GPS) receiver, wherein the AR device is configured to use the GPS receiver to determine a location of the AR device and is configured to provide location information to the management system.

Example 36 includes a method of using an augmented reality (AR) device, the method comprising: identifying, using an indoor positioning system, a standard rack in an image captured by the AR device; obtaining information about the standard rack and any equipment installed in the standard rack from a management system based on the identity of the standard rack; detecting perimeters of standard rack positions in the standard rack based on the information; and generating an overlay for the AR device, the overlay comprising at least one emphasis feature generated based on at least one of the perimeters.

Example 37 includes the method of Example 36, wherein the information about the standard rack and any equipment installed in the standard rack comprises information about ports or other parts of any equipment installed in the standard rack.

Example 38 includes the method of Example 37, wherein the information about the ports or other parts of any equipment installed in the standard rack comprises information about a respective region associated with each of the ports or other parts of any equipment installed in the standard rack; and wherein the method further comprises determining, based on the obtained information, a respective location of each respective region associated with each of the ports or other parts of any equipment installed in the standard rack.

Example 39 includes the method of any of the Examples 36-38, further comprising: identifying, using the indoor positioning system, non-rack-mounted equipment in an image captured by the AR device; obtaining information about the non-rack-mounted equipment from the management system based on the identity of the non-rack-mounted equipment; and detecting a perimeter of the non-rack-mounted equipment; and wherein the overlay comprises at least one emphasis feature associated with the non-rack-mounted equipment generated based on the perimeter of the non-rack-mounted equipment.

Example 40 includes the method of Example 39, wherein the overlay further comprises at least one interactive region associated with the non-rack-mounted equipment based on the perimeter of the non-rack-mounted equipment.

Example 41 includes the method of any of the Examples 36-40, wherein the AR device is configured to communicate with the management system using at least one of a BLUETOOTH wireless connection, a near-field communication wireless connection, a wireless local area network (WLAN) wireless connection, a cellular wireless connection, and a wired connection.

Example 42 includes the method of any of the Examples 36-41, wherein the AR device is configured to communicate with the management system using at least one of a direct connection with the management system, an indirect connection via at least one of a wireless local area network, a cellular network, or a connection with a local controller.

Example 43 includes the method of any of the Examples 36-42, wherein the AR device is configured to communicate with the management system by first storing captured data locally within the AR device and then downloading the stored data to the management system.

Example 44 includes the method of any of the Examples 36-43, wherein the AR device further comprises a global position system (GPS) receiver, wherein the AR device is configured to use the GPS receiver to determine a location of the AR device and is configured to provide location information to the management system.

Example 45 includes a system of tracking connections made using cables, the system comprises: a standard rack; a management system; an augmented reality (AR) device; and an indoor positioning system; wherein the system is configured to: identify, using the indoor positioning system, the standard rack in an image captured by the AR device; obtain information about the standard rack and any equipment installed in the standard rack from a management system based on the identity of the standard rack; detect perimeters of standard rack positions in the standard rack based on the information; and generate an overlay for the AR device, the overlay comprising at least one emphasis feature generated based on at least one of the perimeters.

Example 46 includes the system of Example 45, wherein at least some of the indoor positioning system is a part of the AR device.

Example 47 includes the system of any of the Examples 45-46, wherein the information about the standard rack and any equipment installed in the standard rack comprises information about ports or other parts of any equipment installed in the standard rack.

Example 48 includes the system of Example 47, wherein the information about the ports or other parts of any equipment installed in the standard rack comprises information about a respective region associated with each of the ports or other parts of any equipment installed in the standard rack; and wherein the system is further configured to determine, based on the obtained information, a respective location of each respective region associated with each of the ports or other parts of any equipment installed in the standard rack.

Example 49 includes the system of any of the Examples 45-48, wherein the system is further configured to: identify, using the indoor positioning system, non-rack-mounted equipment in an image captured by the AR device; obtain information about the non-rack-mounted equipment from the management system based on the identity of the non-rack-mounted equipment; and detect a perimeter of the non-rack-mounted equipment; and wherein the overlay comprises at least one emphasis feature associated with the non-rack-mounted equipment generated based on the perimeter of the non-rack-mounted equipment.

Example 50 includes the system of Example 49, wherein the overlay further comprises at least one interactive region associated with the non-rack-mounted equipment based on the perimeter of the non-rack-mounted equipment.

Example 51 includes the system of any of the Examples 45-50, wherein the AR device is configured to communicate with the management system using at least one of a BLUETOOTH wireless connection, a near-field communication wireless connection, a wireless local area network (WLAN) wireless connection, a cellular wireless connection, and a wired connection.

Example 52 includes the system of any of the Examples 45-51, wherein the AR device is configured to communicate with the management system using at least one of a direct connection with the management system, an indirect connection via at least one of a wireless local area network, a cellular network, or a connection with a local controller.

Example 53 includes the system of any of the Examples 45-52, wherein the AR device is configured to communicate with the management system by first storing captured data locally within the AR device and then downloading the stored data to the management system.

Example 54 includes the system of any of the Examples 45-53, wherein the AR device further comprises a global position system (GPS) receiver, wherein the AR device is configured to use the GPS receiver to determine a location of the AR device and is configured to provide location information to the management system.

Example 55 includes a method of using an augmented reality (AR) device to assist a user in locating non-visible equipment, the method comprising: detecting and identifying a marker deployed near the non-visible equipment; obtaining information about the non-visible equipment from a management system based on the identified marker; and generating an overlay for the AR device, the overlay comprising at least one digital representation of the non-visible equipment.

Example 56 includes the method of Examples 55, wherein the marker comprises at least one of (i) an object or equipment installed near the non-visible equipment; and (ii) a label, a code, or a tag on an object or equipment installed near the non-visible equipment.

Example 57 includes the method of any of the Examples 55-56, wherein the marker comprises at least one of a bar code, a QR code, or a RFID tag.

Example 58 includes the method of any of the Examples 55-57, wherein the non-visible equipment comprises at least one of: connectivity equipment, networking equipment, power equipment, security equipment, heating, ventilation, and air conditioning (HVAC) equipment, lighting equipment, elevator equipment, building-related equipment and structures, and information technology (IT) equipment.

Example 59 includes the method of any of the Examples 55-58, wherein the non-visible equipment comprises at least one of: a consolidation point, a cable, a cable bundle, a conduit, a raceway, a wireless local area network access point, a fuse, an Internet Protocol (IP) security camera, a sensor, and a light fixture.

Example 60 includes the method of any of the Examples 55-59, wherein the non-visible equipment includes non-visible equipment that is installed in at least one of an office environment and an outside plant.

Example 61 includes the method of any of the Examples 55-60, wherein the non-visible equipment includes non-visible equipment that is at least one of installed underground or in a dropped ceiling, a raised floor, a wall, a vault, an outdoor cabinet, or an indoor enclosure.

Example 62 includes the method of any of the Examples 55-61, wherein the management system is configured to store information about connectivity equipment and networking equipment; and wherein the method further comprises: obtaining information about types of non-visible equipment other than connectivity equipment or networking equipment from a non-connectivity system based on the identified marker.

Example 63 includes the method of any of the Examples 55-62, wherein obtaining information about the non-visible equipment from the management system based on the identified marker comprises: obtaining information about the non-visible equipment and visible equipment from the management system based on the identified marker; and wherein generating the overlay for the AR device comprises: generating the overlay for the AR device comprises based on information about the non-visible equipment and the visible equipment.

Example 64 includes the method of Example 63, wherein the overlay comprises at least one digital representation of the non-visible equipment and/or of the visible equipment.

Example 65 includes the method of any of the Examples 55-64, wherein the AR device is configured to communicate with the management system using at least one of a BLUETOOTH wireless connection, a near-field communication wireless connection, a wireless local area network (WLAN) wireless connection, a cellular wireless connection, and a wired connection.

Example 66 includes the method of any of the Examples 55-65, wherein the AR device is configured to communicate with the management system using at least one of a direct connection with the management system, an indirect connection via at least one of a wireless local area network, a cellular network, or a connection with a local controller.

Example 67 includes the method of any of the Examples 55-66, wherein the AR device is configured to communicate with the management system by first storing captured data locally within the AR device and then downloading the stored data to the management system.

Example 68 includes the method of any of the Examples 55-67, wherein the AR device further comprises a global position system (GPS) receiver, wherein the AR device is configured to use the GPS receiver to determine a location of the AR device and is configured to provide location information to the management system.

Example 69 includes a system for assisting a user in locating non-visible equipment, the system comprises: a management system; and an augmented reality (AR) device; wherein the system is configured to: detect and identify a marker deployed near the non-visible equipment; obtain information about the non-visible equipment from the management system based on the identified marker; and generate an overlay for the AR device, the overlay comprising at least one digital representation of the non-visible equipment.

Example 70 includes the system of Example 69, wherein the marker comprises at least one of (i) an object or equipment installed near the non-visible equipment; and (ii) a label, a code, or a tag on an object or equipment installed near the non-visible equipment.

Example 71 includes the system of any of the Examples 69-70, wherein the marker comprises at least one of a bar code, a QR code, or a RFID tag.

Example 72 includes the system of any of the Examples 69-71, wherein the non-visible equipment comprises at least one of: connectivity equipment, networking equipment, power equipment, security equipment, heating, ventilation, and air conditioning (HVAC) equipment, lighting equipment, elevator equipment, building-related equipment and structures, and information technology (IT) equipment.

Example 73 includes the system of any of the Examples 69-72, wherein the non-visible equipment comprises at least one of: a consolidation point, a cable, a cable bundle, a conduit, a raceway, a wireless local area network access point, a fuse, an Internet Protocol (IP) security camera, a sensor, and a light fixture.

Example 74 includes the system of any of the Examples 69-73, wherein the non-visible equipment includes non-visible equipment that is installed in at least one of an office environment and an outside plant.

Example 75 includes the system of any of the Examples 69-74, wherein the non-visible equipment includes non-visible equipment that is at least one of installed underground or in a dropped ceiling, a raised floor, a wall, a vault, an outdoor cabinet, or an indoor enclosure.

Example 76 includes the system of any of the Examples 69-75, wherein the management system is configured to store information about connectivity equipment and networking equipment; and wherein the system is further configured to: obtain information about types of non-visible equipment other than connectivity equipment or networking equipment from a non-connectivity system based on the identified marker.

Example 77 includes the system of any of the Examples 69-76, wherein the system is configured to obtaining information about the non-visible equipment and visible equipment from the management system based on the identified marker; and wherein the system is configured to generate the overlay for the AR device comprises based on information about the non-visible equipment and the visible equipment.

Example 78 includes the system of Example 77, wherein the overlay comprises at least one digital representation of the non-visible equipment and/or of the visible equipment.

Example 79 includes the system of any of the Examples 69-78, wherein the AR device is configured to communicate with the management system using at least one of a BLUETOOTH wireless connection, a near-field communication wireless connection, a wireless local area network (WLAN) wireless connection, a cellular wireless connection, and a wired connection.

Example 80 includes the system of any of the Examples 69-79, wherein the AR device is configured to communicate with the management system using at least one of a direct connection with the management system, an indirect connection via at least one of a wireless local area network, a cellular network, and a connection with a local controller.

Example 81 includes the system of any of the Examples 69-80, wherein the AR device is configured to communicate with the management system by first storing captured data locally within the AR device and then downloading the stored data to the management system.

What is claimed is:

1. A method of using an augmented reality (AR) device, the method comprising:
detecting and decoding an identifier associated with a standard rack in an image captured by the AR device;
obtaining information about the standard rack and any equipment installed in the standard rack from a management system using the identifier;
detecting perimeters of standard rack positions in the standard rack based on the information; and
generating an overlay for the AR device, the overlay comprising at least one emphasis feature generated based on at least one of the perimeters.

2. The method of claim 1, wherein the identifier is attached to at least one of the standard rack, equipment installed in the standard rack, and a structure near the standard rack.

3. The method of claim 1, wherein the information about any equipment installed in the standard rack comprises information indicative of a height of each item of equipment installed in the standard rack.

4. The method of claim 3, wherein the height of each item of equipment installed in the standard rack is expressed in a number of standard rack units or a fraction thereof.

5. The method of claim 1, wherein the overlay comprises at least one interactive region based on at least one of the perimeters.

6. The method of claim 1, wherein the information about the standard rack and any equipment installed in the standard rack comprises dimensional data for the standard rack and any equipment installed in the standard rack.

7. The method of claim 1, wherein the information about the standard rack and any equipment installed in the standard rack comprises information about ports or other parts of any equipment installed in the standard rack.

8. The method of claim 7, wherein the information about the ports or other parts of any equipment installed in the standard rack comprises information about at least one of:
communication ports, power ports, cards, Gigabit Interface Converter (GBIC) slots, or add-on modules.

9. The method of claim 7, wherein the information about the ports or other parts of any equipment installed in the standard rack comprises information about a respective region associated with each of the ports or other parts of any equipment installed in the standard rack; and
wherein the method further comprises determining, based on the obtained information, a respective location of each respective region associated with each of the ports or other parts of any equipment installed in the standard rack.

10. The method of claim 1, wherein the equipment installed in the standard rack comprises at least one of patching equipment or other equipment.

11. The method of claim 10, wherein the other equipment comprises at least one of a switch, a router, a server, media converter, multiplexer, mainframe, or power strip.

12. The method of claim 1, further comprising:
detecting and decoding an identifier associated with non-rack-mounted equipment in an image captured by the AR device;
obtaining information about the non-rack-mounted equipment from the management system using the identifier; and
detecting a perimeter of the non-rack-mounted equipment; and
wherein the overlay comprises at least one emphasis feature associated with the non-rack-mounted equipment generated based on the perimeter of the non-rack-mounted equipment.

13. The method of claim 12, wherein the overlay further comprises at least one interactive region associated with the non-rack-mounted equipment based on the perimeter of the non-rack-mounted equipment.

14. The method of claim 1, wherein the AR device is configured to communicate with the management system using at least one of a BLUETOOTH wireless connection, a near-field communication wireless connection, a wireless local area network (WLAN) wireless connection, a cellular wireless connection, and a wired connection.

15. The method of claim 1, wherein the AR device is configured to communicate with the management system using at least one of a direct connection with the management system, an indirect connection via at least one of a wireless local area network, a cellular network, or a connection with a local controller.

16. The method of claim 1, wherein the AR device is configured to communicate with the management system by first storing captured data locally within the AR device and then downloading the stored data to the management system.

17. The method of claim 1, wherein the AR device further comprises a global position system (GPS) receiver, wherein the AR device is configured to use the GPS receiver to determine a location of the AR device and is configured to provide location information to the management system.

18. The method of claim 1, wherein the AR device further comprises a global position system (GPS) receiver, wherein the AR device is configured to use the GPS receiver to determine a location of the AR device and is configured to provide location information to the management system.

19. A system of tracking connections made using cables, the system comprises:
a standard rack;
a management system; and
an augmented reality (AR) device;
wherein the system is configured to:
detect and decode an identifier associated with the standard rack in an image captured by the AR device;
obtain information about the standard rack and any equipment installed in the standard rack from the management system using the identifier;
detect perimeters of standard rack positions in the standard rack based on the information; and
generate an overlay for the AR device, the overlay comprising at least one emphasis feature generated based on at least one of the perimeters.

20. The system of claim 19, wherein the identifier is attached to at least one of the standard rack, equipment installed in the standard rack, and a structure near the standard rack.

21. The system of claim 19, wherein the information about any equipment installed in the standard rack comprises information indicative of a height of each item of equipment installed in the standard rack.

22. The system of claim 21, wherein the height of each item of equipment installed in the standard rack is expressed in a number of standard rack units or a fraction thereof.

23. The system of claim 19, wherein the overlay comprises at least one interactive region based on at least one of the perimeters.

24. The system of claim 19, wherein the information about the standard rack and any equipment installed in the standard rack comprises dimensional data for the standard rack and any equipment installed in the standard rack.

25. The system of claim 19, wherein the information about the standard rack and any equipment installed in the standard rack comprises information about ports or other parts of any equipment installed in the standard rack.

26. The system of claim 25, wherein the information about the ports or other parts of any equipment installed in the standard rack comprises information about at least one of: communication ports, power ports, cards, Gigabit Interface Converter (GBIC) slots, or add-on modules.

27. The system of claim 25, wherein the information about the ports or other parts of any equipment installed in the standard rack comprises information about a respective region associated with each of the ports or other parts of any equipment installed in the standard rack; and
wherein the system is further configured to determine, based on the obtained information, a respective location of each respective region associated with each of the ports or other parts of any equipment installed in the standard rack.

28. The system of claim 19, wherein the equipment installed in the standard rack comprises at least one of patching equipment or other equipment.

29. The system of claim 28, wherein the other equipment comprises at least one of a switch, a router, a server, media converter, multiplexer, mainframe, or power strip.

30. The system of claim 19, wherein the system is further configured to:
detect and decode an identifier associated with non-rack-mounted equipment in an image captured by the AR device;
obtain information about the non-rack-mounted equipment from the management system using the identifier; and
detect a perimeter of the non-rack-mounted equipment; and
wherein the overlay comprises at least one emphasis feature associated with the non-rack-mounted equipment generated based on the perimeter of the non-rack-mounted equipment.

31. The system of claim 30, wherein the overlay further comprises at least one interactive region associated with the non-rack-mounted equipment based on the perimeter of the non-rack-mounted equipment.

32. The system of claim 19, wherein the AR device is configured to communicate with the management system using at least one of a BLUETOOTH wireless connection, a near-field communication wireless connection, a wireless local area network (WLAN) wireless connection, a cellular wireless connection, and a wired connection.

33. The system of claim 19, wherein the AR device is configured to communicate with the management system using at least one of a direct connection with the management system, an indirect connection via at least one of a wireless local area network, a cellular network, or a connection with a local controller.

34. The system of claim 19, wherein the AR device is configured to communicate with the management system by first storing captured data locally within the AR device and then downloading the stored data to the management system.

35. The system of claim 19, wherein the AR device further comprises a global position system (GPS) receiver, wherein the AR device is configured to use the GPS receiver to determine a location of the AR device and is configured to provide location information to the management system.

36. A method of using an augmented reality (AR) device, the method comprising:
identifying, using an indoor positioning system, a standard rack in an image captured by the AR device;
obtaining information about the standard rack and any equipment installed in the standard rack from a management system based on the identity of the standard rack;
detecting perimeters of standard rack positions in the standard rack based on the information; and
generating an overlay for the AR device, the overlay comprising at least one emphasis feature generated based on at least one of the perimeters.

37. The method of claim 36, wherein the information about the standard rack and any equipment installed in the standard rack comprises information about ports or other parts of any equipment installed in the standard rack.

38. The method of claim 37, wherein the information about the ports or other parts of any equipment installed in the standard rack comprises information about a respective region associated with each of the ports or other parts of any equipment installed in the standard rack; and
wherein the method further comprises determining, based on the obtained information, a respective location of each respective region associated with each of the ports or other parts of any equipment installed in the standard rack.

39. The method of claim 36, further comprising:
identifying, using the indoor positioning system, non-rack-mounted equipment in an image captured by the AR device;
obtaining information about the non-rack-mounted equipment from the management system based on the identity of the non-rack-mounted equipment; and
detecting a perimeter of the non-rack-mounted equipment; and
wherein the overlay comprises at least one emphasis feature associated with the non-rack-mounted equipment generated based on the perimeter of the non-rack-mounted equipment.

40. The method of claim 39, wherein the overlay further comprises at least one interactive region associated with the non-rack-mounted equipment based on the perimeter of the non-rack-mounted equipment.

41. The method of claim 36, wherein the AR device is configured to communicate with the management system using at least one of a BLUETOOTH wireless connection, a near-field communication wireless connection, a wireless local area network (WLAN) wireless connection, a cellular wireless connection, and a wired connection.

42. The method of claim 36, wherein the AR device is configured to communicate with the management system using at least one of a direct connection with the management system, an indirect connection via at least one of a wireless local area network, a cellular network, or a connection with a local controller.

43. The method of claim 36, wherein the AR device is configured to communicate with the management system by first storing captured data locally within the AR device and then downloading the stored data to the management system.

44. The method of claim 36, wherein the AR device further comprises a global position system (GPS) receiver, wherein the AR device is configured to use the GPS receiver to determine a location of the AR device and is configured to provide location information to the management system.

45. A system of tracking connections made using cables, the system comprises:
a standard rack;
a management system;
an augmented reality (AR) device; and
an indoor positioning system;
wherein the system is configured to:
identify, using the indoor positioning system, the standard rack in an image captured by the AR device;
obtain information about the standard rack and any equipment installed in the standard rack from a management system based on the identity of the standard rack;
detect perimeters of standard rack positions in the standard rack based on the information; and
generate an overlay for the AR device, the overlay comprising at least one emphasis feature generated based on at least one of the perimeters.

46. The system of claim 45, wherein at least some of the indoor positioning system is a part of the AR device.

47. The system of claim 45, wherein the information about the standard rack and any equipment installed in the standard rack comprises information about ports or other parts of any equipment installed in the standard rack.

48. The system of claim 47, wherein the information about the ports or other parts of any equipment installed in the standard rack comprises information about a respective region associated with each of the ports or other parts of any equipment installed in the standard rack; and
wherein the system is further configured to determine, based on the obtained information, a respective location of each respective region associated with each of the ports or other parts of any equipment installed in the standard rack.

49. The system of claim 45, wherein the system is further configured to:
identify, using the indoor positioning system, non-rack-mounted equipment in an image captured by the AR device;
obtain information about the non-rack-mounted equipment from the management system based on the identity of the non-rack-mounted equipment; and
detect a perimeter of the non-rack-mounted equipment; and
wherein the overlay comprises at least one emphasis feature associated with the non-rack-mounted equipment generated based on the perimeter of the non-rack-mounted equipment.

50. The system of claim 49, wherein the overlay further comprises at least one interactive region associated with the non-rack-mounted equipment based on the perimeter of the non-rack-mounted equipment.

51. The system of claim 45, wherein the AR device is configured to communicate with the management system using at least one of a BLUETOOTH wireless connection, a near-field communication wireless connection, a wireless local area network (WLAN) wireless connection, a cellular wireless connection, and a wired connection.

52. The system of claim 45, wherein the AR device is configured to communicate with the management system using at least one of a direct connection with the management system, an indirect connection via at least one of a wireless local area network, a cellular network, or a connection with a local controller.

53. The system of claim 45, wherein the AR device is configured to communicate with the management system by first storing captured data locally within the AR device and then downloading the stored data to the management system.

54. The system of claim 45, wherein the AR device further comprises a global position system (GPS) receiver, wherein the AR device is configured to use the GPS receiver to determine a location of the AR device and is configured to provide location information to the management system.

55. A method of using an augmented reality (AR) device to assist a user in locating non-visible equipment, the method comprising:
detecting and identifying a marker deployed near the non-visible equipment;
obtaining information about the non-visible equipment from a management system based on the identified marker; and
generating an overlay for the AR device, the overlay comprising at least one digital representation of the non-visible equipment.

56. The method of claim 55, wherein the marker comprises at least one of (i) an object or equipment installed near the non-visible equipment; and (ii) a label, a code, or a tag on an object or equipment installed near the non-visible equipment.

57. The method of claim 55, wherein the marker comprises at least one of a bar code, a QR code, or a RFID tag.

58. The method of claim 55, wherein the non-visible equipment comprises at least one of:
connectivity equipment, networking equipment, power equipment, security equipment, heating, ventilation, and air conditioning (HVAC) equipment, lighting equipment, elevator equipment, building-related equipment and structures, and information technology (IT) equipment.

59. The method of claim 55, wherein the non-visible equipment comprises at least one of: a consolidation point, a cable, a cable bundle, a conduit, a raceway, a wireless local area network access point, a fuse, an Internet Protocol (IP) security camera, a sensor, and a light fixture.

60. The method of claim 55, wherein the non-visible equipment includes non-visible equipment that is installed in at least one of an office environment and an outside plant.

61. The method of claim 55, wherein the non-visible equipment includes non-visible equipment that is at least one of installed underground or in a dropped ceiling, a raised floor, a wall, a vault, an outdoor cabinet, or an indoor enclosure.

62. The method of claim 55, wherein the management system is configured to store information about connectivity equipment and networking equipment; and
wherein the method further comprises:
obtaining information about types of non-visible equipment other than connectivity equipment or networking equipment from a non-connectivity system based on the identified marker.

63. The method of claim 55, wherein obtaining information about the non-visible equipment from the management system based on the identified marker comprises:
obtaining information about the non-visible equipment and visible equipment from the management system based on the identified marker; and
wherein generating the overlay for the AR device comprises:
generating the overlay for the AR device comprises based on information about the non-visible equipment and the visible equipment.

64. The method of claim 63, wherein the overlay comprises at least one digital representation of the non-visible equipment and/or of the visible equipment.

65. The method of claim 55, wherein the AR device is configured to communicate with the management system using at least one of a BLUETOOTH wireless connection, a near-field communication wireless connection, a wireless local area network (WLAN) wireless connection, a cellular wireless connection, and a wired connection.

66. The method of claim 55, wherein the AR device is configured to communicate with the management system using at least one of a direct connection with the management system, an indirect connection via at least one of a wireless local area network, a cellular network, or a connection with a local controller.

67. The method of claim 55, wherein the AR device is configured to communicate with the management system by first storing captured data locally within the AR device and then downloading the stored data to the management system.

68. The method of claim 55, wherein the AR device further comprises a global position system (GPS) receiver, wherein the AR device is configured to use the GPS receiver to determine a location of the AR device and is configured to provide location information to the management system.

69. A system for assisting a user in locating non-visible equipment, the system comprises:
a management system; and
an augmented reality (AR) device;
wherein the system is configured to:
detect and identify a marker deployed near the non-visible equipment;
obtain information about the non-visible equipment from the management system based on the identified marker; and
generate an overlay for the AR device, the overlay comprising at least one digital representation of the non-visible equipment.

70. The system of claim 69, wherein the marker comprises at least one of (i) an object or equipment installed near the non-visible equipment; and (ii) a label, a code, or a tag on an object or equipment installed near the non-visible equipment.

71. The system of claim 69, wherein the marker comprises at least one of a bar code, a QR code, or a RFID tag.

72. The system of claim 69, wherein the non-visible equipment comprises at least one of: connectivity equipment, networking equipment, power equipment, security equipment, heating, ventilation, and air conditioning (HVAC) equipment, lighting equipment, elevator equipment, building-related equipment and structures, and information technology (IT) equipment.

73. The system of claim 69, wherein the non-visible equipment comprises at least one of: a consolidation point, a cable, a cable bundle, a conduit, a raceway, a wireless local area network access point, a fuse, an Internet Protocol (IP) security camera, a sensor, and a light fixture.

74. The system of claim 69, wherein the non-visible equipment includes non-visible equipment that is installed in at least one of an office environment and an outside plant.

75. The system of claim 69, wherein the non-visible equipment includes non-visible equipment that is at least one of installed underground or in a dropped ceiling, a raised floor, a wall, a vault, an outdoor cabinet, or an indoor enclosure.

76. The system of claim 69, wherein the management system is configured to store information about connectivity equipment and networking equipment; and
wherein the system is further configured to:
obtain information about types of non-visible equipment other than connectivity equipment or networking equipment from a non-connectivity system based on the identified marker.

77. The system of claim 69, wherein the system is configured to obtaining information about the non-visible equipment and visible equipment from the management system based on the identified marker; and
wherein the system is configured to generate the overlay for the AR device comprises based on information about the non-visible equipment and the visible equipment.

78. The system of claim 77, wherein the overlay comprises at least one digital representation of the non-visible equipment and/or of the visible equipment.

79. The system of claim 69, wherein the AR device is configured to communicate with the management system using at least one of a BLUETOOTH wireless connection, a near-field communication wireless connection, a wireless local area network (WLAN) wireless connection, a cellular wireless connection, and a wired connection.

80. The system of claim 69, wherein the AR device is configured to communicate with the management system using at least one of a direct connection with the management system, an indirect connection via at least one of a wireless local area network, a cellular network, and a connection with a local controller.

81. The system of claim 69, wherein the AR device is configured to communicate with the management system by first storing captured data locally within the AR device and then downloading the stored data to the management system.
